(19) United States
(12) Patent Application Publication
(10) Pub. No.: US 2023/0269609 A1
(43) Pub. Date: Aug. 24, 2023

(54) COMMUNICATION METHOD, APPARATUS, AND SYSTEM

(71) Applicant: HUAWEI TECHNOLOGIES CO., LTD., Shenzhen (CN)

(72) Inventors: Ting WANG, Shanghai (CN); Yongxia LYU, Shenzhen (CN); Jun WANG, Shanghai (CN); Jianglei MA, Ottawa (CA)

(21) Appl. No.: 18/308,317

(22) Filed: Apr. 27, 2023

Related U.S. Application Data
(63) Continuation of application No. PCT/CN2021/121954, filed on Sep. 29, 2021.

(30) Foreign Application Priority Data
Oct. 31, 2020 (CN) 202011198161.8

(51) Int. Cl. H04W 24/02

(52) U.S. Cl. CPC H04W 24/02

(57) ABSTRACT

Embodiments of this application provide example communication methods, devices, apparatuses, and systems. One example method includes receiving, by a terminal device and from a network device, a first identifier indicating a first communication mode of the terminal device. The first communication mode corresponds to a first physical layer function parameter used by the terminal device for communication. The first physical layer function parameter corresponding to the first communication mode is determined by the terminal device based on the first identifier and a first correspondence between a communication mode and a physical layer function parameter. Communication is performed based on the first physical layer function parameter corresponding to the first communication mode. The communication mode in the first correspondence includes the first communication mode.

### CROSS-REFERENCE TO RELATED APPLICATIONS

This application is a continuation of International Application No. PCT/CN2021/121954, filed on Sep. 29, 2021, which claims priority to Chinese Patent Application No. 202011198161.8, filed on Oct. 31, 2020. The disclosures of the aforementioned applications are hereby incorporated by reference in their entireties.

### TECHNICAL FIELD

The present invention relates to the field of communication technologies, and in particular, to a communication method, apparatus, and system.

### BACKGROUND

An existing new radio (NR) communication system defines three modes for a terminal device: an idle mode, an inactive mode, and a connected mode. When the terminal device is in the idle mode, the terminal device does not establish a radio resource control (RRC) connection, and cannot transmit data. When the terminal device is in the inactive mode, although the terminal device does not establish an RRC connection, the terminal device can transmit small-packet data. When the terminal device is in the connected mode, the terminal device establishes an RRC connection, and can transmit data.

When the terminal device transmits small-packet data, a network device can indicate the terminal device to switch to the inactive mode, to reduce power consumption of the terminal device. When the terminal device transmits large-packet data, the network device can indicate the terminal device to switch to the connected mode, to reduce a transmission delay and improve communication quality.

Specifically, the terminal device can transmit data by using a physical layer based on a physical layer function parameter delivered by the network device by using RRC signaling.

However, because the terminal device has no historical memory, when the physical layer function parameter changes, the network device needs to deliver a physical layer function parameter to the terminal device again by using the RRC signaling. Consequently, signaling overheads of the network device and the terminal device are high, a switching delay is high, and power consumption of the terminal device is high.

### SUMMARY

In view of this, an objective of this application is to provide a communication method, apparatus, and system, to resolve the following technical problems: when a network device configures a physical layer function parameter for a terminal device by using RRC signaling, signaling overheads are high, a switching delay is high, and power consumption of the terminal device is high.

According to a first aspect, an embodiment of this application provides a communication method. The method includes: a terminal device receives a first identifier indicating a first communication mode of the terminal device from a network device. The first communication mode corresponds to a physical layer function parameter used by the terminal device for communication. The terminal device determines, based on the first identifier and a first correspondence between a communication mode and a physical layer function parameter, the physical layer function parameter corresponding to the first communication mode. The communication mode in the first correspondence includes the first communication mode. The terminal device performs communication based on the physical layer function parameter corresponding to the first communication mode.

Based on the first aspect, after receiving the first identifier sent by the network device, the terminal device can determine, based on the first correspondence, the physical layer function parameter corresponding to the first communication mode corresponding to the first identifier, and further perform communication based on the physical layer function parameter corresponding to the first communication mode, so that the network device is prevented from sending RRC signaling including the physical layer function parameter to the terminal device. This reduces RRC signaling overheads, reduces a physical layer function switching delay corresponding to the terminal device, reduces power consumption of the terminal device, and reduces communication complexity.

In a possible design, a type of the physical layer function parameter corresponding to the communication mode includes one or more of the following: data transmission, a channel state information CSI measurement feedback, initial access, mobility, power control, and beam management.

Based on the possible design, a feasible solution is provided for a correspondence between the communication mode and the type of the physical layer function parameter.

In a possible design, when a terminal type is an ultra reliable low latency communication URLLC device, the type of the physical layer function parameter corresponding to the communication mode includes the data transmission, the mobility, and the beam management. In addition/Alternatively, when a terminal type is an internet of things device IoT, the type of the physical layer function parameter corresponding to the communication mode includes the data transmission. In addition/Alternatively, when a terminal type is customer premise equipment CPE, the type of the physical layer function parameter corresponding to the communication mode includes the data transmission and the CSI measurement feedback.

Based on this possible design, the type of the physical layer function parameter corresponding to the terminal type can be determined based on the terminal type, to implement customization of the physical layer function parameter of the terminal type, meet a communication requirement of the terminal device, and reduce signaling overheads.

In a possible design, the terminal device receives the first correspondence between a communication mode and a physical layer function parameter from the network device. The communication mode in the first correspondence is determined based on a terminal type of the terminal device.

Based on this possible design, the terminal device can receive the first correspondence between a communication mode and a physical layer function parameter from the network device, to determine, based on the first correspondence, the physical layer function parameter corresponding to the communication mode of the terminal device.

In a possible design, before a terminal device receives a first identifier from a network device, the method further includes: the terminal device sends request information to the network device. The request information is used to request to switch the communication mode.

Based on this possible design, the terminal device can send the request information to the network device, to request to switch the communication mode. This provides a feasible solution for the terminal device to switch the communication mode.

In a possible design, the request information includes characteristic information. The characteristic information indicates the communication mode in the first correspondence.

Based on this possible design, the terminal device can send the characteristic information to the network device, so that the network device determines, based on the characteristic information, the communication mode corresponding to the terminal device. Therefore, a communication requirement of the terminal device is met, and communication quality is improved.

In a possible design, the physical layer function parameter includes a first parameter field. The first parameter field indicates a configuration manner of the physical layer function parameter. The configuration manner includes a second parameter field. The second parameter field includes a configuration parameter of the configuration manner.

Based on this possible design, a feasible solution is provided for designing a parameter field of the physical layer function parameter.

In a possible design, when the terminal type is the ultra reliable low latency communication URLLC device, a communication mode of the URLLC includes the first communication mode and a second communication mode. A type of a physical layer function parameter of the first communication mode includes the data transmission, and a configuration manner of the data transmission is a configured grant type scheduling manner, a feedback manner in which an acknowledgement/negative acknowledgement ACK/NACK feedback is not required, and a retransmission mechanism of blind retransmission. A type of a physical layer function parameter of the second communication mode includes the data transmission, and the configuration manner of the data transmission is a slot or sub-slot aggregation scheduling manner, a feedback manner of a codeword-level ACK/NACK feedback, and a retransmission mechanism of codeword-level retransmission. In addition/Alternatively, when the terminal type is the internet of things IoT device, a communication mode of the IoT includes the first communication mode. A type of a physical layer function parameter of the first communication mode includes the data transmission, and a configuration manner of the data transmission is a scheduling manner of dynamic scheduling, a feedback manner in which an acknowledgement/negative acknowledgement ACK/NACK feedback is not required, and a retransmission mechanism of blind retransmission. In addition/Alternatively, when the terminal type is the customer premise equipment CPE, a communication mode of the CPE includes the first communication mode and a second communication mode. A type of a physical layer function parameter of the first communication mode includes the data transmission and the CSI measurement feedback, a configuration manner of the data transmission is a scheduling manner of dynamic scheduling and a slot or sub-slot aggregation scheduling manner, a feedback manner of a codeword-level ACK/NACK feedback, and a retransmission mechanism of codeword-level retransmission, and a configuration manner of the CSI measurement feedback is a periodic CSI measurement feedback. A type of a physical layer function parameter of the second communication mode includes the data transmission and the CSI measurement feedback, the configuration manner of the data transmission is a scheduling manner of cross-slot scheduling, a feedback manner of a code block group-level ACK/NACK feedback, and a retransmission mechanism of code block group-level retransmission, and the configuration manner of the CSI measurement feedback is the periodic CSI measurement feedback.

Based on this possible design, the type of the physical layer function parameter corresponding to the terminal type can be determined based on the terminal type, to implement customization of the physical layer function parameter of the terminal type, meet a communication requirement of the terminal device, and reduce signaling overheads.

In a possible design, the communication mode in the first correspondence is an uplink communication mode or a downlink communication mode.

In a possible design, the terminal device receives a timer from the network device. The timer is used by the terminal device to switch the communication mode when the timer expires.

Based on this possible design, the terminal device can switch the communication mode based on the timer. This provides a feasible solution for the terminal device to switch the communication mode.

In a possible design, the terminal device sends acknowledgment information to the network device. The acknowledgment information indicates that the terminal device receives the first identifier.

Based on this possible design, after receiving the first identifier, the terminal device can send the acknowledgment information to the network device, so that the terminal device and the network device reach a consensus on the communication mode used by the terminal device.

In a possible design, the terminal device receives resource indication information from the network device. The resource indication information indicates a transmission resource used when the terminal device sends the acknowledgment information. The terminal device sends the acknowledgment information to the network device based on the transmission resource.

Based on this possible design, the terminal device can send the acknowledgment information to the network device based on the transmission resource indicated by the network device, so that the network device receives and identifies the acknowledgment information.

According to a second aspect, an embodiment of this application provides a terminal device. The terminal device may implement functions performed by the terminal device in the first aspect or the possible designs of the first aspect, and the functions may be implemented by hardware executing corresponding software. The hardware or the software includes one or more modules corresponding to the functions, for example, a transceiver module and a processing module. The transceiver module is configured to receive a first identifier indicating a first communication mode of the terminal device from a network device. The first communication mode corresponds to a physical layer function parameter used by the terminal device for communication. The processing module is configured to determine, based on the first identifier and a first correspondence between a communication mode and a physical layer function parameter, the physical layer function parameter corresponding to the first communication mode. The communication mode in the first correspondence includes the first communication mode. The processing module is further configured to perform communication based on the physical layer function parameter corresponding to the first communication mode.

In a possible design, a type of the physical layer function parameter corresponding to the communication mode includes one or more of the following: data transmission, a channel state information CSI measurement feedback, initial access, mobility, power control, and beam management.

In a possible design, when a terminal type is an ultra reliable low latency communication URLLC device, the type of the physical layer function parameter corresponding to the communication mode includes the data transmission, the mobility, and the beam management. In addition/Alternatively, when a terminal type is an internet of things device IoT, the type of the physical layer function parameter corresponding to the communication mode includes the data transmission. In addition/Alternatively, when a terminal type is customer premise equipment CPE, the type of the physical layer function parameter corresponding to the communication mode includes the data transmission and the CSI measurement feedback.

In a possible design, the transceiver module is further configured to receive the first correspondence between a communication mode and a physical layer function parameter from the network device. The communication mode in the first correspondence is determined based on a terminal type of the terminal device.

In a possible design, before receiving the first identifier from the network device, the transceiver module is further configured to send request information to the network device. The request information is used to request to switch the communication mode.

In a possible design, the request information includes characteristic information. The characteristic information indicates the communication mode in the first correspondence.

In a possible design, the physical layer function parameter includes a first parameter field. The first parameter field indicates a configuration manner of the physical layer function parameter. The configuration manner includes a second parameter field. The second parameter field includes a configuration parameter of the configuration manner.

In a possible design, when the terminal type is the ultra reliable low latency communication URLLC device, a communication mode of the URLLC includes the first communication mode and a second communication mode. A type of a physical layer function parameter of the first communication mode includes the data transmission, and a configuration manner of the data transmission is a configured grant type scheduling manner, a feedback manner in which an acknowledgement/negative acknowledgement ACK/NACK feedback is not required, and a retransmission mechanism of blind retransmission. A type of a physical layer function parameter of the second communication mode includes the data transmission, and the configuration manner of the data transmission is a slot or sub-slot aggregation scheduling manner, a feedback manner of a codeword-level ACK/NACK feedback, and a retransmission mechanism of codeword-level retransmission. In addition/Alternatively, when the terminal type is the internet of things IoT device, a communication mode of the IoT includes the first communication mode. A type of a physical layer function parameter of the first communication mode includes the data transmission, and a configuration manner of the data transmission is a scheduling manner of dynamic scheduling, a feedback manner in which an acknowledgement/negative acknowledgement ACK/NACK feedback is not required, and a retransmission mechanism of blind retransmission. In addition/Alternatively, when the terminal type is the customer premise equipment CPE, a communication mode of the CPE includes the first communication mode and a second communication mode. A type of a physical layer function parameter of the first communication mode includes the data transmission and the CSI measurement feedback, a configuration manner of the data transmission is a scheduling manner of dynamic scheduling and a slot or sub-slot aggregation scheduling manner, a feedback manner of a codeword-level ACK/NACK feedback, and a retransmission mechanism of codeword-level retransmission, and a configuration manner of the CSI measurement feedback is a periodic CSI measurement feedback. A type of a physical layer function parameter of the second communication mode includes the data transmission and the CSI measurement feedback, the configuration manner of the data transmission is a scheduling manner of cross-slot scheduling, a feedback manner of a code block group-level ACK/NACK feedback, and a retransmission mechanism of code block group-level retransmission, and the configuration manner of the CSI measurement feedback is the periodic CSI measurement feedback.

In a possible design, the communication mode in the first correspondence is an uplink communication mode or a downlink communication mode.

In a possible design, the transceiver module is further configured to receive a timer from the network device. The timer is used by the terminal device to switch the communication mode when the timer expires.

In a possible design, the transceiver module is further configured to send acknowledgment information to the network device. The acknowledgment information indicates that the terminal device receives the first identifier.

In a possible design, the transceiver module is further configured to receive resource indication information from the network device. The resource indication information indicates a transmission resource used when the terminal device sends the acknowledgment information. The transceiver module is further configured to send the acknowledgment information to the network device based on the transmission resource.

According to a third aspect, an embodiment of this application provides a terminal device. The terminal device may be a terminal device or a chip or a system-on-a-chip in the terminal device. The terminal device may implement functions performed by the terminal device in the foregoing aspects or the possible designs, and the functions may be implemented by hardware. In a possible design, the terminal device may include a transceiver and a processor. The transceiver and the processor may be configured to support the terminal device in implementing the functions in any one of the first aspect or the possible designs of the first aspect. For example, the transceiver is configured to receive a first identifier indicating a first communication mode of the terminal device from a network device. The first communication mode corresponds to a physical layer function parameter used by the terminal device for communication. The processor is configured to determine, based on the first identifier and a first correspondence between a communication mode and a physical layer function parameter, the physical layer function parameter corresponding to the first communication mode. The communication mode in the first correspondence includes the first communication mode. The processor is further configured to perform communication based on the physical layer function parameter corresponding to the first communication mode. In another possible design, the terminal device may further include a memory. The memory is configured to store computer-executable instructions and data that are necessary for the terminal device. When the terminal device runs, the transceiver and the processor execute the computer-executable instructions stored in the memory, to enable the terminal device to perform the communication method according to any one of the first aspect or the possible designs of the first aspect.

For a specific implementation of the terminal device in the second aspect and the third aspect, refer to behavior functions of the terminal device in the communication method provided in any one of the first aspect or the possible designs of the first aspect.

According to a fourth aspect, an embodiment of this application provides a communication method. The method includes: a network device determines a first identifier. The first identifier indicates a first communication mode of a terminal device. The first communication mode corresponds to a physical layer function parameter used by the terminal device for communication. The network device sends the first identifier to the terminal device.

Based on the fourth aspect, the network device sends the first identifier to the terminal device, so that the network device can be prevented from sending RRC signaling including the physical layer function parameter to the terminal device. This reduces RRC signaling overheads, reduces a physical layer function switching delay corresponding to the terminal device, reduces power consumption of the terminal device, and reduces communication complexity.

In a possible design, a type of the physical layer function parameter corresponding to a communication mode includes one or more of the following: data transmission, a channel state information CSI measurement feedback, initial access, mobility, power control, and beam management.

Based on the possible design, a feasible solution is provided for a correspondence between the communication mode and the type of the physical layer function parameter.

In a possible design, the network device determines, based on a terminal type of the terminal device, a first correspondence that is between a communication mode and a physical layer function parameter and that corresponds to the terminal device. The network device sends, to the terminal device, the first correspondence that is between a communication mode and a physical layer function parameter and that corresponds to the terminal device.

Based on this possible design, the network device can determine, based on the terminal type, the first correspondence that is between a communication mode and a physical layer function parameter and that corresponds to the terminal device, to implement customization of the physical layer function parameter of the terminal type, meet a communication requirement of the terminal device, and reduce signaling overheads.

In a possible design, the network device determines the terminal type of the terminal device based on one or more of the following: a service type, mobility, a transmission delay requirement, a channel environment, a reliability requirement, a coverage requirement, and a communication scenario that correspond to the terminal device.

In a possible design, before the network device sends the first identifier to the terminal device, the network device receives request information from the terminal device. The request information is used to request to switch the communication mode.

Based on the possible design, the network device can determine, based on the request information, the communication mode corresponding to the terminal device. This provides a feasible solution for the terminal device to switch the communication mode.

In a possible design, the request information further includes characteristic information. The characteristic information indicates the communication mode in the first correspondence.

Based on this possible design, the network device can determine, based on the characteristic information, the communication mode corresponding to the terminal device. Therefore, a communication requirement of the terminal device is met, and communication quality is improved.

In a possible design, the physical layer function parameter includes a first parameter field. The first parameter field indicates a configuration manner of the physical layer function parameter. The configuration manner includes a second parameter field. The second parameter field includes a configuration parameter of the configuration manner.

Based on this possible design, a feasible solution is provided for designing a parameter field of the physical layer function parameter.

In a possible design, the network device sends a timer to the terminal device. The timer is used by the terminal device to switch the communication mode when the timer expires.

Based on this possible design, the terminal device can switch the communication mode based on the timer. This provides a feasible solution for the terminal device to switch the communication mode.

In a possible design, the network device receives acknowledgment information from the terminal device. The acknowledgment information indicates that the terminal device receives the first identifier.

Based on the possible design, the network device receives the acknowledgment information, so that the terminal device and the network device can reach a consensus on the communication mode used by the terminal device.

In a possible design, the network device sends resource indication information to the terminal device. The resource indication information indicates a transmission resource used when the terminal device sends the acknowledgment information.

Based on this possible design, the terminal device can send the acknowledgment information to the network device based on the transmission resource indicated by the network device, so that the network device receives and identifies the acknowledgment information.

According to a fifth aspect, an embodiment of this application provides a network device. The network device may implement functions performed by the network device in the fourth aspect or the possible designs of the fourth aspect, and the functions may be implemented by hardware executing corresponding software. The hardware or the software includes one or more modules corresponding to the functions, for example, a processing module and a transceiver module. The processing module is configured to determine a first identifier. The first identifier indicates a first communication mode of a terminal device. The first communication mode corresponds to a physical layer function parameter used by the terminal device for communication. The transceiver module is configured to send the first identifier to the terminal device.

In a possible design, a type of the physical layer function parameter corresponding to a communication mode includes one or more of the following: data transmission, a channel state information CSI measurement feedback, initial access, mobility, power control, and beam management.

In a possible design, the processing module is further configured to determine, based on a terminal type of the terminal device, a first correspondence that is between a communication mode and a physical layer function parameter and that corresponds to the terminal device. The transceiver module is further configured to send, to the terminal device, the first correspondence that is between a communication mode and a physical layer function parameter and that corresponds to the terminal device.

In a possible design, the processing module is further configured to determine the terminal type of the terminal device based on one or more of the following: a service type, mobility, a transmission delay requirement, a channel environment, a reliability requirement, a coverage requirement, and a communication scenario that correspond to the terminal device.

In a possible design, before sending the first identifier to the terminal device, the transceiver module is further configured to receive request information from the terminal device. The request information is used to request to switch the communication mode.

In a possible design, the request information further includes characteristic information. The characteristic information indicates the communication mode in the first correspondence.

In a possible design, the physical layer function parameter includes a first parameter field. The first parameter field indicates a configuration manner of the physical layer function parameter. The configuration manner includes a second parameter field. The second parameter field includes a configuration parameter of the configuration manner.

In a possible design, the transceiver module is further configured to send a timer to the terminal device. The timer is used by the terminal device to switch the communication mode when the timer expires.

In a possible design, the transceiver module is further configured to receive acknowledgment information from the terminal device. The acknowledgment information indicates that the terminal device receives the first identifier.

In a possible design, the transceiver module is further configured to send resource indication information to the terminal device. The resource indication information indicates a transmission resource used when the terminal device sends the acknowledgment information.

According to a sixth aspect, an embodiment of this application provides a network device. The network device may be a network device or a chip or a system-on-a-chip in the network device. The network device may implement functions performed by the network device in the foregoing aspects or the possible designs, and the functions may be implemented by hardware. In a possible design, the network device may include a transceiver and a processor. The transceiver and the processor may be configured to support the network device in implementing the functions in any one of the fourth aspect or the possible designs of the fourth aspect. For example, the processor is configured to determine a first identifier. The first identifier indicates a first communication mode of a terminal device. The first communication mode corresponds to a physical layer function parameter used by the terminal device for communication. The transceiver is configured to send the first identifier to the terminal device. In another possible design, the network device may further include a memory. The memory is configured to store computer-executable instructions and data that are necessary for the network device. When the network device runs, the transceiver and the processor execute the computer-executable instructions stored in the memory, to enable the network device to perform the communication method according to any one of the fourth aspect or the possible designs of the fourth aspect.

For a specific implementation of the network device in the fifth aspect and the sixth aspect, refer to behavior functions of the network device in the communication method provided in any one of the fourth aspect or the possible designs of the fourth aspect.

According to a seventh aspect, an embodiment of this application further provides a communication method. The method includes: a terminal device receives a second identifier from a network device. The second identifier indicates a first terminal status of the terminal device. The first terminal status is a data transmission state or a non-data transmission state, or the first terminal status is an enhanced state or a non-enhanced state. The terminal device determines a parameter of the first terminal status based on the second identifier and a second correspondence between a terminal status and a parameter of the terminal status. The terminal status in the second correspondence includes the first terminal status. The terminal device switches to the first terminal status.

Based on the seventh aspect, the network device sends the second identifier to the terminal device, so that the terminal device can complete terminal status switching based on the second identifier. This avoids switching by using RRC signaling, reduces RRC signaling overheads, reduces a terminal status switching delay corresponding to the terminal device, reduces power consumption of the terminal device, and reduces communication complexity.

In a possible design, the terminal device receives the second correspondence between a terminal status and a parameter of the terminal status from the network device. The terminal status in the second correspondence is determined based on a terminal type of the terminal device.

Based on this possible design, the corresponding terminal status is determined for the terminal device based on the terminal type, so that communication requirements of different terminal devices can be met, RRC signaling overheads can be reduced, chip complexity can be reduced, production costs can be reduced, and communication complexity can be reduced.

In a possible design, the enhanced state is a large-packet transmission state, and the non-enhanced state is a small-packet transmission state. Alternatively, the enhanced state is a high-rate transmission state, and the non-enhanced state is a low-rate transmission state. Alternatively, the enhanced state is a high power consumption state, and the non-enhanced state is a low power consumption state. Alternatively, the enhanced state is a high transmission delay state, and the non-enhanced state is a low transmission delay state.

Based on the possible design, a feasible solution is provided for the enhanced state and the non-enhanced state.

According to an eighth aspect, an embodiment of this application provides a terminal device. The terminal device may implement functions performed by the terminal device in the seventh aspect or the possible designs of the seventh aspect, and the functions may be implemented by hardware executing corresponding software. The hardware or the software includes one or more modules corresponding to the functions, for example, a transceiver module and a processing module. The transceiver module is configured to receive a second identifier from a network device. The second identifier indicates a first terminal status of the terminal device. The first terminal status is a data transmission state or a non-data transmission state, or the first terminal status is an enhanced state or a non-enhanced state. The processing module is configured to determine a parameter of the first terminal status based on the second identifier and a second correspondence between a terminal status and a parameter of the terminal status. The terminal status in the second correspondence includes the first terminal status. The processing module is further configured to switch to the first terminal status.

In a possible design, the terminal device receives the second correspondence between a terminal status and a parameter of the terminal status from the network device. The terminal status in the second correspondence is determined based on a terminal type of the terminal device.

In a possible design, the enhanced state is a large-packet transmission state, and the non-enhanced state is a small-packet transmission state. Alternatively, the enhanced state is a high-rate transmission state, and the non-enhanced state is a low-rate transmission state. Alternatively, the enhanced state is a high power consumption state, and the non-enhanced state is a low power consumption state. Alternatively, the enhanced state is a high transmission delay state, and the non-enhanced state is a low transmission delay state.

According to a ninth aspect, an embodiment of this application provides a terminal device. The terminal device may be a terminal device or a chip or a system-on-a-chip in the terminal device. The terminal device may implement functions performed by the terminal device in the foregoing aspects or the possible designs, and the functions may be implemented by hardware. In a possible design, the terminal device may include a transceiver and a processor. The transceiver and the processor may be configured to support the terminal device in implementing the functions in any one of the seventh aspect or the possible designs of the seventh aspect. For example, the transceiver is configured to receive a second identifier from a network device. The second identifier indicates a first terminal status of the terminal device. The first terminal status is a data transmission state or a non-data transmission state, or the first terminal status is an enhanced state or a non-enhanced state. The processor is configured to determine a parameter of the first terminal status based on the second identifier and a second correspondence between a terminal status and a parameter of the terminal status. The terminal status in the second correspondence includes the first terminal status. The processor is further configured to switch to the first terminal status. In another possible design, the terminal device may further include a memory. The memory is configured to store computer-executable instructions and data that are necessary for the terminal device. When the terminal device runs, the transceiver and the processor execute the computer-executable instructions stored in the memory, to enable the terminal device to perform the communication method according to any one of the seventh aspect or the possible designs of the seventh aspect.

For a specific implementation of the terminal device in the eighth aspect and the ninth aspect, refer to behavior functions of the terminal device in the communication method provided in any one of the seventh aspect or the possible designs of the seventh aspect.

According to a tenth aspect, an embodiment of this application provides a communication method. The method includes: a network device determines a second identifier. The second identifier indicates a first terminal status of a terminal device. The first terminal status is a data transmission state or a non-data transmission state, or the first terminal status is an enhanced state or a non-enhanced state. The network device sends the second identifier to the terminal device.

Based on the tenth aspect, the network device sends the second identifier to the terminal device, so that the terminal device can complete terminal status switching based on the second identifier. This avoids switching by using RRC signaling, reduces RRC signaling overheads, reduces a terminal status switching delay corresponding to the terminal device, reduces power consumption of the terminal device, and reduces communication complexity.

In a possible design, the network device determines, based on a terminal type of the terminal device, a second correspondence that is between a terminal status and a parameter of the terminal status and that corresponds to the terminal device. The network device sends, to the terminal device, the second correspondence that is between a terminal status and a parameter of the terminal status and that corresponds to the terminal device.

Based on this possible design, the corresponding terminal status is determined for the terminal device based on the terminal type, so that communication requirements of different terminal devices can be met, RRC signaling overheads can be reduced, chip complexity can be reduced, production costs can be reduced, and communication complexity can be reduced.

In a possible design, the enhanced state is a large-packet transmission state, and the non-enhanced state is a small-packet transmission state. Alternatively, the enhanced state is a high-rate transmission state, and the non-enhanced state is a low-rate transmission state. Alternatively, the enhanced state is a high power consumption state, and the non-enhanced state is a low power consumption state. Alternatively, the enhanced state is a high transmission delay state, and the non-enhanced state is a low transmission delay state.

Based on the possible design, a feasible solution is provided for the enhanced state and the non-enhanced state.

According to an eleventh aspect, an embodiment of this application provides a network device. The network device may implement functions performed by the network device in the tenth aspect or the possible designs of the tenth aspect, and the functions may be implemented by hardware executing corresponding software. The hardware or the software includes one or more modules corresponding to the functions, for example, a processing module and a transceiver module. The processing module is configured to determine a second identifier. The second identifier indicates a first terminal status of a terminal device. The first terminal status is a data transmission state or a non-data transmission state, or the first terminal status is an enhanced state or a non-enhanced state. The transceiver module is configured to send the second identifier to the terminal device.

In a possible design, the processing module is further configured to determine, based on a terminal type of the terminal device, a second correspondence that is between a terminal status and a parameter of the terminal status and that corresponds to the terminal device. The transceiver module is further configured to send, to the terminal device, the second correspondence that is between a terminal status and a parameter of the terminal status and that corresponds to the terminal device.

In a possible design, the enhanced state is a large-packet transmission state, and the non-enhanced state is a small-packet transmission state. Alternatively, the enhanced state is a high-rate transmission state, and the non-enhanced state is a low-rate transmission state. Alternatively, the enhanced state is a high power consumption state, and the non-enhanced state is a low power consumption state. Alternatively, the enhanced state is a high transmission delay state, and the non-enhanced state is a low transmission delay state.

According to a twelfth aspect, an embodiment of this application provides a network device. The network device may be a network device or a chip or a system-on-a-chip in the network device. The network device may implement functions performed by the network device in the foregoing aspects or the possible designs, and the functions may be implemented by hardware. In a possible design, the network device may include a transceiver and a processor. The transceiver and the processor may be configured to support the network device in implementing the functions in any one of the tenth aspect or the possible designs of the tenth aspect. For example, the processor is configured to determine a second identifier. The second identifier indicates a first terminal status of a terminal device. The first terminal status is a data transmission state or a non-data transmission state, or the first terminal status is an enhanced state or a non-enhanced state. The transceiver is configured to send the second identifier to the terminal device. In another possible design, the network device may further include a memory. The memory is configured to store computer-executable instructions and data that are necessary for the network device. When the network device runs, the transceiver and the processor execute the computer-executable instructions stored in the memory, to enable the network device to perform the communication method according to any one of the tenth aspect or the possible designs of the tenth aspect.

For a specific implementation of the network device in the eleventh aspect and the twelfth aspect, refer to behavior functions of the network device in the communication method provided in any one of the tenth aspect or the possible designs of the tenth aspect.

According to a thirteenth aspect, a communication apparatus is provided. The communication apparatus includes one or more processors and one or more memories. The one or more memories are coupled to the one or more processors. The one or more memories are configured to store computer program code or computer instructions. When the one or more processors execute the computer instructions, the communication apparatus is enabled to perform the communication method according to any one of the first aspect or the possible designs of the first aspect, or perform the communication method according to any one of the fourth aspect or the possible designs of the fourth aspect, or perform the communication method according to any one of the seventh aspect or the possible designs of the seventh aspect, or perform the communication method according to any one of the tenth aspect or the possible designs of the tenth aspect.

According to a fourteenth aspect, a computer-readable storage medium is provided. The computer-readable storage medium stores computer instructions or a program. When the computer instructions or the program are/is run on a computer, the computer is enabled to perform the communication method according to any one of the first aspect or the possible designs of the first aspect, or perform the communication method according to any one of the fourth aspect or the possible designs of the fourth aspect, or perform the communication method according to any one of the seventh aspect or the possible designs of the seventh aspect, or perform the communication method according to any one of the tenth aspect or the possible designs of the tenth aspect.

According to a fifteenth aspect, a computer program product including instructions is provided. When the computer program product runs on a computer, the computer is enabled to perform the communication method according to any one of the first aspect or the possible designs of the first aspect, or perform the communication method according to any one of the fourth aspect or the possible designs of the fourth aspect, or perform the communication method according to any one of the seventh aspect or the possible designs of the seventh aspect, or perform the communication method according to any one of the tenth aspect or the possible designs of the tenth aspect.

According to a sixteenth aspect, a communication apparatus is provided. The communication apparatus includes a processor and a communication interface. The processor is configured to read instructions. When the communication apparatus is a chip, the communication apparatus may perform the communication method according to any one of the first aspect or the possible designs of the first aspect, or perform the communication method according to any one of the fourth aspect or the possible designs of the fourth aspect, or perform the communication method according to any one of the seventh aspect or the possible designs of the seventh aspect, or perform the communication method according to any one of the tenth aspect or the possible designs of the tenth aspect. When the communication apparatus is a terminal device, the communication apparatus may perform the communication method according to any one of the first aspect or the possible designs of the first aspect, or perform the communication method according to any one of the seventh aspect or the possible designs of the seventh aspect. When the communication apparatus is a network device, the communication apparatus may perform the communication method according to any one of the fourth aspect or the possible designs of the fourth aspect, or perform the communication method according to any one of the tenth aspect or the possible designs of the tenth aspect.

For technical effects brought by any one of the designs of the thirteenth aspect to the sixteenth aspect, refer to technical effects brought by any one of the possible designs of the first aspect, or refer to technical effects brought by any one of the possible designs of the fourth aspect, or refer to technical effects brought by any one of the possible designs of the seventh aspect, or refer to technical effects brought by any one of the possible designs of the tenth aspect. Details are not described again.

According to a seventeenth aspect, a communication system is provided. The communication system includes the terminal device according to any one of the second aspect and the third aspect and the network device according to any one of the fifth aspect and the sixth aspect, or includes the terminal device according to any one of the eighth aspect and the ninth aspect and the network device according to any one of the eleventh aspect and the twelfth aspect.

### BRIEF DESCRIPTION OF DRAWINGS

FIG. 1a is a flowchart of establishing an RRC connection according to an embodiment of this application;

FIG. 1B is a schematic diagram of state switching performed by a terminal device according to an embodiment of this application;

FIG. 1c is a schematic diagram depicting that a network device configures a physical layer function parameter for a terminal device according to an embodiment of this application;

FIG. 1d is a schematic diagram of composition of a communication system according to an embodiment of this application;

FIG. 1e is a schematic diagram of a protocol stack of a terminal device and a network device according to an embodiment of this application.

FIG. if is a schematic diagram of composition of a communication system according to an embodiment of this application;

FIG. 2 is a schematic diagram of composition of a communication apparatus according to an embodiment of this application;

FIG. 3a is a flowchart of a communication method according to an embodiment of this application;

FIG. 3b is a flowchart of a communication method according to an embodiment of this application;

FIG. 3c is a flowchart of a communication method according to an embodiment of this application;

FIG. 4 is a schematic diagram of a terminal type according to an embodiment of this application;

FIG. 5 is a schematic diagram of a type of a physical layer function parameter according to an embodiment of this application;

FIG. 6 is a schematic diagram of a scheduling manner according to an embodiment of this application;

FIG. 7 is a schematic diagram of a feedback manner according to an embodiment of this application;

FIG. 8 is a schematic diagram of a retransmission mechanism according to an embodiment of this application;

FIG. 9 is a schematic diagram of a CSI measurement feedback according to an embodiment of this application;

FIG. 10 is a schematic diagram of power control according to an embodiment of this application;

FIG. 11a is a schematic diagram of beams formed by four antenna panels included in one network device according to an embodiment of this application;

FIG. 11b is a schematic diagram of beams formed by four antenna panels included in one network device according to an embodiment of this application;

FIG. 11c is a schematic diagram of beam management according to an embodiment of this application;

FIG. 12 is a schematic diagram of beam sweeping according to an embodiment of this application;

FIG. 13 is a schematic diagram of beam sweeping according to an embodiment of this application;

FIG. 14 is a schematic diagram of beam sweeping according to an embodiment of this application;

FIG. 15 is a schematic diagram of beam sweeping according to an embodiment of this application;

FIG. 16a is a flowchart of a communication method according to an embodiment of this application;

FIG. 16b is a flowchart of a communication method according to an embodiment of this application;

FIG. 16c is a flowchart of a communication method according to an embodiment of this application;

FIG. 17a is a flowchart of a communication method according to an embodiment of this application;

FIG. 17b is a flowchart of a communication method according to an embodiment of this application;

FIG. 17c is a flowchart of a communication method according to an embodiment of this application;

FIG. 18a is a flowchart of a communication method according to an embodiment of this application;

FIG. 18b is a flowchart of a communication method according to an embodiment of this application;

FIG. 18c is a flowchart of a communication method according to an embodiment of this application;

FIG. 19 is a schematic diagram of composition of a terminal device according to an embodiment of this application; and

FIG. 20 is a schematic diagram of composition of a network device according to an embodiment of this application.

### DESCRIPTION OF EMBODIMENTS

Before embodiments of this application are described, technical terms used in embodiments of this application are described.

An existing new radio (NR) communication system defines three modes for a terminal device: an idle mode, an inactive mode, and a connected mode. The terminal device is in only one state at a moment, and the terminal device may switch between the foregoing three modes based on upper layer signaling sent by a network device. For example, the terminal device may switch between the three modes based on radio resource control (RRC) signaling sent by the network device.

When the terminal device is in the idle mode, the terminal device does not establish an RRC connection to the network device, maintains only a basic connection to the network device, and cannot transmit data.

Specifically, when the terminal device is in the idle mode, the terminal device may perform one or more of the following functions: (1) The terminal device may receive terminal device-level discontinuous reception (DRX) configured at an upper layer. (2) The terminal device may receive controlled movement configured by the network device. (3) The terminal device may detect a short message. The short message may perform scheduling transmission by using downlink control information (DCI) scrambled by using a paging radio network temporary identifier (P-RNTI). (4) The terminal device may receive paging information and detect a paging channel. For example, the terminal device may detect a paging channel on which core network paging is performed by using a 5G S-temporary mobile subscription identifier (5G-S-TMSI). (5) The terminal device may perform neighboring cell measurement and cell selection or cell reselection. (6) The terminal device may obtain system information, and transmit a system information request. (7) The terminal device may perform logging on possible measurement, and perform logging on a recorded location and time of measurement configured by the terminal device.

When the terminal device is in the inactive mode, the terminal device does not establish an RRC connection to the network device, and maintains only a basic connection to the network device. However, the terminal device can store a context of the terminal device, and can transmit small-packet data.

Specifically, when the terminal device is in the inactive mode, the terminal device may perform one or more of the following functions: (1) The terminal device may receive terminal device-level DRX configured at an upper layer or configured at an RRC layer. (2) The terminal device may receive controlled movement configured by the network device. (3) The terminal device may store an access stratum (AS) context of the terminal device in the inactive mode. (4) The terminal device may receive a radio access network-based notification area (RNA) configured at the RRC layer. (5) The terminal device may detect a short message. The short message may perform scheduling transmission by using DCI scrambled by using a P-RNTI. (6) The terminal device may receive paging information and detect a paging channel. For example, the terminal device may perform core network paging by using a 5G-S-TMSI, and perform RAN paging by using a full inactive radio network temporary identifier (I-RNTI). (7) The terminal device may perform neighboring cell measurement and cell selection or cell reselection. (8) When the terminal device moves outside the RAN-based notification area configured by the network device, the terminal device may perform RAN-based periodic notification area update. (9) The terminal device may obtain system information, and transmit a system information request. (10) The terminal device may logging on possible measurement, and perform logging on a recorded location and time of measurement configured by the terminal device.

Specifically, when the terminal device is in the inactive mode, the network device may perform RRC configuration on the terminal device. The RRC configuration may include terminal capability reporting, configured grant, and the like. Alternatively, the network device may configure a random access channel (RACH) for the terminal device to perform uplink synchronization and uplink data transmission.

When the terminal device is in the connected mode, the terminal device establishes an RRC connection to the network device, and the terminal device can transmit data.

Specifically, when the terminal device is in the connected mode, the terminal device may perform one or more of the following functions: (1) The terminal device may store an access stratum context. (2) The terminal device may receive and/or send unicast data. (3) The terminal device may receive terminal device-level DRX configured at a lower layer. (4) When the terminal device supports carrier aggregation CA), a primary cell may aggregate one or more secondary cells to enhance bandwidth. (5) When the terminal device supports dual connectivity (DC), a master cell group may aggregate one secondary cell group to enhance bandwidth. (6) The terminal device may receive controlled movement configured by the network device. (7) The terminal device may detect a short message. The short message may perform scheduling transmission by using DCI scrambled by using a P-RNTI. (8) When data scheduling exists, the terminal device may detect a control channel and an associated shared data channel. (9) The terminal device may provide channel quality and feedback information. (10) The terminal device may perform neighboring cell measurement and measurement reporting. (11) The terminal device may obtain system information.

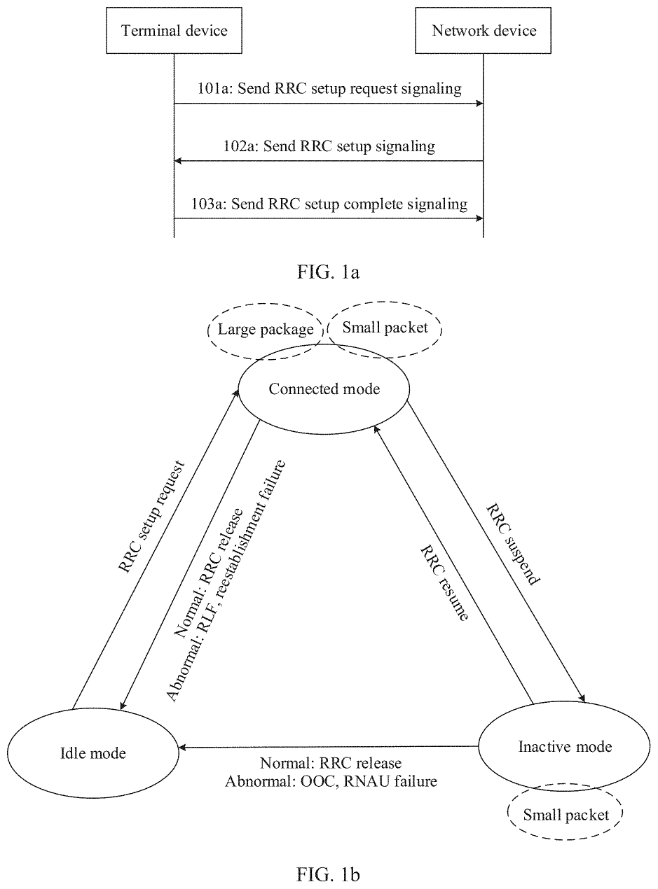

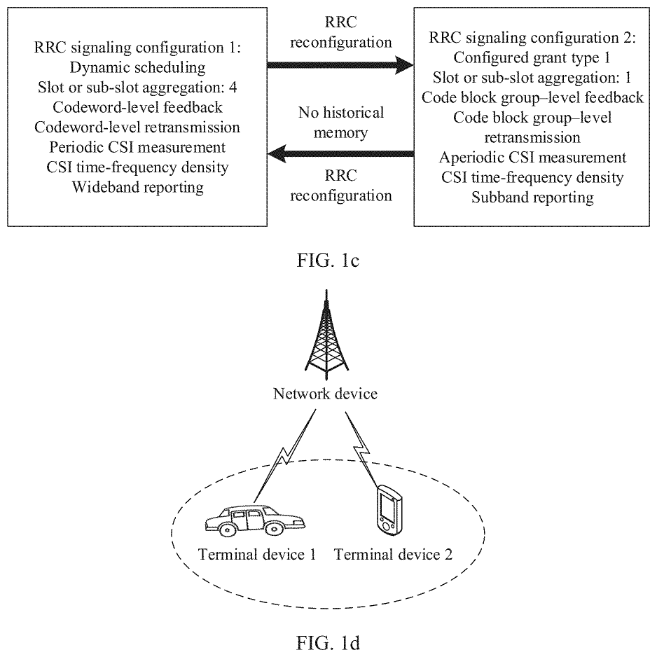

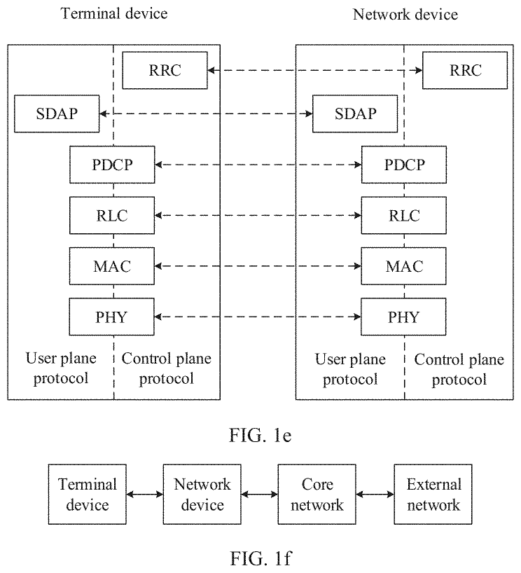

For example, as shown in FIG. 1a, a terminal device may establish an RRC connection to a network device with reference to a method shown in FIG. 1a. Specifically, the method may include the following steps.

Step 101a: the terminal device sends RRC setup request signaling to the network device. Correspondingly, the network device receives the RRC setup request signaling.

The RRC setup request signaling may be RRC Setup Request signaling.

Specifically, after completing a random access procedure and uplink synchronization, the terminal device may send a message 3 (MSG3) including the RRC setup request signaling generated at the RRC layer to the network device.

When the terminal device establishes the RRC connection to the network device for the first time, the terminal device may perform the random access procedure. Alternatively, the terminal device may perform the random access procedure based on a timing advance (TA) previously delivered by the network device when an effective range of the TA is exceeded.

Specifically, when the terminal device performs the random access procedure, the terminal device may start the random access procedure by sending a random access preamble sequence to the network device. After receiving the random access preamble sequence, the network device may feed back a random access response to the terminal device. The random access response may carry the timing advance (TA), so that the terminal device performs the random access procedure when the effective range of the TA is exceeded, and further requests to establish the RRC connection to the network device.

It should be noted that if the random access preamble sequence is not dedicated to the terminal device, the terminal device may send the message 3 to the network device and receive a message 4 (MSG4) from the network device, to perform conflict resolution.

Step 102a: the network device sends RRC setup signaling to the terminal device.

The RRC setup signaling may be RRC Setup signaling, and the RRC setup signaling may include configuration information required for establishing the RRC connection by the terminal device.

Specifically, after the network device receives the RRC setup request signaling sent by the terminal device, if the network device agrees to establish the RRC connection for the terminal device, the network device may send, to the terminal device, the RRC setup signaling including the configuration information required for establishing the RRC connection by the terminal device.

Step 103a: the terminal device sends RRC setup complete signaling to the network device.

The RRC setup complete signaling may be RRC Setup Complete signaling.

Specifically, after receiving the RRC setup signaling sent by the network device, the terminal device may perform configuration based on the configuration information in the RRC setup signaling, and send the RRC setup complete signaling to the network device after the configuration is completed, to establish the RRC connection to the network device.

In another example, as shown in FIG. 1B, the terminal device switches between an idle mode, an inactive mode, and a connected mode based on RRC signaling.

When the terminal device is in the idle mode, the terminal device may establish the RRC connection to the network device with reference to the method shown in FIG. 1a, so that the terminal device switches from the idle mode to the connected mode.

When the terminal device is in the connected mode, the network device may send RRC release signaling to the terminal device, so that the terminal device switches from the connected mode to the idle mode, or the terminal device may switch from the connected mode to the idle mode when a radio link failure (RLF) or a reestablishment failure occurs. When the terminal device is in the connected mode, the network device may alternatively send RRC suspend signaling to the terminal device, so that the terminal device switches from the connected mode to the inactive mode.

When the terminal device is in the inactive mode, the network device may send RRC resume signaling to the terminal device, so that the terminal device switches from the inactive mode to the connected mode. When the terminal device is in the inactive mode, the network device may also send the RRC release signaling to the terminal device, so that the terminal device switches from the inactive mode to the idle mode. Alternatively, when the terminal device moves out of coverage (OOC) of a network, the terminal device may send a RAN-based notification area update (RNAU) request to the network device. The network device obtains a context of the terminal device based on the RNAU request, and indicates the terminal device to release the RRC connection based on the context, so that the terminal device switches from the inactive mode to the idle mode, or indicates the terminal device to restore the RRC connection based on the context, so that the terminal device switches from the inactive mode to the connected mode.

Based on the foregoing three modes, when the random access preamble sequence is not dedicated to the terminal device, the terminal device can establish the RRC connection to the network device only after performing conflict resolution to complete the random access procedure. Consequently, a switching delay is high. In addition, receiving and sending of the RRC signaling need to be scheduled through a physical layer, for example, receiving and/or sending of DCI, and receiving and/or sending of a data channel, and a transmission delay of upper layer signaling is high, for example, tens of milliseconds to hundreds of milliseconds. As a result, when the terminal device switches between the foregoing three modes based on the RRC signaling, RRC signaling overheads are high, and a switching delay is high. Consequently, when the terminal device performs state switching, the terminal device needs to maintain a high power consumption state, resulting in high power consumption of the terminal device.

Further, when the terminal device transmit data, the terminal device may transmit data by using the physical layer based on a physical layer function parameter delivered by the network device by using the RRC signaling.

Because the terminal device has no historical memory, when the physical layer function parameter changes, the network device needs to deliver the physical layer function parameter to the terminal device again by using the RRC signaling. Even if a value of a physical layer function parameter configured by the network device for the terminal device at a moment is the same as a value of the physical layer function parameter previously configured by the network device for the terminal device, the network device still needs to re-configure the physical layer function parameter for the terminal device by using the RRC signaling. As a result, RRC signaling overheads are high, and a sending delay of the RRC signaling is high. Consequently, a switching delay of the physical layer function parameter corresponding to the terminal device is high, and power consumption of the terminal device is high.

For example, as shown in FIG. 1c, a physical layer function parameter configured by the network device for the terminal device for the first time by using the RRC signaling is an RRC signaling configuration 1, and a physical layer function parameter configured by the network device for the terminal device for the second time by using RRC reconfiguration signaling is an RRC signaling configuration 2. The RRC signaling configuration 1 includes dynamic scheduling, slot or sub-slot aggregation: 4, a codeword-level feedback, codeword-level retransmission, periodic channel state information (CSI) measurement, CSI time-frequency density, and wideband reporting. The RRC signaling configuration 2 includes: a configured grant type 1, slot or sub-slot aggregation: 1, a code block group-level feedback, code block group-level retransmission, aperiodic CSI measurement, CSI time-frequency density, and subband reporting. It is assumed that a physical layer function parameter configured by the network device for the terminal device for the third time by using the RRC reconfiguration signaling is the RRC signaling configuration 1. Because the terminal device has no historical memory, the network device still needs to send, to the terminal device by using the RRC reconfiguration information, the physical layer function parameter corresponding to the RRC signaling configuration 1. Consequently, RRC signaling overheads are high, a sending delay of the RRC signaling is high, a switching delay of the physical layer function parameter corresponding to the terminal device is high, and power consumption of the terminal device is high.

When data is transmitted based on the physical layer function parameter, RRC signaling overheads are high, a sending delay of the RRC signaling is high, a switching delay of the physical layer function parameter corresponding to the terminal device is high, and power consumption of the terminal device is high. To resolve the foregoing technical problems, an embodiment of this application provides a communication method. The method includes: a terminal device receives a first identifier indicating a first communication mode of the terminal device from a network device. The first communication mode corresponds to a physical layer function parameter used by the terminal device for communication. The terminal device determines, based on the first identifier and a first correspondence between a communication mode and a physical layer function parameter, the physical layer function parameter corresponding to the first communication mode. The communication mode in the first correspondence includes the first communication mode. The terminal device performs communication based on the physical layer function parameter corresponding to the first communication mode. In this embodiment of this application, after receiving the first identifier sent by the network device, the terminal device can determine, based on the first correspondence, the physical layer function parameter corresponding to the first communication mode corresponding to the first identifier, and further perform communication based on the physical layer function parameter corresponding to the first communication mode, so that the network device is prevented from sending RRC signaling including the physical layer function parameter to the terminal device. This reduces RRC signaling overheads, reduces a physical layer function switching delay corresponding to the terminal device, reduces power consumption of the terminal device, and reduces communication complexity.

The following describes implementations of this embodiment of this application in detail with reference to accompanying drawings in this specification.

The communication method provided in this embodiment of this application may be applied to any communication system. The communication system may be a third generation partnership project (3GPP) communication system, for example, a long term evolution (LTE) system, or may be a fifth generation (5G) mobile communications system, a new radio (NR) system, or an NR V2X system, or may be applied to an LTE and 5G hybrid networking system, or a device-to-device (D2D) communication system, a machine to machine (M2M) communication system, an internet of things (IoT), a frequency division duplex (FDD) system, a time division duplex (TDD) system, a satellite communication system, and another next-generation communication system, or may also be a non-3GPP communication system. This is not limited.

The communication method provided in this embodiment of this application may be applied to various communication scenarios, for example, may be applied to one or more of the following communication scenarios: enhanced mobile broadband (eMBB), ultra reliable low latency communication (URLLC), machine type communication (MTC), internet of things (IoT), narrow band internet of thing (NB-IoT), customer premise equipment (CPE), augmented reality (AR), virtual reality (VR), massive machine type communication (mMTC), device to device (D2D), vehicle to everything (V2X), vehicle to vehicle (V2V), and the like.

It should be noted that the IoT in this embodiment of this application may include one or more of the MTC, the NB-IoT, the mMTC, and the like. This is not limited.

This embodiment of this application is applicable to both a homogeneous network scenario and a heterogeneous network scenario, and no limitation is imposed on a transmission point. Coordinated multipoint transmission may be performed between macro base stations, between micro base stations, and between a macro base station and a micro base station. This embodiment of this application is applicable to a frequency division multiplexing system, a time division multiplexing system, a duplex system, an access and backhaul system, a relay system, and the like. This embodiment of this application is applicable to a low-frequency scenario (sub 6G), or a high-frequency scenario (above 6G), terahertz, optical communication, and the like.

The eMBB may be a traffic-intensive mobile broadband service such as a three-dimensional (3D)/ultra high-definition video. Specifically, the eMBB may further improve performance such as a network speed and user experience based on a mobile broadband service. For example, when a user watches a 4K high-definition video, a peak network speed can reach 10 Gbps.

The URLLC may be a service with high reliability, a low delay, and extremely high availability. Specifically, the URLLC may include the following communication scenarios and applications: industrial application and control, traffic safety and control, remote manufacturing, remote training, remote surgery, self driving, industrial automation, security protection industry, and the like.

The MTC may be a low-cost and coverage-enhanced service, and may also be referred to as M2M. The mMTC is a massive internet of things service.

The NB-IoT may be a service characterized by wide coverage, massive connections, a low rate, low costs, low power consumption, an excellent architecture, and the like. Specifically, the NB-IoT may include smart water meters, smart parking, smart pet tracking, smart bicycles, smart smoke detectors, smart toilets, smart vending machines, and the like.

The CPE may be a mobile signal access device that receives a mobile signal and forwards the mobile signal as a wireless fidelity (Wi-Fi) signal, or may be a device that converts a high-speed 4G or 5G signal into a Wi-Fi signal, and may support a relatively large quantity of mobile terminals in simultaneously accessing the internet. The CPE can be widely used in rural areas, towns, hospitals, organizations, factories, and residential communities to provide wireless network access, to reduce costs of wired network deployment.

The V2X enables communication between vehicles, between a vehicle and a network device, and between network devices, to obtain a series of traffic information such as real-time road conditions, road information, and pedestrian information, and provide in-vehicle entertainment information. This improves driving safety, reduces congestion, and improves traffic efficiency.

The following describes the communication method provided in this embodiment of this application by using FIG. 1d as an example.

FIG. 1d is a schematic diagram of a communication system according to an embodiment of this application. As shown in FIG. 1d, the communication system may include a terminal device and a network device.

The terminal device in FIG. 1d may be located in a cell coverage area of the network device. The terminal device may perform air interface communication with the network device by using an uplink (UL) or a downlink (DL). In a UL direction, the terminal device may send data to the network device by using an uplink physical layer shared channel (PUSCH). In a DL direction, the network device may send a PDCCH carrying DCI to the terminal device, or may send data to the terminal by using a downlink physical layer shared channel ( ).

The uplink physical layer shared channel may also be referred to as a physical uplink shared channel for short. The downlink physical layer shared channel may also be referred to as a physical downlink shared channel for short.

Specifically, a schematic diagram of a network architecture is shown in FIG. 1e. The terminal device may include a physical layer (PHY), a media access control (MAC) layer, a radio link control (RLC) layer, a packet data convergence protocol (PDCP) layer, a service data adaptation protocol (SDAP) layer, and a radio resource control (RRC) layer. The terminal device may include a user plane protocol and a control plane protocol.

For example, the terminal device in FIG. 1d may be referred to as a terminal, user equipment (UE), a mobile station (MS), a mobile terminal (MT), or the like, and may be a device that provides voice and/or data connectivity for a user. Specifically, the terminal device in FIG. 1d may be a mobile phone, an uncrewed aerial vehicle, a tablet computer, a computer having a wireless transceiver function, a handheld device having a wireless connection function, a vehicle-mounted device, or the like. Alternatively, the terminal device may be a palmtop computer, a mobile internet device (MID), a wearable device, an eMBB terminal, a URLLC terminal, an MTC terminal, an NB-IoT terminal, a CPE terminal, a VR terminal, an AR terminal, a V2X terminal, a wireless terminal in industrial control, a wireless terminal in self driving, a wireless terminal in remote medical, a wireless terminal in a smart grid, a wireless terminal in transportation safety, a wireless terminal in a smart city, a wireless terminal in smart home, a sensor, a cellular phone, a cordless phone, a session initiation protocol (SIP) phone, a wireless local loop (WLL) station, a personal digital assistant (PDA), a computing device or another processing device connected to a wireless modem, a vehicle-mounted terminal, a vehicle having a vehicle-to-vehicle (V2V) communication capability, and an uncrewed aerial vehicle (UAV) having an uncrewed aerial vehicle to uncrewed aerial vehicle communication capability, a terminal device in a 5G network, a terminal device in a future evolved public land mobile network (PLMN), or the like. This is not limited.

The wearable device may also be referred to as a wearable intelligent device and is a general term of wearable devices, such as glasses, gloves, watches, clothes, and shoes, that are developed by applying wearable technologies to intelligent designs of daily wear. The wearable device is a portable device that can be directly worn on the body or integrated into clothes or an accessory of a user. The wearable device is not only a hardware device, but also implements a powerful function through software support, data exchange, and cloud interaction. Generalized wearable intelligent devices include full-featured and large-size devices that can implement complete or partial functions without depending on smartphones, such as smart watches or smart glasses, and devices that focus on only one type of application and need to work with other devices such as smartphones, such as various smart bands or smart jewelry for monitoring physical signs.

In addition, the terminal device may alternatively be a terminal device in an internet of things (IoT) system. An IoT is an important part in future development of information technologies. A main technical feature of the IoT is to connect things to a network by using a communication technology, to implement an intelligent network for human-machine interconnection and thing-thing interconnection. The IoT technology can implement massive connections, deep coverage, and power saving for terminals by using, for example, a narrow band (NB) technology.

In addition, the terminal device may alternatively include sensors such as an intelligent printer, a train detector, and a gas station, and main functions include: collecting data, receiving control information and downlink data of a network device, sending an electromagnetic wave, and transmitting uplink data to the network device.

The network device in FIG. 1d may be any device having a wireless transceiver function, and may be configured to be responsible for functions related to an air interface, for example, a radio link maintenance function, a radio resource management function, or some mobility management functions. The radio link maintenance function is used to maintain a radio link to the terminal device, and is responsible for protocol conversion between radio link data and internet protocol (IP) data. The radio resource management function may include functions such as radio link establishment and release, and radio resource scheduling and allocation. Some mobility management functions may include configuring the terminal device for measurement, evaluating radio link quality of the terminal device, determining handover of the terminal device between cells, and the like.

Specifically, a schematic diagram of protocol stacks of the terminal device and the network device may be shown in FIG. 1e. The protocol stack of the network device may include a PHY layer, a MAC layer, an RLC layer, a PDCP layer, a SDAP layer, and an RRC layer. The protocol stack of the network device also includes a user plane protocol and a control plane protocol, and layers of the terminal device and the network device may be connected to each other to transmit information.

For example, the network device may be a device supporting wired access, or may be a device supporting wireless access. For example, the network device may be an access network (AN)/radio access network (RAN) device, where the AN/RAN device includes a plurality of AN/RAN nodes. The AN/RAN node may be an access point (AP), a NodeB (NB), an enhanced NodeB (eNB), a next-generation NodeB (gNB), a transmission reception point (TRP), a transmission point (transmission point, TP), another access node, or the like.

Currently, examples of some RAN nodes may be: a continuing evolved NodeB (gNB), a transmission reception point (TRP), an evolved NodeB (eNB), a radio network controller (RNC), a home evolved NodeB (for example, a home evolved NodeB, or a home NodeB, HNB), a wireless fidelity (Wi-Fi) access point (AP), a wireless relay node, a wireless backhaul node, a transmission point (TP), a transmission reception point (TRP), or the like, and may also be a gNB or a transmission point (a TRP or a TP) in a 5G system such as an NR system, or an antenna panel or a group of antenna panels of a base station in a 5G system, or may be a network node that constitutes a gNB or a transmission point, for example, a baseband unit (BBU) or a distributed unit (DU), D2D, V2X, or a device serving as a base station in machine-to-machine (M2M) communication, or a base station in a future communication system.

In some deployments, the gNB may include a central unit (CU) and a DU, and the gNB may further include an active antenna unit (AAU). The CU can implement some functions of the gNB, and the DU can implement some functions of the gNB. For example, the CU is responsible for processing a non-real-time protocol and service, to implement functions of a radio resource control RRC layer and a packet data convergence protocol (PDCP) layer. The DU is responsible for processing a physical layer protocol and a real-time service, to implement functions of a radio link control (RLC) layer, a medium access control (MAC) layer, and a physical (PHY) layer. The AAU implements some physical layer processing functions, radio frequency processing, and a function related to an active antenna. Information at the RRC layer eventually becomes information at the PHY layer, or is changed from information at the PHY layer. Therefore, in this architecture, higher-layer signaling such as RRC layer signaling may also be considered as being sent by the DU or sent by the DU and the AAU. It may be understood that the network device may be a device including one or more of a CU node, a DU node, and an AAU node. In addition, the CU may be classified into a network device in an access network (RAN), or the CU may be classified into a network device in a core network (CN). This is not limited in this application.

The network device may serve a cell, and a terminal device communicates with the cell by using a transmission resource (for example, a frequency domain resource or a spectrum resource) allocated by the network device. The cell may belong to a macro base station (for example, a macro eNB or a macro gNB), or may belong to a base station corresponding to a small cell. The small cell herein may include a metro cell, a micro cell, a pico cell, a femto cell, and the like. These small cells are characterized by small coverage and low transmit power, and are applicable to providing a high-rate data transmission service.

In this embodiment of this application, a measurement unit of time domain for communication may be referred to as a time unit or a time scheduling unit. The time scheduling unit or the time unit may be a radio frame, a subframe, a slot, a mini-slot, a sub-slot, or the like. The time scheduling unit or the time unit may also be one or more symbols or the like, where the symbol is a basic unit in time domain.

In this embodiment of this application, a measurement unit of frequency domain for communication may be referred to as a frequency domain resource unit or a frequency domain scheduling unit. The frequency domain resource unit may be a basic resource element (RE), a resource block, a resource block group, or the like. One resource block may include one or more resource elements. One resource block group may include one or more resource blocks. For example, a frequency domain resource unit used for data transmission may include several basic resource elements, one RE may correspond to one subcarrier, and one physical resource block (PRB) has X1 basic resource elements, where X1 is an integer greater than or equal to 1. For example, X1 is 12.

It should be noted that the terminal device and the network device in this embodiment of this application may be one or more chips, or may be a system on chip (SOC), or the like. FIG. 1d is merely an example of the accompanying drawing, and a quantity of devices included in FIG. 1d is not limited. Names of devices and links in FIG. 1d are not limited. In addition to the names shown in FIG. 1d, the devices and the links may have other names. For example, the terminal device communicates with the network device through a user equipment (Uu) interface, or UL may be named as a Uu link. This is not limited.

In addition to the device shown in FIG. 1d, as shown in FIG. 1f, the communication system may further include a core network and an external network.

For example, a mobile network may be divided into three parts: a base station subsystem, a network subsystem, and a system support part. The network device may be located in the base station subsystem, and the core network may be located in the network subsystem.

Specifically, the core network may be configured to transmit a call request or a data request from an air interface to different external networks. The core network may serve as an interface provided by a bearer network for the external network, and may provide functions such as user connection, user management, and a bearer connection.

For example, establishment of the user connection may include functions such as mobility management (MM), call management (CM), switching/routing, and recording notification. The user management may include functions such as user description, quality of service (QoS), user communication accounting, virtual home environment (VHE) (for example, a virtual home environment provided by using a session with an intelligent network platform), and security (for example, corresponding security measures provided by an authentication center, including security management for a mobile service and security processing for external network access). The bearer connection (access to) includes functions such as an external public interactive telephone network (PSTN), an external circuit data network and packet data network, internet, intranets, and short message service (SMS) server of a mobile operator. A basic service provided by the core network may include mobile office, e-commerce, communication, an entertainment service, a travel and location-based service, a telemetry service, a simple message transfer service (monitoring and control), or the like.

The external network may be an operator network that provides a data transmission service for a user, for example, may be an operator network that provides an IP multimedia service (IMS) for the user. An application server may be deployed in the DN, and the application server may provide a data transmission service for the user. Specifically, the operator may include a public land mobile network (PLMN). The PLMN is a network established and operated by a government or an operator approved by the government to provide a land mobile communication service for the public, for example, may be a network of China Mobile, a network of China Unicom, or a network of China Telecom.

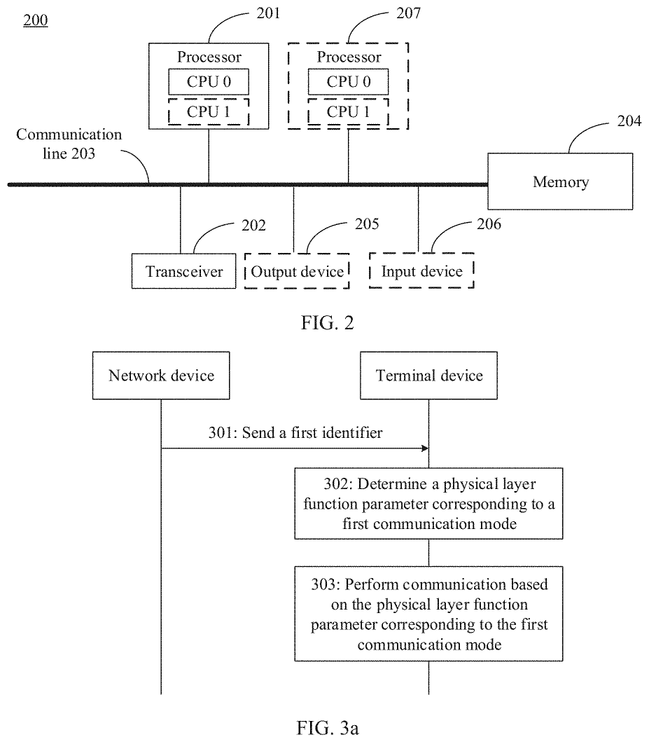

During specific implementation, as shown in FIG. 1d, each terminal device and each network device may use a composition structure shown in FIG. 2, or include components shown in FIG. 2. FIG. 2 is a schematic diagram of composition of a communication apparatus 200 according to an embodiment of this application. The communication apparatus 200 may be a terminal device, or a chip or a system-on-a-chip in the terminal device; or may be a network device, or a chip or a system-on-a-chip in the network device. As shown in FIG. 2, the communication apparatus 200 includes a processor 201, a transceiver 202, and a communication line 203.

Further, the communication apparatus 200 may further include a memory 204. The processor 201, the memory 204, and the transceiver 202 may be connected through the communication line 203.

The processor 201 is a central processing unit (CPU), a general-purpose processor, a network processor (NP), a digital signal processor (DSP), a microprocessor, a microcontroller, a programmable logic device (PLD), or any combination thereof. Alternatively, the processor 201 may be another apparatus having a processing function, for example, a circuit, a component, or a software module. This is not limited.

The transceiver 202 is configured to communicate with another device or another communication network. The another communication network may be an Ethernet, a radio access network (RAN), a wireless local area network (WLAN), or the like. The transceiver 202 may be a module, a circuit, a transceiver, or any apparatus that can implement communication.

The communication line 203 is configured to transmit information between the components included in the communication apparatus 200.

The memory 204 is configured to store instructions. The instructions may be a computer program.

The memory 204 may be a read-only memory (ROM) or another type of static storage device that can store static information and/or instructions, may be a random access memory (RAM) or another type of dynamic storage device that can store information and/or instructions, or may be an electrically erasable programmable read-only memory (EEPROM), a compact disc read-only memory (CD-ROM) or another compact disc storage, an optical disc storage (including a compressed optical disc, a laser disc, an optical disc, a digital universal optical disc, a Blu-ray disc, or the like), a magnetic disk storage medium or another magnetic storage device, or the like. This is not limited.

It should be noted that the memory 204 may be independent of the processor 201, or may be integrated with the processor 201. The memory 204 may be configured to store instructions, program code, some data, or the like. The memory 204 may be located inside the communication apparatus 200, or may be located outside the communication apparatus 200. This is not limited. The processor 201 is configured to execute the instructions stored in the memory 204, to implement the communication method provided in the following embodiments of this application.

In an example, the processor 201 may include one or more CPUs, for example, a CPU 0 and a CPU 1 in FIG. 2.

In an optional implementation, the communication apparatus 200 includes a plurality of processors. For example, in addition to the processor 201 in FIG. 2, the communication apparatus 200 may further include a processor 207.

In an optional implementation, the communication apparatus 200 further includes an output device 205 and an input device 206. For example, the input device 206 is a device, for example, a keyboard, a mouse, a microphone, or a joystick, and the output device 205 is a device, for example, a display or a speaker.

It should be noted that the communication apparatus 200 may be a desktop computer, a portable computer, a network server, a mobile phone, a tablet computer, a wireless terminal, an embedded device, a chip system, or a device having a structure similar to a structure in FIG. 2. In addition, the composition structure shown in FIG. 2 does not constitute a limitation on the communication apparatus. In addition to the components shown in FIG. 2, the communication apparatus may include more or fewer components than components shown in the figure, combine some components, or have different component arrangements.

In this embodiment of this application, the chip system may include a chip, or may include a chip and another discrete component.

In addition, for actions, terms, and the like in embodiments of this application, refer to each other. This is not limited. In embodiments of this application, names of messages exchanged between devices, names of parameters in the messages, or the like are merely examples. Other names may alternatively be used during specific implementation. This is not limited.

The communication method shown in embodiments of this application may be applied to communication between a first communication apparatus and a second communication apparatus. The first communication apparatus may be a terminal device or a network device. The second communication apparatus may be a terminal device or a network device. The following embodiment is described by using an example in which the first communication apparatus is a terminal device and the second communication apparatus is a network device. It should be noted that the communication method shown in embodiments of this application may be applied to communication between a terminal device and a network device, or may be applied to communication between terminal devices, or may be applied to communication between network devices. The communication between network devices may be coordinated multipoint transmission between macro base stations, between micro base stations, or between a macro base station and a micro base station.

With reference to the communication system shown in FIG. 1d, the communication method provided in embodiments of this application is described by using an example in which the communication method shown in embodiments of this application is applied to communication between a terminal device and a network device. The terminal device may be any terminal device in the communication system, and the network device may be any network device in the communication system. The terminal device and the network device described in the following embodiment may have the components shown in FIG. 2.

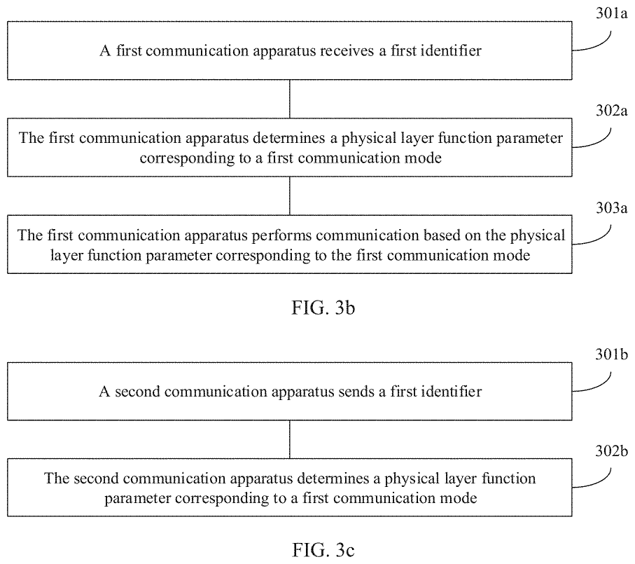

FIG. 3a is a flowchart of a communication method according to an embodiment of this application. As shown in FIG. 3a, the method may include the following steps.

Step 301: the network device sends a first identifier to the terminal device. Correspondingly, the terminal device receives the first identifier.

The first identifier may indicate a first communication mode of the terminal device, and the first communication mode corresponds to a physical layer function parameter used by the terminal device for communication.

Optionally, the network device may send DCI including the first identifier to the terminal device. In other words, the network device may send the first identifier to the terminal device by using physical layer signaling.

Optionally, the network device may send the first identifier to the terminal device by using upper layer signaling.

Optionally, the first identifier may be one or more of the following: an identifier of a communication mode, an identifier of a physical layer function parameter corresponding to the communication mode, an identifier of a type of the physical layer function parameter corresponding to the communication mode, an identifier of a configuration manner of the physical layer function parameter corresponding to the communication mode, an identifier of a configuration parameter of the configuration manner of the physical layer function parameter corresponding to the communication mode, and the like.

For example, the network device may send 1 bit to indicate an identifier of a communication mode (for example, DCI, RRC signaling, or MAC signaling). For example, 0 indicates the first communication mode, and 1 indicates a second communication mode; or 0 indicates a second communication mode, and 1 indicates the first communication mode.

1 bit in this embodiment of this application may alternatively be M bits, and M is a positive integer greater than or equal to 1, for example, 2 bits. This is not specifically limited in this application.

A quantity of bits may depend on a quantity of communication modes. For example, a quantity of bits is equal to log 2 (a quantity of communication modes) rounded up.

According to the foregoing design, one-click quick switching of the communication mode can be implemented, for example, switching from the first communication mode to the second communication mode, or switching from the second communication mode to the first communication mode. This can reduce RRC signaling overheads, reduce a parameter configuration delay, and avoid RRC reconfiguration.

Optionally, the network device may determine at least one communication mode for the terminal device based on a terminal type of the terminal device. The communication mode may correspond to the physical layer function parameter used by the terminal device for communication, and the communication mode corresponding to the terminal device may include the first communication mode.

Further, the network device may send a first correspondence between each communication mode and a physical layer function parameter to the terminal device, so that the terminal device determines, based on the communication mode, the physical layer function parameter corresponding to the communication mode.

The network device may send the first correspondence to the terminal device by using the upper layer signaling or the physical layer signaling. The upper layer signaling may be RRC signaling, MAC signaling, or the like. This is not limited.

Alternatively, the communication mode corresponding to the terminal type of the terminal device and the first correspondence between a communication mode and a physical layer function parameter may be pre-specified in a communication protocol. The communication mode corresponding to the terminal type of the terminal device may include the first communication mode.

Terminal devices belonging to a same terminal type may correspond to a same communication mode. The communication mode corresponding to the terminal type of the terminal device may also be described as a communication mode corresponding to the terminal device, or may be described as a communication mode corresponding to the terminal type.

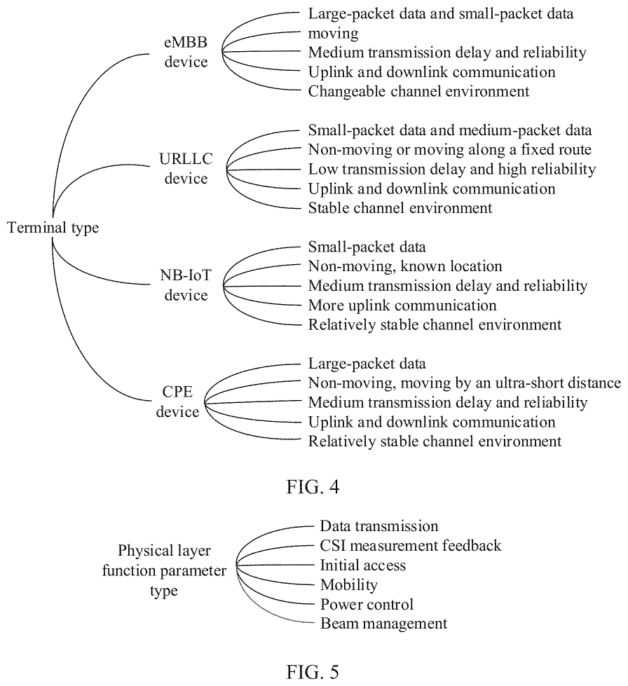

It should be noted that, for specific descriptions of the terminal type of the terminal device, refer to the following related descriptions of FIG. 4. For specific descriptions of the physical layer function parameter and the first correspondence, refer to the following related descriptions of FIG. 5 to FIG. 15. Details are not described herein again. Specifically, when the terminal device performs communication, the network device may determine the first communication mode for the terminal device from one or more communication modes corresponding to the terminal device, and send the first identifier corresponding to the first communication mode to the terminal device, so that the terminal device determines the first communication mode based on the first identifier, and performs communication by using the physical layer function parameter corresponding to the first communication mode. Therefore, the network device is prevented from sending the RRC signaling including the physical layer function parameter to the terminal device. This reduces RRC signaling overheads, reduces a switching delay of the physical layer function corresponding to the terminal device, reduces power consumption of the terminal device, and reduces communication complexity.

For example, when the terminal device performs data transmission, the network device may determine, for the terminal device based on a data transmission requirement of the terminal device, the first communication mode that meets the data transmission requirement of the terminal device from the one or more communication modes corresponding to the terminal device, so that the terminal device performs communication based on the physical layer function parameter corresponding to the first communication mode, to improve communication quality.

Step 302: the terminal device determines, based on the first identifier and the first correspondence between a communication mode and a physical layer function parameter, the physical layer function parameter corresponding to the first communication mode.

The communication mode in the first correspondence may include the first communication mode.

Optionally, the terminal device may receive the first correspondence from the network device, and determine, based on the first correspondence and the first identifier, the physical layer function parameter corresponding to the first communication mode.

Alternatively, when the communication mode corresponding to the terminal type and the first correspondence between a communication mode and a physical layer function parameter are pre-specified in the communication protocol, the terminal device may determine, based on the first correspondence specified in the communication protocol and the first identifier sent by the network device, the physical layer function parameter corresponding to the first communication mode.

Step 303: the terminal device performs communication based on the physical layer function parameter corresponding to the first communication mode.

Alternatively, based on the method shown in FIG. 3a, as shown in FIG. 3b, the communication method provided in this embodiment of this application may be described from a perspective of the first communication apparatus.

FIG. 3b is a flowchart of a communication method according to an embodiment of this application. As shown in FIG. 3b, the method may include the following steps.

Step 301a: the first communication apparatus receives the first identifier.

Specifically, for specific descriptions in which the first communication apparatus receives the first identifier, refer to the related descriptions in which the terminal device receives the first identifier in step 301. Details are not described again.

Step 302a: the first communication apparatus determines the physical layer function parameter corresponding to the first communication mode.

Specifically, for specific descriptions in which the first communication apparatus determines the physical layer function parameter corresponding to the first communication mode, refer to the related descriptions in which the terminal device determines the physical layer function parameter corresponding to the first communication mode in step 302. Details are not described again.

Step 303a: the first communication apparatus performs communication based on the physical layer function parameter corresponding to the first communication mode.

Specifically, for specific descriptions in which the first communication apparatus performs communication based on the physical layer function parameter corresponding to the first communication mode, refer to the related descriptions in which the terminal device performs communication based on the physical layer function parameter corresponding to the first communication mode in step 303. Details are not described again.

Alternatively, based on the method shown in FIG. 3a and FIG. 3b, as shown in FIG. 3c, the communication method provided in this embodiment of this application may be described from a perspective of the second communication apparatus.

FIG. 3c is a flowchart of a communication method according to an embodiment of this application. As shown in FIG. 3c, the method may include the following steps.

Step 301b: the second communication apparatus sends the first identifier.

Specifically, for specific descriptions in which the second communication apparatus sends the first identifier, refer to the related descriptions in which the network device receives the first identifier in step 301. Details are not described again.

Step 302b: the second communication apparatus determines the physical layer function parameter corresponding to the first communication mode.

Specifically, for specific descriptions in which the second communication apparatus determines the physical layer function parameter corresponding to the first communication mode, refer to the related descriptions in which the network device determines the physical layer function parameter corresponding to the first communication mode in step 302. Details are not described again.

It should be noted that an execution sequence of step 301b and step 302b is not limited. Step 302b may be performed before step 301b, or step 301b may be performed before step 302b, or step 301b and step 302b may be performed simultaneously.

This embodiment of this application may be an independent embodiment, or may be combined with another embodiment of this application. This is not specifically limited in this application.

Based on the method shown in FIG. 3a, after receiving the first identifier sent by the network device, the terminal device can determine, based on the first correspondence, the physical layer function parameter corresponding to the first communication mode corresponding to the first identifier, and further perform communication based on the physical layer function parameter corresponding to the first communication mode, so that the network device is prevented from sending RRC signaling including the physical layer function parameter to the terminal device. This reduces RRC signaling overheads, reduces a physical layer function switching delay corresponding to the terminal device, reduces power consumption of the terminal device, and reduces communication complexity.

Based on the method shown in FIG. 3a, when the terminal type corresponding to the terminal device is determined, the terminal type corresponding to the terminal device may be determined based on one or more of the following factors: a service type, mobility, a transmission delay requirement, a channel environment, a reliability requirement, a coverage requirement, and a communication scenario.

Optionally, the service type may be determined based on a size of service data. For example, the service type may include large-packet data, medium-packet data, small-packet data, and the like. The mobility may include moving and fixing. The moving may also include irregular moving, moving along a fixed route, moving by an ultra-short distance, and the like. The transmission delay requirement may include a high transmission delay, a low transmission delay, a medium transmission delay, and the like. The channel environment may include a changeable channel environment, a stable channel environment, a relatively stable channel environment, and the like. The reliability requirement may include high reliability, low reliability, medium reliability, and the like. The coverage requirement may include wide coverage, strong coverage, weak coverage, medium coverage, deep coverage, and the like. The communication scenario may include the communication scenario included in the foregoing descriptions of the communication system, or the communication scenario may include uplink communication, downlink communication, uplink and downlink communication, sidelink communication, full-duplex communication, access communication, backhaul communication, relay communication, and the like. This is not limited.

For example, as shown in FIG. 4, the terminal type includes one or more of the following: an eMBB device, a URLLC device, an IoT device, a CPE device, and a V2X device. The eMBB device is mainly configured to transmit large-packet data, or may be configured to transmit small-packet data. The eMBB device is usually in a moving state, and has medium requirements for a transmission delay and reliability. The eMBB device performs both uplink communication and downlink communication, has a relatively complex and changeable channel environment, and may perform indoor communication or outdoor communication. For example, the eMBB device may be a mobile phone. The URLLC device is mainly configured to transmit small-packet data, or may transmit medium-packet data. The URLLC device is usually in a non-moving state, or may move along a fixed route, and has high requirements for a transmission delay and reliability, that is, requires a low transmission delay and high reliability. The URLLC device performs both uplink communication and downlink communication, and has a stable channel environment. For example, the URLLC device may be a factory device. The IoT device is mainly configured to transmit small data, is usually in a non-moving state, and has a known location. The IoT device has medium requirements for a transmission delay and reliability, performs more uplink communication, and has a relatively stable channel environment. For example, the IoT device may be a smart water meter or a sensor. The CPE device is mainly configured to transmit large-packet data, and is usually in a non-moving state, or may move by an ultra-short distance. The CPE device has medium requirements for a transmission delay and reliability, performs both uplink communication and downlink communication, and has a relatively stable channel environment. For example, the CPE device may be a terminal device, an AR, or a VR in smart home. When the terminal type of the terminal device is determined, the terminal type corresponding to the terminal device may be determined as the eMBB device, the URLLC device, the IoT device, or the CPE device based on the service type, the mobility, the transmission delay requirement, the reliability requirement, the channel environment, and the communication scenario of the terminal device.

It should be noted that the eMBB device may also be described as eMBB, the URLLC device may also be described as URLLC, the IoT device may also be described as IoT, the CPE device may also be described as CPE, and the V2X device may also be described as V2X. This is not limited.

Based on the method shown in FIG. 3a, as shown in FIG. 5, the type of the physical layer function parameter may be one or more of the following: data transmission, a channel state information CSI measurement feedback, initial access, mobility, power control, and beam management.

Optionally, the terminal device and/or the network device may determine the type of the physical layer function parameter based on the terminal type.

The physical layer function parameter includes a first parameter field. The first parameter field indicates the configuration manner of the physical layer function parameter. The configuration manner includes a second parameter field. The second parameter field includes the configuration parameter of the configuration manner.

Optionally, the data transmission may include one or more of the following: a scheduling manner, a feedback manner, a retransmission mechanism, and the like.

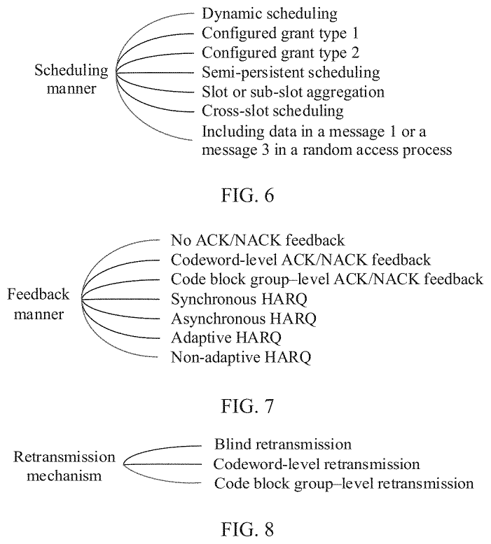

For example, as shown in FIG. 6, the scheduling manner may include one or more of the following configuration manners: dynamic scheduling (dynamic grant), a configured grant (configured grant, cg) type 1 (configured grant type 1), a configured grant type 2 (configured grant type 2), semi-persistent scheduling (SPS), slot or sub-slot aggregation, cross-slot scheduling, and including data in a message 1 or a message 3 in a random access process. Alternatively, the scheduling manner may not be limited to the foregoing manner, and may be another scheduling manner. This is not limited in this application.

The dynamic scheduling may be a scheduling manner of transmitting data based on DCI scheduling. To be specific, when receiving the DCI, the terminal device may transmit data based on the DCI.

The configured grant type 1 may be referred to as a grant-free transmission mode (grant free). Data may be transmitted by using the configured grant type 1 based on scheduling information configured by using the RRC signaling. This may not be indicated by the DCI.

The configured grant type 2 may also be referred to as a grant-free transmission mode, and the configured grant type 2 may be activated or deactivated by using the DCI. After the configured grant type 2 is activated by using the DCI, the terminal device may transmit data based on the scheduling information configured by using the RRC signaling.

Data transmission based on a configured grant type may not be scheduled by using the DCI, to implement fast data transmission of the terminal device, and reduce a transmission delay, and may be used for a terminal device having a high transmission delay requirement.

For example, the network device may configure a transmission resource by using the RRC signaling. When the terminal device needs to transmit data, the terminal device may directly transmit data on the transmission resource configured by the network device, to reduce a transmission delay.

For the semi-persistent scheduling, a plurality of times of transmission may be scheduled by using one piece of DCI, and the DCI indicates to stop data transmission. Alternatively, for the semi-persistent scheduling, a quantity of transmission times may be predefined, and the semi-persistent scheduling may be used by the terminal device to transmit large-packet data. When the terminal device transmits data based on the semi-persistent scheduling, the terminal device can implement fast large-packet data transmission, DCI signaling overheads are reduced, and a transmission delay is reduced.

For example, the terminal device may transmit data for a plurality of times after receiving the DCI, and stop transmitting data after receiving next DCI. Alternatively, the terminal device may transmit data based on the quantity of transmission times carried in the DCI.

The slot or sub-slot aggregation may mean that one time of data transmission may occupy one or more slots, or one time of data transmission may occupy one or more sub-slots. Specifically, a quantity of slots or sub-slots occupied by one time of data transmission may be indicated by using an aggregation factor, and the terminal device may determine the aggregation factor based on an upper layer signaling indication or a physical layer signaling indication. When the terminal device transmits data based on the slot or sub-slot aggregation, the terminal device can perform fast data transmission for a plurality of times, DCI signaling overheads are reduced, and a transmission delay is reduced. This is applicable to a terminal device having a high reliability requirement.

For example, the terminal device may transmit data in a plurality of slots or sub-slots by using one piece of DCI, to implement a plurality of times of fast and efficient data transmission. This reduces DCI overheads, and reduces a transmission delay.

Specifically, when the terminal device transmits data based on the slot or sub-slot aggregation, the data in the plurality of slots or sub-slots may be same data of different redundancy versions, and a diversity gain is obtained through repeated transmission for a plurality of times, to reduce a bit rate, and improve data transmission reliability. The data in the plurality of slots or sub-slots may also be different data, to implement fast large-packet data transmission. This reduces DCI overheads, reduces a transmission delay, and increases a data transmission capacity.

The cross-slot scheduling may mean that a slot in which the DCI is located is not the same as a slot in which the data is located. Based on the cross-slot scheduling, the terminal device may reserve a subsequent slot when there is no transmission resource in a current slot, to prepare for data receiving and sending in advance, thereby reducing a transmission delay.

The including data in a message 1 or a message 3 in a random access process may mean that when sending a random access preamble sequence of an RACH, the terminal device may transmit data on a corresponding time-frequency resource to avoid DCI scheduling, or may mean that the terminal device transmits data in the message 3 based on random access response (RAR) scheduling in the random access process. The terminal device includes data in the message 1 or the message 3 in the random access process, so that the data can be quickly sent. This reduces a transmission delay, and improves transmission efficiency.

For example, as shown in FIG. 7, the feedback manner may include one or more of the following configuration manners: no acknowledgement/negative acknowledgement (ACK/NACK) feedback, a codeword-level ACK/NACK feedback, a code block group-level ACK/NACK feedback, a synchronous hybrid automatic repeat request (HARQ), an asynchronous HARQ, an adaptive HARQ, and a non-adaptive HARQ. Alternatively, the feedback manner may not be limited to the foregoing manner, and may be another feedback manner. This is not limited in this application.

No ACK/NACK feedback may mean that the terminal device does not need to feed back an ACK/a NACK after receiving or sending data. Based on this feedback manner, the terminal device may transmit data in a blind retransmission manner, and the network device does not need to feed back the ACK/NACK. This reduces feedback overheads, reduces a delay, and improves communication quality. Based on this feedback manner, the network device may transmit data in a blind retransmission manner, and the terminal device does not need to feed back the ACK/NACK. This reduces feedback overheads, reduces a delay, and improves communication quality.

The codeword-level ACK/NACK feedback may mean that a granularity of ACK/NACK feedback data is a codeword. For example, an ACK may be fed back when a codeword is correctly transmitted, and a NACK may be fed back when the codeword is incorrectly transmitted. It should be noted that a codeword may also be referred to as a transmission block (TB).

The code block group-level ACK/NACK feedback may mean that a granularity of ACK/NACK feedback data is a code block group. One codeword may include one or more code blocks. The terminal device may group a plurality of code blocks in the codeword or the transmission block, and grouped code blocks are referred to as a code block group (CBG). For example, one codeword includes a code block group 1 and a code block group 2. An ACK is fed back when the code block group 1 is correctly transmitted, a NACK is fed back when the code block group 1 is incorrectly transmitted, an ACK is fed back when the code block group 2 is correctly transmitted, and a NACK is fed back when the code block group 2 is incorrectly transmitted. It should be noted that a maximum quantity of CBGs may be 2, 4, 6, 8, or the like.

Compared with the codeword-level ACK/NACK feedback, based on the code block group-level ACK/NACK feedback, a feedback at a smaller granularity can be implemented. Because one TB is divided into a plurality of code blocks (CBs), during decoding, the terminal device may know whether each CB is correctly transmitted. When the code block group-level ACK/NACK feedback is used, an ACK/NACK feedback may be performed on each CB. When a TB fails to be decoded, the terminal device may retransmit only a CB that is incorrectly transmitted, and does not need to retransmit the entire TB. This can reduce retransmitted redundant information, and improve resource utilization.

However, a relatively large quantity of ACKs/NACKs need to be fed back when a code block group-level ACK/NACK feedback is used. Consequently, overheads of feedback signaling for data transmission are high, and a resource waste is also caused. Therefore, a compromise between a TB-based feedback and a CB-based feedback may be used as a feedback manner for data transmission. To be specific, a plurality of CBs in a TB are grouped, and grouped CBs are referred to as a CBG. A corresponding ACK/NACK is fed back based on each CBG, and retransmission is performed based on the CBG. A terminal device configuration may be classified into two types. One type supports a CBG-based feedback, and the other type does not support the CBG-based feedback. Only a terminal device for which CBG-based transmission is configured can retransmit data based on a CBG feedback. This improves resource utilization and avoids retransmission of redundant information, and can further avoid excessively large feedback signaling and avoid a resource waste.

Because a HARQ protocol is classified into a synchronous HARQ protocol and an asynchronous HARQ protocol in time domain, and is classified into an adaptive HARQ protocol and a non-adaptive HARQ protocol in frequency domain, the feedback manner may further include one or more of the following: synchronous HARQ, asynchronous HARQ, adaptive HARQ, and non-adaptive HARQ. Asynchronous/synchronous and adaptive/non-adaptive indicate a relationship between previous transmission and retransmission.

In the synchronous HARQ, retransmission of each HARQ process can be performed only at a fixed moment after previous data transmission, that is, for a time unit such as a specific subframe or slot, only a specific HARQ process can be used. Based on the synchronous HARQ, the terminal device may directly derive a HARQ process number based on a time unit number such as a system frame number/subframe number/slot number. In other words, the HARQ process may be directly derived from the system frame number/subframe number, and the HARQ process number does not need to be explicitly sent.

In the asynchronous HARQ, for a same HARQ process, the HARQ process can be used to process only one TB at a same transmission time interval. Based on the asynchronous HARQ, retransmission may occur at any moment/time unit. In other words, the terminal device can use the HARQ processes in any order, to improve flexibility of retransmission scheduling.

In the adaptive HARQ, a used physical resource block (PRB) resource, a modulation and coding scheme (MCS), and the like may be changed. To be specific, a PRB and/or an MCS, and the like in the retransmission may be different from those in previous transmission.

In the non-adaptive HARQ, a PRB resource and an MCS that are the same as those used in previous transmission need to be used in retransmission. The previous transmission may be initial transmission, or may be previous retransmission.

For example, as shown in FIG. 8, the retransmission mechanism may include one or more of the following configuration manners: blind retransmission, codeword-level retransmission, and code block group-level retransmission. Alternatively, the retransmission mechanism may not be limited to the foregoing manners, and may be another retransmission mechanism. This is not limited in this application.

The blind retransmission may mean that when sending data, the terminal device performs retransmission or repeated sending based on a quantity of transmission times. When the terminal device transmits data based on the blind retransmission, a transmission delay can be reduced, feedback overheads can be reduced, and communication quality can be improved.

For example, when sending data for the first time, the terminal device may transmit data for a plurality of times based on the blind retransmission without receiving a HARQ. This reduces a transmission delay, and reduces feedback overheads.

The codeword-level retransmission may mean that a granularity of data retransmission is a codeword. For example, retransmission is not required when a codeword is correctly transmitted, and the entire codeword is retransmitted when the codeword is incorrectly transmitted.

The code block group-level retransmission may mean that a granularity of data retransmission is a code block group. To be specific, only a coding block group that is incorrectly transmitted is retransmitted at a granularity of a coding block group. For example, one codeword includes a code block group 1 and a code block group 2. It is assumed that the code block group 1 corresponds to an ACK, and the code block group 2 corresponds to a NACK. During retransmission, only the code block group 2 may be retransmitted.

Based on the foregoing analysis of the codeword-level retransmission and the code block group-level retransmission, in the code block group-level retransmission, retransmission at a smaller granularity can be implemented. When a CBG of a TB fails to be decoded, the terminal device may retransmit only a CBG that is incorrectly transmitted, and does not need to retransmit the entire TB. This can reduce retransmitted redundant information, and improve resource utilization.

Another manner is code block-level retransmission. However, when the code block-level retransmission is used, ACKs/NACKs corresponding to code blocks are required, that is, many ACKs/NACKs need to be fed back. As a result, uplink signaling overheads are high, and a resource waste is caused. Therefore, the foregoing compromise between a TB-based feedback and a CB-based feedback may be used. A plurality of CBs in a TB are grouped, a corresponding ACK/NACK is fed back based on each grouped CBG, and retransmission is performed based on the CBG. Only a terminal device for which CBG-based retransmission is configured may perform retransmission based on the CBG. This improves resource utilization and avoids retransmission of redundant information, and can further avoid excessively large feedback signaling and avoid a resource waste.

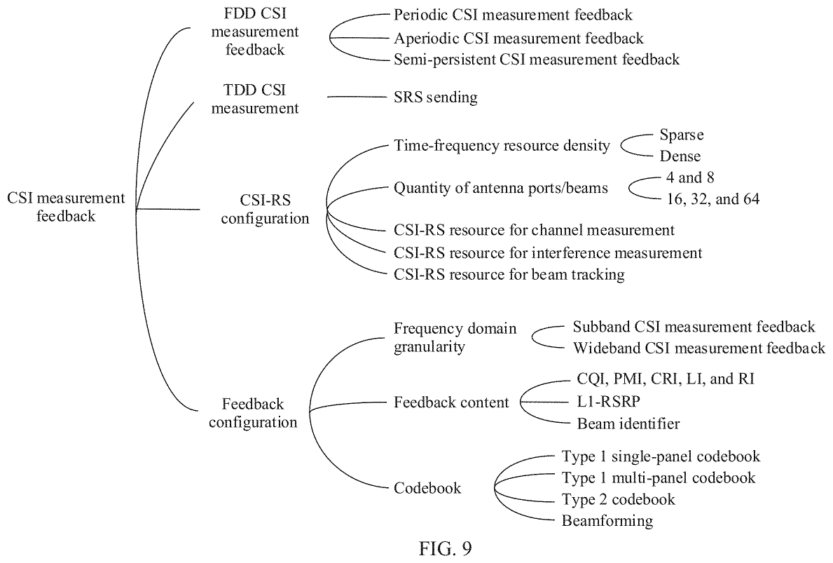

Optionally, as shown in FIG. 9, the CSI measurement feedback may include one or more of the following configuration manners: an FDD CSI measurement feedback, TDD CSI measurement, a channel state information reference signal (CSI-RS) configuration, and a feedback configuration.

The FDD CSI measurement feedback may include one or more of the following: a periodic CSI measurement feedback, an aperiodic CSI measurement feedback, and a semi-persistent CSI measurement feedback. Alternatively, the FDD CSI measurement feedback may not be limited to the foregoing manners, for example, may be a CSI measurement feedback configuration in the protocol 38.331, or may be another FDD CSI measurement feedback configuration. This is not limited in this application.

The TDD CSI measurement may include channel sounding reference signal (SRS) sending.

The CSI-RS configuration may include one or more of the following: a time-frequency resource density, a quantity of antenna ports/beams, a CSI-RS resource for channel measurement, a CSI-RS resource for interference measurement, and a CSI-RS resource for beam tracking. Specifically, the time-frequency resource density may include sparse, dense, and the like. The quantity of antenna ports/beams may include 4 or 8; 16, 32, or 64; and the like. Alternatively, the CSI-RS configuration may not be limited to the foregoing description, for example, may be a CSI-RS configuration in the protocol 38.331, or may be another CSI-RS configuration. This is not limited in this application.

The feedback configuration may include one or more of the following: a frequency domain granularity, feedback content, a codebook, and the like. Specifically, the frequency domain granularity may include one or more of the following: a subband CSI measurement feedback, a wideband CSI measurement feedback, and the like. The subband CSI measurement feedback may include one or more of the following: a subband precoding matrix indication (PMI), a subband channel quality indicator (CQI), and the like. The wideband CSI measurement feedback may include one or more of the following: a wideband PMI, a wideband CQI, and the like. The feedback content may include one or more of the following: a CQI, a PMI, a CSI-RS resource indicator (CRI), a layer indicator (LI), a rank indication (RI), a reference signal received power (L1-RSRP), a beam identifier, and the like. The codebook may include one or more of the following: a type 1 single-panel codebook, a type 1 multi-panel codebook, a type 2 codebook, beamforming, and the like. Specifically, the type 1 single-panel codebook may be a codebook for beam selection. The type 1 multi-panel codebook may be a codebook for feeding back inter-panel phase information on the basis of the type 1 single-panel codebook. The type 2 codebook may be a codebook for beam combination. The beamforming may be a codebook for port combination. Alternatively, the feedback configuration may not be limited to the foregoing description, for example, may be a CSI measurement feedback configuration in the protocol 38.331, or may be another feedback configuration. This is not limited in this application.

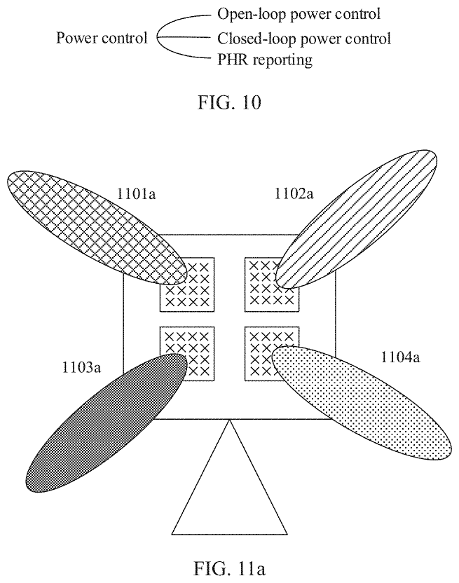

Optionally, as shown in FIG. 10, the power control may include one or more of the following configuration manners: open-loop power control, closed-loop power control, and power headroom report (PHR). Alternatively, the power control may not be limited to the foregoing description, for example, may be a CSI measurement feedback configuration in the protocol 38.331, or may be another power control manner. This is not limited in this application.

In the open-loop power control, the terminal device may perform power control based on measurement of the terminal device, and does not need to perform power control based on feedback information of a receiving device. The terminal device performs power control by using the open-loop power control, an operation is simple, and signaling interaction between the network device and the terminal device is not required. This reduces signaling overheads.

Specifically, the terminal device may determine a value of a transmit power without any input of the network device. An input of power control of the terminal device is from the inside of the terminal device. For example, the open-loop power control is used for power control of a physical random access channel (PRACH). An input of power control reference may be a preamble initial received target power and a pathloss. The preamble initial received target power may be pre-specified in the communication protocol, or may be configured by the network device for the terminal device. The terminal device may determine the pathloss based on a reference signal sent by the network device.

In the closed-loop power control, the terminal device may control the transmit power based on feedback information sent by the receiving device. Specifically, the terminal device may determine, based on outer-loop power control, a target SIR value used for inner-loop power control, and adjust the transmit power based on the inner-loop power control and based on a received SIR value and the target SIR value. The SIR (signal interference ratio) is a signal-to-interference ratio after joint detection and before decoding, the signal-to-interference ratio may be a ratio of signal energy to a sum of interference energy and additive noise energy, and the interference energy may be co-channel interference or multipath interference.

For example, the terminal device may compare a block error rate reported by MAC with an allowed block error rate. If the block error rate reported by the MAC is greater than the allowed block error rate, the target SIR value may be increased by a first preset step; otherwise, the target SIR value may be decreased by a first preset step. The first preset step may be one step. When the SIR value received by the terminal device is greater than the target SIR value, the terminal device may indicate a peer layer to decrease a transmit power on an air interface by a second preset step. If the SIR value received by the terminal device is less than the target SIR value, the transmit power is increased by the second preset step. The second preset step may be one step.

Based on the foregoing closed-loop power control, the terminal device performs power control based on the feedback content of the network device, so that signal receiving performance can be more accurately and properly considered. This can better meet a power requirement, reduce power consumption of the terminal device, and better overcome interference.

In the PHR, a power headroom indicates a remaining power after the terminal device completes current data transmission. The terminal device may perform PHR reporting by using a MAC control element (MAC CE).

Specifically, the terminal device may trigger PHR reporting when a pathloss change value exceeds a preset threshold, or may trigger PHR reporting when a timer expires. For example, the network device may indicate the terminal device to calculate a pathloss value at an antenna port of the terminal device based on the reference signal, and indicate the terminal device to perform PHR reporting when the pathloss change value exceeds the preset threshold. Alternatively, the network device may configure a timer for the terminal device by using the RRC signaling, and indicate the terminal device to trigger PHR reporting when the timer expires.

For example, PUSCH transmission is used as an example. Power headroom=maximum transmit power of the terminal device−transmit power of the PUSCH=Pₘₐₓ−P_{PUSCH}.

Based on the foregoing PHR reporting, the network device may learn of a current power level and a data transmission capability of the terminal device. If the power headroom is positive, it may indicate that the terminal device may further transmit more data at a maximum transmit power. If the power headroom is negative, it may indicate that transmission of the terminal device exceeds an allowed maximum transmit power. In addition, when the terminal device uses more resource blocks (RBs), the terminal device requires a higher transmit power, but the transmit power cannot exceed the allowed maximum power corresponding to the terminal device in the communication protocol. Therefore, the terminal device does not have a large power headroom, and cannot occupy more RBs. Therefore, the network device may estimate, based on a power headroom reported by the terminal device, a bandwidth used by the terminal device in a specific time unit such as an uplink subframe/slot.

Based on the foregoing power control, inter-cell interference can be suppressed for a downlink, to improve networking performance. Different powers are allocated to different physical channels in an open-loop manner, so that a transmit power on each downlink subcarrier of the network device can be controlled. A downlink reference signal is mainly transmitted at a constant power. A main purpose of the PDSCH is to compensate for a pathloss and slow fading, and adjust a power based on channel quality information (CQI) fed back by the terminal device in a closed-loop manner. The network device stores the CQI and a transmit power table, to achieve a specific signal to interference plus noise ratio (SINR) target. For an uplink, the terminal device may consider QoS and power saving to overcome interference, complete pathloss measurement based on reference signal strength, and determine a pathloss to be compensated.

Optionally, a beamforming technology may mean that a specific shape and direction are assigned to an antenna radiation pattern by adjusting amplitudes and phases of a plurality of antennas, so that radio signal energy is concentrated on a narrower beam, which enhances coverage and reduces interference. The network device may use massive MIMO, so that a beam formed by the network device is narrower and a gain is higher. When both the terminal device and the network device use beams, beam alignment between the terminal device and the network device may be enabled by using a beam management mechanism, to implement communication.

It may be understood that the beam in this embodiment of the present invention may be a beam formed by performing amplitude and/or phase weighting on data transmitted or received by at least one antenna port, or may be formed by using another method, for example, adjusting a related parameter of an antenna unit. The beam may include a transmit beam and a receive beam. The transmit beam indicates distribution of signal strength formed in different directions in space after a signal is transmitted by using an antenna. The receive beam indicates distribution of signal strength that is of a wireless signal received from an antenna and that is in different directions in space.

Signal processing at a receive end may be performing weighted combination on signals received by a multi-antenna array element, to form a wanted signal. From a perspective of an antenna directivity pattern, such operation is equivalent to forming a beam in a specified direction. For example, an original all-round receiving directivity pattern is converted into a lobe directivity pattern having a null point and a maximum direction. A same principle is also applicable to a transmit end. Amplitude and phase adjustment is performed on feed of an antenna array element, to form a directivity pattern of a required shape.

Because a plurality of groups of antennas are used, radio signals from a transmit end to a receive end correspond to a same spatial stream, and are transmitted through a plurality of paths. When signals received by a plurality of antennas are processed at the receive end by using a specific algorithm, a signal to interference plus noise ratio at the receive end may be significantly improved. Even when the receive end is far away, relatively good signal quality can be obtained.

A communication apparatus (for example, a terminal device or a network device) may be configured with a massive array structure of a plurality of antenna panels. Different antenna panels form a plurality of beams for sending signals. Therefore, channel characteristics of different beams for sending signals are different. In different beams, the network device may send signals by using a same antenna port number, and the network device may send different beam signals for different beams.

For example, FIG. 11a and FIG. 11b are schematic diagrams of beams formed by four antenna panels included in one network device. In FIG. 11a, each of the four antenna panels independently forms one or more beams, for example, 1101a, 1102a, 1103a, and 1104a. Beams formed by the antenna panels are different, and antenna ports for sending signals by using the four different beams may be non-QCL. In FIG. 11b, four antenna panels form a beam together, for example, 1101b. However, because different precoding is performed on the beams formed by the four antenna panels, directivity of the beams is different. In this case, an antenna port for sending a signal may also be non-QCL. Non-QCL means that large-scale properties of channels that antenna ports of signals pass through are different. The large-scale property may be one or more of a delay spread, a Doppler spread, a Doppler frequency shift, an average channel gain and an average delay, an angle of arrival (AOA) for receiving, an angle of arrival spread (AAS), an angle of departure (AOD) for transmission, an angle of departure spread (ADS), a spatial correlation, and the like.

Optionally, as shown in FIG. 11c, the beam management may include one or more of the following configuration manners: beam sweeping, beam tracking, beam recovery, beam management during data transmission, and beam management for initial access. Alternatively, the beam management may not be limited to the foregoing description, for example, may be a beam management manner in the protocol 38.331, or may be another beam management manner. This is not limited in this application.

The beam sweeping may include wide beam sweeping, narrow beam sweeping, and the like. In beam sweeping, a sending device may sweep a transmit beam, and the receiving device may sweep a receive beam. If the sending device has a plurality of antennas, the plurality of antennas may form a plurality of beams. In this case, the sending device may perform beam sweeping. If the receiving device has a plurality of antennas, the plurality of antennas may form a plurality of beams. In this case, the receiving device may perform beam sweeping.

For example, the sending device is a network device, and the receiving device is a terminal device. The network device and the terminal device may perform beam sweeping by using a method shown in the following Manner 1 or Manner 2.

Manner 1: The network device and the terminal device alternately perform beam sweeping.

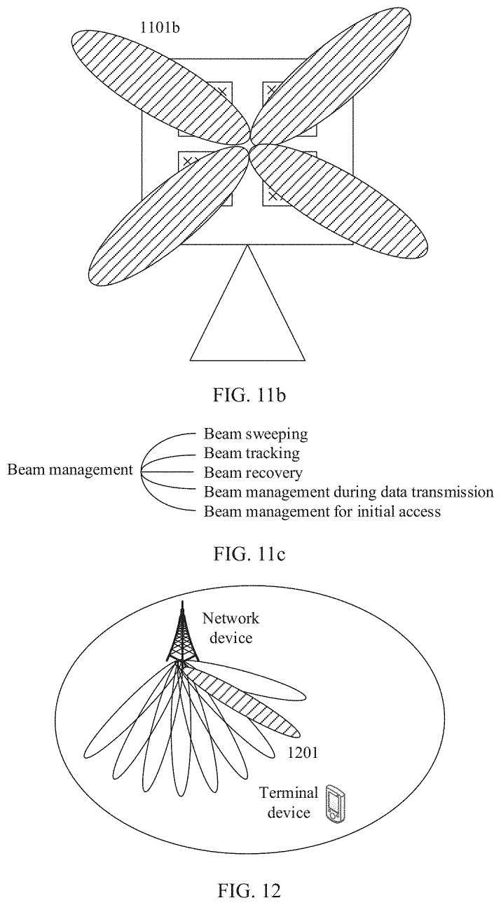

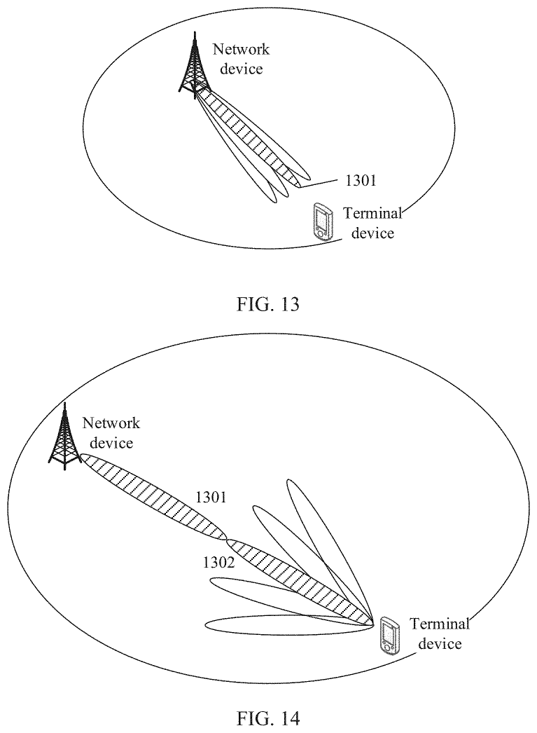

Specifically, as shown in FIG. 12, the network device may first perform wide beam sweeping, and when the network device performs beam sweeping, the terminal device may perform fixed beam direction or omnidirectional receiving. When determining a preferred wide beam 1201 on a network device side, the terminal device may report the wide beam 1201 determined by the terminal device to the network device. As shown in FIG. 13, the network device may perform narrow beam sweeping based on the wide beam reported by the terminal device. When determining a preferred narrow beam 1301 on a network device side, the terminal device may report the narrow beam 1301 determined by the terminal device to the network device. As shown in FIG. 14, the network device may send a signal to the terminal device by using the narrow beam 1301 reported by the terminal device, or the terminal device may receive, by using a beam 1302, the signal sent by the network device. For example, the network device may repeatedly send the signal to the terminal device by using the narrow beam, so that the terminal device performs beam sweeping.

Manner 2: the network device and the terminal device perform joint beam sweeping.

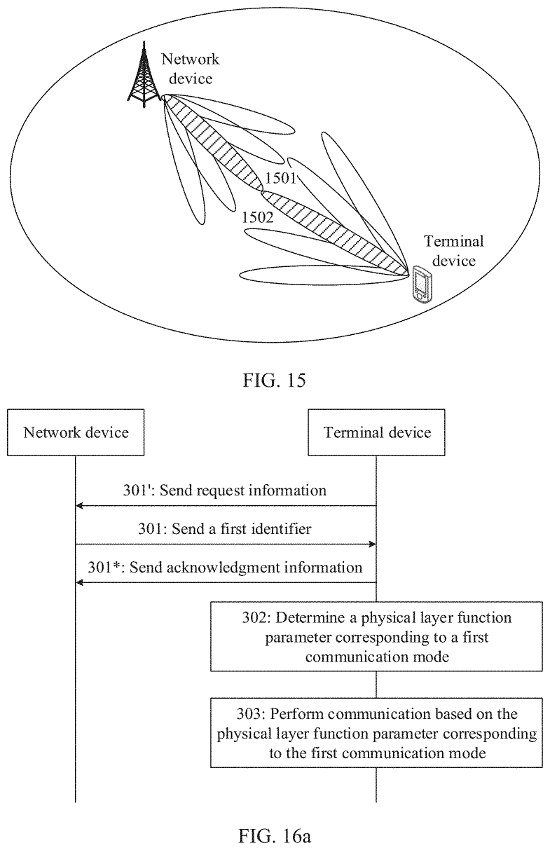

Specifically, as shown in FIG. 15, the network device may send a signal by using a beam, and the terminal device may receive the signal by using the beam, and find an optimal beam pair of a transmit beam and a receive beam, for example, a beam pair of a transmit beam 1501 and a receive beam 1502.

In the beam tracking, when the sending device and/or the receiving device moves, the sending device may perform beam measurement and reporting, to determine a beam with better current communication, that is, perform the beam tracking when the sending device and/or the receiving device moves.

In the beam recovery, when a beam on a network device side and a beam on a terminal device side that are originally aligned with each other are blocked by an obstacle (for example, a human body or a vehicle), a new pair of beams that can be aligned with each other on a reflection path may be searched for, to ensure that the network device and the terminal device can continue to communicate with each other.

Specifically, the beam recovery may be performed by using the following step 1 to step 4.

Step 1: new beam identification.

Specifically, the terminal device may always maintain a backup beam pair. If a beam failure occurs, the terminal device may report a number of the backup beam to the network device.

It should be noted that step 1 may be independent of the following step 2 to step 4.

Step 2: beam failure detection.

Specifically, the terminal device may monitor control channel quality. If the control channel quality is continuously lower than a preset threshold for a preset time, it is considered that a beam failure occurs, and step 3 is performed.

The preset time may be preconfigured by the network device for the terminal device.

For example, if a block error rate (BLER)>0.1 and lasts for the preset time, it may be considered that a beam failure occurs.

Step 3: beam failure recovery request.

Specifically, the terminal device may notify, by using a physical random access channel (PRACH), the network device that a beam failure occurs, report, by using the PRACH, a number of the backup beam maintained in step 1 to the network device, then switch a beam of the terminal device to the backup beam, and wait for a response from the network device. Step 4 is performed.

Step 4: beam failure recovery response.

Specifically, after receiving the beam failure recovery request, the network device may switch a beam of the network device to the backup beam reported by the terminal device, and send a response on the backup beam. After receiving the response, the terminal device completes beam failure recovery. Otherwise, the terminal device enters link recovery.

Based on the type of the physical layer function parameter, the configuration manner of the physical layer function parameter may include at least one of the foregoing configuration parameters.

For example, the type of the physical layer function parameter is data transmission, the data transmission includes a scheduling manner, and a first parameter field of the scheduling manner indicates a configured grant type 1. The configured grant type 1 may include at least one configuration parameter combination.

Specifically, when the scheduling manner is the configured grant type 1, the network device may send a configuration parameter of the configured grant type 1 to the terminal device. The configuration parameter may include one or more of the following: frequency hopping, cg-demodulation reference signal configuration (cg-DMRS-configuration), MCS table, whether to transmit uplink control information on a PUSCH, a resource allocation manner, a resource block group size, a power control loop to use, a power control parameter of a PUSCH, whether to enable transform precoding, a quantity of HARQ processes, a quantity of repetitions, a redundancy version of K repetitions, a period, and an RRC configuration uplink permission parameter. Alternatively, the configuration parameter may not be limited to the foregoing description, for example, may be a configuration parameter in the protocol 38.331, or may be another configuration parameter. This is not limited in this application.

The frequency hopping may include intra-slot frequency hopping, inter-slot frequency hopping, and the like.

The MCS table may be an MCS table supporting 256QAM, an MCS table supporting 64QAM with a low code rate, an MCS table supporting 64QAM, or the like.

The resource allocation manner may be one or more of the following: a resource allocation manner of a type 0, a resource allocation manner of a type 1, a resource allocation manner in which a type 0 and a type 1 are dynamically switched, or the like. For example, the resource allocation manner may be a resource allocation manner in the protocol 38.214, or may be another resource allocation manner. This is not limited in this application.

The resource block group size may be a size of a resource block group (RBG) that uses a configuration 1, or may be a size of an RBG that uses a configuration 2, or the like. One RBG may include one or more resource blocks RBs). Different configuration manners correspond to different RBG sizes. For example, as shown in Table 1, the RBG size may be determined based on a bandwidth part size. The RBG size includes an RBG size in the configuration 1 and an RBG size in the configuration 2.

TABLE 1

| Bandwidth part | RBG size of the | RBG size of the |
|---|---|---|
| size (RB) | configuration 1 | configuration 2 |
| 1-36 | 2 | 4 |
| 37-72 | 4 | 8 |
| 73-144 | 8 | 16 |
| 145-275 | 16 | 16 |

The RRC configuration uplink grant parameter may include one or more of the following: a time domain offset, time domain allocation, frequency domain allocation, an antenna port, DMRS sequence initialization, precoding and a layer quantity, an SRS resource indicator, an MCS and a transport block size (TBS), a frequency-domain frequency hopping offset, a pathloss reference identifier, a PUSCH repetition type indicator, and the like.

Optionally, one optional option combination of the configuration parameters is a configuration 1 of the configured grant type 1, and another optional option combination of the configuration parameters is a configuration 2 of the configured grant type 1. In the configuration 1 and the configuration 2 of the configured grant type 1, at least one parameter is different, and/or the at least one parameter has different values.

Specifically, for example, the configured grant type 1 includes the configuration 1 and the configuration 2, and the terminal device currently uses the configuration 1 to transmit data. When the network device determines, based on a transmission requirement of the terminal device, that the terminal device needs to use the configuration 2 to transmit data, the network device may send an identifier of the configuration 2 to the terminal device, so that the terminal device updates a configuration parameter of the configuration 1 to a configuration parameter of the configuration 2 based on the identifier of the configuration 2. When the network device determines, based on a transmission requirement of the terminal device, that the terminal device needs to use the configuration 1 again to transmit data, the network device may send an identifier of the configuration 1 to the terminal device, so that the terminal device updates the configuration parameter of the configuration 2 to the configuration parameter of the configuration 1 based on the identifier of the configuration 1. Therefore, excessively high signaling overheads are avoided, RRC reconfiguration is avoided, and a high configuration delay of the configured grant type 1 is avoided.

In another example, the type of the physical layer function parameter is power control, and the first parameter field of the power control indicates closed-loop power control. The closed-loop power control may include at least one configuration parameter.

Specifically, when the power control is the closed-loop power control, the network device may send a configuration parameter of the power control to the terminal device. The configuration parameter may include one or more of the following: whether to enable power control accumulation, a parameter of the message 3, a PO value for uplink grant-free or SPS PUSCH transmission, a pathloss reference signal, whether to store two PUSCH power control adjustment states, and whether to enable a difference MCS.

For whether to enable power control accumulation, if power control accumulation is enabled, the terminal device may use a transmit power control (TPC) command in an accumulation manner; or if power control accumulation is disabled, the terminal device does not use a TPC command in an accumulation manner.

The pathloss reference signal may be a reference signal used for PUSCH pathloss estimation, for example, may be a CSI-RS or a synchronization signal and physical broadcast channel block (SSB).

Optionally, one optional option combination of the configuration parameters is a configuration 1 of the closed-loop power control, and another optional option combination of the configuration parameters is a configuration 2 of the closed-loop power control. In the configuration 1 and the configuration 2 of the closed-loop power control, at least one parameter is different, and/or the at least one parameter has different values.

Specifically, for example, the closed-loop power control includes the configuration 1 and the configuration 2, and the terminal device currently uses the configuration 1 to perform the power control. When the network device determines, based on a power control requirement of the terminal device, that the terminal device needs to use the configuration 2 to perform the power control, the network device may send an identifier of the configuration 2 to the terminal device, so that the terminal device updates a configuration parameter of the configuration 1 to a configuration parameter of the configuration 2 based on the identifier of the configuration 2. When the network device determines, based on a power control requirement of the terminal device, that the terminal device needs to use the configuration 1 again to perform the power control, the network device may send an identifier of the configuration 1 to the terminal device, so that the terminal device updates the configuration parameter of the configuration 2 to the configuration parameter of the configuration 1 based on the identifier of the configuration 1. Therefore, excessively high signaling overheads are avoided, RRC reconfiguration is avoided, and a high configuration delay of the power control is avoided.

It should be noted that the foregoing merely uses an example of the configuration parameter of the configured grant type 1 and the configuration parameter of the closed-loop power control for description. Similarly, a configuration manner corresponding to each of the foregoing physical layer function parameters may be configured and switched in the foregoing manner. Details are not described again.

Optionally, the physical layer function parameter in this application may be one or more of RRC parameters in the protocol 38.331, or may be another configuration parameter. This is not specifically limited in this application.

Based on the method shown in FIG. 3a, the terminal type shown in FIG. 4, and the physical layer function parameters shown in FIG. 5 to FIG. 15, the terminal type of the terminal device may be determined based on the related descriptions in FIG. 4, and the communication mode corresponding to the terminal device and the physical layer function parameter corresponding to the communication mode are determined based on the terminal type.

In a possible implementation, the terminal device and/or the network device may determine the communication mode based on the terminal type. Optionally, there is a correspondence between the terminal type and the communication mode. The correspondence may be predefined in a protocol, or may be notified by the network device or the core network to a terminal by using upper layer signaling (for example, RRC signaling or MAC signaling), physical layer signaling, or the like. This embodiment of this application may be an independent embodiment, or may be combined with another embodiment of this application. This is not specifically limited in this application.

The terminal device may correspond to at least one communication mode, and terminal devices of different terminal types correspond to at least one different communication mode.

In a possible implementation, the terminal device and/or the network device may determine, based on the terminal type, the physical layer function parameter corresponding to the communication mode.

Optionally, there is a correspondence between the terminal type and the physical layer function parameter corresponding to the communication mode. The correspondence may be predefined in a protocol, or may be notified by the network device or the core network to a terminal by using upper layer signaling (for example, RRC signaling or MAC signaling), physical layer signaling, or the like. This embodiment of this application may be an independent embodiment, or may be combined with another embodiment of this application. This is not specifically limited in this application.

The physical layer function parameter includes a first parameter field, and the first parameter field indicates a configuration manner of the physical layer function parameter.

Optionally, the configuration manner includes a second parameter field, and the second parameter field includes a configuration parameter of the configuration manner.

Specifically, that there is a correspondence between the terminal type and the physical layer function parameter corresponding to the communication mode may also include one or more of the following: there is a correspondence between the terminal type and the type of the physical layer function parameter corresponding to the communication mode, there is a correspondence between the terminal type and the configuration manner of the physical layer function parameter corresponding to the communication mode, and there is a correspondence between the terminal type and the configuration parameter of the configuration manner of the physical layer function parameter corresponding to the communication mode.

The following embodiment is a method for designing a physical layer function parameter. In the method, a physical layer function parameter may be customized based on a terminal type, to implement matching between a function and a terminal. This optimally meets requirements of various devices, reduces signaling overheads, reduces a delay in physical layer function switching, reduces communication complexity, and reduces chip costs. This embodiment of this application may be an independent embodiment, or may be combined with another embodiment of the present invention. This is not specifically limited in this application.

In a possible implementation, there is a correspondence between the terminal type and the type of the physical layer function parameter corresponding to the communication mode.

The following embodiment is a method for designing a type of a physical layer function parameter. In the method, a type of a physical layer function parameter may be customized based on a terminal type, to implement matching between a function type and a terminal. This optimally meets requirements of various devices, reduces signaling overheads, reduces a delay in physical layer function switching, reduces communication complexity, and reduces chip costs. This embodiment of this application may be an independent embodiment, or may be combined with another embodiment of the present invention. This is not specifically limited in this application.

Specifically, different terminal types may correspond to different communication requirements. Therefore, the terminal device may not support at least one of the foregoing types of the physical layer function parameters. Therefore, a type that is of a physical layer function parameter and that is suitable for the terminal device to perform communication may be determined based on the terminal type, to meet different communication requirements of terminal devices of different terminal types, and reduce signaling overheads.

In a possible implementation, the terminal device and/or the network device may determine, based on the terminal type, the type of the physical layer function parameter corresponding to the communication mode.

Optionally, there is a correspondence between the terminal type and the type of the physical layer function parameter. The correspondence may be predefined in a protocol, or may be notified by the network device or the core network to a terminal by using upper layer signaling (for example, RRC signaling or MAC signaling), physical layer signaling, or the like. This embodiment of this application may be an independent embodiment, or may be combined with another embodiment of this application. This is not specifically limited in this application.

For example, when the terminal device is always in a static state, the terminal device may not support the beam management, and the network device may not configure a beam management related parameter for the terminal device. When the terminal device always performs small-packet transmission or short-distance transmission, the terminal device may not support the power control, and the network device may not configure a power control related parameter for the terminal device.

For example, when the terminal type is URLLC, a type of a physical layer function parameter corresponding to a communication mode of the URLLC may include the data transmission, the mobility, and the beam management.

According to the foregoing design, because the URLLC mainly transmits a small-packet service, power control may not be performed, to reduce complexity. In addition, the URLLC is mainly used in a stationary scenario or a moving scenario in a fixed path, and a channel state is relatively stable. Therefore, the CSI measurement feedback may not be performed, and low-rate transmission is used, to reduce power consumption, and improve communication efficiency. In addition, in a URLLC scenario of a type such as a mechanical arm, the beam management may be performed to implement beam alignment, location prediction, and preparation of data transmission in advance. This can reduce a delay, meet a requirement for a precise operation of a service and a delay, and improve communication efficiency.

When the terminal type is IoT, a type of a physical layer function parameter corresponding to a communication mode of the IoT may include the data transmission.

According to the foregoing design, because an application scenario of the IoT is mainly a stationary scenario such as a smart water meter, mobility management may not be performed, and the power control may not be performed, to reduce complexity. In addition, the CSI measurement feedback may not be performed, and low-rate transmission is used, to reduce power consumption, and improve communication efficiency.

When the terminal type is CPE, a type of a physical layer function parameter corresponding to a communication mode of the CPE may include the data transmission and the CSI measurement feedback.

According to the foregoing design, because an application scenario of the CPE is mainly static large data transmission, a high power consumption mode may be used, and the power control does not need to be performed, for example, sending at a maximum power. High-rate transmission, no mobility, and no beam management reduce complexity, reduce power consumption, and improve communication efficiency.

When the terminal type is eMBB, a type of a physical layer function parameter corresponding to a communication mode of the eMBB may include the data transmission, the mobility, the CSI measurement feedback, and the beam management.

Further, for the physical layer function parameter corresponding to the communication mode of the terminal device, different configuration manners may be determined, based on different communication requirements of the terminal device, for the physical layer function parameter corresponding to each communication mode of the terminal device.

The following embodiment is a method for designing a configuration manner of a physical layer function parameter. In the method, a configuration manner of a physical layer function parameter may be customized based on a terminal type, to implement matching between a function and a terminal. This optimally meets requirements of various devices, reduces signaling overheads, reduces a delay in physical layer function switching, reduces communication complexity, and reduces chip costs. This embodiment of this application may be an independent embodiment, or may be combined with another embodiment of this application. This is not specifically limited in this application.

In a possible implementation, the terminal device and/or the network device may determine, based on the terminal type, a configuration manner of the type of the physical layer function parameter corresponding to the communication mode.

Optionally, there is a correspondence between the terminal type and the configuration manner of the type of the physical layer function parameter. The correspondence may be predefined in a protocol, or may be notified by the network device or the core network to a terminal by using upper layer signaling (for example, RRC signaling or MAC signaling), physical layer signaling, or the like. This embodiment of this application may be an independent embodiment, or may be combined with another embodiment of this application. This is not specifically limited in this application.

For example, the type of the physical layer function parameter is data transmission, and the data transmission includes the scheduling manner shown in FIG. 6. A corresponding configuration manner may be determined, based on the terminal type of the terminal device, for a scheduling manner corresponding to each communication mode of the terminal device. This embodiment of this application may be an independent embodiment, or may be combined with another embodiment of this application. This is not specifically limited in this application.

The following embodiment is a method for designing a scheduling manner for data transmission. In the method, a scheduling manner for data transmission may be customized based on a terminal type, to implement matching between a function and a terminal type. This optimally meets requirements of various devices, reduces signaling overheads, reduces a delay in physical layer function switching, reduces communication complexity, and reduces chip costs. This embodiment of this application may be an independent embodiment, or may be combined with another embodiment of the present invention. This is not specifically limited in this application.

In a possible implementation, the terminal device and/or the network device may determine, based on the terminal type, the scheduling manner for data transmission corresponding to the communication mode.

Optionally, there is a correspondence between the terminal type and the scheduling manner of the communication mode. The correspondence may be predefined in a protocol, or may be notified by the network device or the core network to a terminal by using upper layer signaling (for example, RRC signaling or MAC signaling), physical layer signaling, or the like.

For example, as shown in the following Table 2, for a terminal type 1, a communication mode 1 may correspond to a scheduling manner A1, a communication mode 2 may correspond to a scheduling manner A2, . . . , and a communication mode N may correspond to a scheduling manner An; for a terminal type 2, a communication mode 1 may correspond to a scheduling manner B1, a communication mode 2 may correspond to a scheduling manner B2, . . . , and a communication mode N may correspond to a scheduling manner Bn; . . . ; for a terminal type X, a communication mode 1 may correspond to a scheduling manner X1, a communication mode 2 may correspond to a scheduling manner X2, . . . , and a communication mode N may correspond to a scheduling manner Xn.

TABLE 2
Terminal type and scheduling manner of a communication mode

| Terminal | Communication | Communication | | Communication |
|---|---|---|---|---|
| type | mode 1 | mode 2 | . . . | mode N |
| Type 1 | Scheduling | Scheduling | . . . | Scheduling |
| | manner A1 | manner A2 | | manner An |
| Type 2 | Scheduling | Scheduling | . . . | Scheduling |
| | manner B1 | manner B2 | | manner Bn |
| . . . | . . . | . . . | . . . | |
| Type X | Scheduling | Scheduling | . . . | Scheduling |
| | manner X1 | manner X2 | | manner Xn |

The terminal type 1, the terminal type 2, . . . , and the terminal type X may be at least one of the foregoing terminal types, for example, the eMBB, the URLLC, the IoT, the CPE, the V2X, the AR/VR, or the like. This is not limited.

The scheduling manner A1, the scheduling manner A2, . . . , and the scheduling manner An, the scheduling manner B1, the scheduling manner B2, . . . , and the scheduling manner Bn, and the scheduling manner X1, the scheduling manner X2, . . . , and the scheduling manner Xn may all be at least one of the foregoing scheduling manners, for example, the dynamic scheduling, the configured grant type scheduling, the SP S scheduling, the slot or sub-slot aggregation, the cross-slot scheduling, the including data in a random access process, or the like. This is not limited.

An, Bn, . . . , and Xn are positive integers, and values of An, Bn, . . . , and Xn may be the same or different.

For example, the communication mode of the terminal type includes the first communication mode and the second communication mode. The first communication mode may include a scheduling manner 1, and the second communication mode may include a scheduling manner 2. The scheduling manner 1 may be one or more of the configuration manners shown in FIG. 6, and the scheduling manner 2 may also be one or more of the configuration manners shown in FIG. 6. In addition, at least one configuration manner in the scheduling manner 1 and the scheduling manner 2 is different, and/or the at least one configuration manner has different configuration parameters.

For example, when the terminal type is eMBB, a first communication mode of the eMBB may include a scheduling manner of dynamic scheduling, a second communication mode may include a slot or sub-slot aggregation scheduling manner, and a third communication mode may include a scheduling manner of SPS scheduling.

For another example, when the terminal type is URLLC, a first communication mode of the URLLC may include a configured grant type scheduling manner, and a second communication mode may include a slot or sub-slot aggregation scheduling manner.

According to the foregoing design, because URLLC data transmission is mainly transmission of a small-packet low-delay and high-reliability service, dynamic scheduling may not be performed, and transmission is directly performed in the configured grant type scheduling manner. An incoming packet can be transmitted at any time, to reduce a delay. Repeated transmission can be performed for a plurality of times by using slot aggregation, to improve reliability, and reduce a delay in feedback and retransmission.

For another example, when the terminal type is IoT, a first communication mode of the IoT may include dynamic scheduling or a configured grant type scheduling manner, and a second communication mode may include a scheduling manner of including data in a message 1 or a message 3 in a random access process.

According to the foregoing design, because the IoT mainly transmits small-packet data and has a regular data transmission requirement, the scheduling manner of dynamic scheduling may be performed. This can implement fast data transmission, reduce a transmission delay, and improve communication efficiency.

For another example, when the terminal type is CPE, a first communication mode of the CPE may include the scheduling manner of dynamic scheduling and the slot or sub-slot aggregation scheduling manner, and a second communication mode may include a scheduling manner of cross-slot scheduling.

According to the foregoing design, because the CPE mainly transmits large data in a stationary scenario, a high power consumption mode may be used, data is transmitted at any time, and a large packet may be transmitted in a plurality of slots by using dynamic scheduling such as cross-slot scheduling and slot aggregation. This can improve communication efficiency.

Optionally, corresponding identifiers may be configured for different scheduling manners.

For example, a communication mode of a terminal type A includes a first communication mode and a second communication mode, the first communication mode includes the scheduling manner 1, and the second communication mode includes the scheduling manner 2. An identifier of the scheduling manner 1 may be determined as A1, and an identifier of the scheduling manner 2 may be determined as A2. When the network device indicates a terminal device A to switch a scheduling manner, the network device may send an identifier of the scheduling manner to the terminal device A, to indicate the terminal device A to switch the scheduling manner. For example, the network device may send A1 to the terminal device A, to indicate the terminal device A to transmit data in the scheduling manner 1, or the network device may send A2 to the terminal device A, to indicate the terminal device A to transmit data in the scheduling manner 2.

In another example, a communication mode of a terminal type B includes a first communication mode and a second communication mode, the first communication mode includes a scheduling manner 1′, and the second communication mode includes a scheduling manner 2′. An identifier of the scheduling manner 1′ may be determined as B1, and an identifier of the scheduling manner 2′ may be determined as B2. When the network device indicates a terminal device B to switch a scheduling manner, the network device may send an identifier of the scheduling manner to the terminal device B, to indicate the terminal device B to switch the scheduling manner. For example, the network device may send B1 to the terminal device B, to indicate the terminal device B to transmit data in the scheduling manner 1′, or the network device may send B2 to the terminal device B, to indicate the terminal device B to transmit data in the scheduling manner 2′.

Optionally, the scheduling manner of the terminal device may be a scheduling manner used when the terminal device performs uplink communication, or may be a scheduling manner used when the terminal device performs downlink communication. In other words, the communication mode of the terminal device may include an uplink scheduling manner and/or a downlink scheduling manner.

For example, the communication mode of the terminal type A includes the first communication mode and the second communication mode. The first communication mode may include an uplink scheduling manner A1′ and/or a downlink scheduling manner A1*, and the second communication mode may include an uplink scheduling manner A2′ and/or a downlink scheduling manner A2*. The uplink scheduling manner A1′, the downlink scheduling manner A1*, the uplink scheduling manner A2′, and the downlink scheduling manner A2* may all be one or more of the configuration manners shown in FIG. 6.

In another example, the communication mode of the terminal type B includes the first communication mode and the second communication mode. The first communication mode may include an uplink scheduling manner BP and/or a downlink scheduling manner B 1*, and the second communication mode may include an uplink scheduling manner B2′ and/or a downlink scheduling manner B2*. The uplink scheduling manner B1′, the downlink scheduling manner B1*, the uplink scheduling manner B2′, and the downlink scheduling manner B2* may all be one or more of the configuration manners shown in FIG. 6.

According to the foregoing embodiment, different scheduling manners for data transmission in a communication mode are designed for different terminal types, to better meet communication requirements of different terminal types, and adapt to data transmission of different terminal types. This reduces signaling overheads, reduces communication complexity, reduces chip costs, and improves communication efficiency.

For example, the type of the physical layer function parameter is data transmission, and the data transmission includes the feedback manner shown in FIG. 7. A corresponding configuration manner may be determined, based on the terminal type of the terminal device, for a feedback manner corresponding to each communication mode of the terminal device. This embodiment of this application may be an independent embodiment, or may be combined with another embodiment of the present invention. This is not specifically limited in this application.

The following embodiment is a method for designing a feedback manner for data transmission. In the method, a feedback manner for data transmission may be customized based on a terminal type, to implement matching between a function and a terminal type. This optimally meets requirements of various devices, reduces signaling overheads, reduces a delay in physical layer function switching, reduces communication complexity, and reduces chip costs. This embodiment of this application may be an independent embodiment, or may be combined with another embodiment of this application. This is not specifically limited in this application.

In a possible implementation, the terminal device and/or the network device may determine, based on the terminal type, the feedback manner for data transmission corresponding to the communication mode.

Optionally, there is a correspondence between the terminal type and the feedback manner of the communication mode. The correspondence may be predefined in a protocol, or may be notified by the network device or the core network to a terminal by using upper layer signaling (for example, RRC signaling or MAC signaling) or physical layer signaling.

For example, as shown in the following Table 3, for a terminal type 1, a communication mode 1 may correspond to a feedback manner a1, a communication mode 2 may correspond to a feedback manner a2, . . . , and a communication mode N may correspond to a feedback manner an; for a terminal type 2, a communication mode 1 may correspond to a feedback manner b1, a communication mode 2 may correspond to a feedback manner b2, . . . , and a communication mode n may correspond to a feedback manner bn; . . . ; for a terminal type X, a communication mode 1 may correspond to a feedback manner x1, a communication mode 2 may correspond to a feedback manner x2, . . . , and a communication mode n may correspond to a feedback manner xn.

TABLE 3
Terminal type and scheduling manner of a communication mode

| Terminal | Communication | Communication | | Communication |
|---|---|---|---|---|
| type | mode 1 | mode 2 | . . . | mode N |
| Type 1 | Feedback | Feedback | . . . | Feedback |
| | manner a1 | manner a2 | | manner an |
| Type 2 | Feedback | Feedback | . . . | Feedback |
| | manner b1 | manner b2 | | manner bn |
| . . . | . . . | . . . | . . . | |
| Type X | Feedback | Feedback | . . . | Feedback |
| | manner x1 | manner x2 | | manner xn |

The terminal type 1, the terminal type 2, . . . , and the terminal type X may be at least one of the foregoing terminal types, for example, the eMBB, the URLLC, the IoT, the CPE, the V2X, the AR/VR, or the like. This is not limited.

The feedback manner a1, the feedback manner a2, . . . , and the feedback manner an, the feedback manner b1, the feedback manner b2, . . . , and the feedback manner bn, and the feedback manner x1, the feedback manner x2, . . . , and the feedback manner xn may all be at least one of the foregoing HARQ feedback manners, for example, no ACK/NACK feedback, the codeword-level ACK/NACK feedback, the CBG-level ACK/NACK feedback, the synchronous HARQ, the asynchronous HARQ, the adaptive HARQ, the non-adaptive HARQ, or the like. This is not limited.

an, bn, . . . , and xn are positive integers, and values of an, bn, . . . , and xn may be the same or different.

For example, the communication mode of the terminal type includes the first communication mode and the second communication mode. The first communication mode may include a feedback manner 1, and the second communication mode may include a feedback manner 2. The feedback manner 1 may be one or more of the configuration manners shown in FIG. 7, and the feedback manner 2 may also be one or more of the configuration manners shown in FIG. 7. In addition, at least one configuration manner in the feedback manner 1 and the feedback manner 2 is different, and/or the at least one configuration manner has different configuration parameters.

For example, when the terminal type is eMBB, the first communication mode of the eMBB may include a feedback manner of a codeword-level ACK/NACK feedback and/or an asynchronous HARQ, and the second communication mode may include a feedback manner of a code block group-level ACK/NACK feedback and/or the asynchronous HARQ.

For another example, when the terminal type is URLLC, the first communication mode of URLLC may include a feedback manner in which an ACK/NACK feedback is not required, and the second communication mode may include a feedback manner of a codeword-level ACK/NACK feedback.

According to the foregoing design, because URLLC data transmission is mainly transmission of a small-packet low-delay and high-reliability service, the ACK/NACK feedback may not be performed, and retransmission may be directly performed for a plurality of times, to reduce a communication delay, and meet requirements for a low delay and high reliability. In addition, repeated transmission is also performed for a plurality of times, to improve reliability, and reduce a delay in a manner of retransmission after feedback. In addition, the codeword-level feedback may also be performed in small-packet transmission, to reduce implementation complexity, and improve communication efficiency. For another example, when the terminal type is IoT, the communication mode of the IoT may include the feedback manner in which an ACK/NACK feedback is not required.

According to the foregoing design, because the IoT mainly transmits small-packet data of a regular service type, an ACK/a NACK may not be fed back, to reduce feedback overheads, reduce a delay, reduce implementation complexity, and improve communication efficiency.

For another example, when the terminal type is CPE, the first communication mode of the CPE may include a feedback manner of a codeword-level ACK/NACK feedback, and the second communication mode may include a feedback manner of a code block group-level ACK/NACK feedback.

According to the foregoing design, because the CPE mainly transmits large data in a stationary scenario, a CBG feedback manner may be used, to avoid repeated transmission of a redundant and correct CBG, and improve transmission efficiency. In addition, the codeword-level feedback manner in the first communication mode may also be applicable to a terminal type with a weak capability, to reduce chip costs.

Optionally, corresponding identifiers may be configured for different feedback manners.

For example, a communication mode of a terminal type A includes a first communication mode and a second communication mode, the first communication mode includes the feedback manner 1, and the second communication mode includes the feedback manner 2. An identifier of the feedback manner 1 may be determined as a1, and an identifier of the feedback manner 2 may be determined as a2. When the network device indicates a terminal device A to switch a feedback manner, the network device may send an identifier of the feedback manner to the terminal device A, to indicate the terminal device A to switch the feedback manner. For example, the network device may send a1 to the terminal device A, to indicate the terminal device A to transmit data in the feedback manner 1, or the network device may send a2 to the terminal device A, to indicate the terminal device A to transmit data in the feedback manner 2.

In another example, a communication mode of a terminal type B includes a first communication mode and a second communication mode, the first communication mode includes a feedback manner 1′, and the second communication mode includes a feedback manner 2′. An identifier of the feedback manner 1′ may be determined as b1, and an identifier of the feedback manner 2′ may be determined as b2. When the network device indicates a terminal device B to switch a feedback manner, the network device may send an identifier of the feedback manner to the terminal device B, to indicate the terminal device B to switch the feedback manner. For example, the network device may send b 1 to the terminal device B, to indicate the terminal device B to transmit data in the feedback manner 1′, or the network device may send b2 to the terminal device B, to indicate the terminal device B to transmit data in the feedback manner 2′.

Optionally, the feedback manner of the terminal device may be a feedback manner used when the terminal device performs uplink communication, or may be a feedback manner used when the terminal device performs downlink communication. In other words, the communication mode of the terminal device may include an uplink feedback manner and/or a downlink feedback manner.

For example, the communication mode of the terminal type A includes the first communication mode and the second communication mode. The first communication mode may include an uplink feedback manner a1′ and/or a downlink feedback manner a1*, and the second communication mode may include an uplink feedback manner a2′ and/or a downlink feedback manner a2*. The uplink feedback manner a1′, the downlink feedback manner a1*, the uplink feedback manner a2′, and the downlink feedback manner a2* may all be one or more of the configuration manners shown in FIG. 7.

In another example, the communication mode of the terminal type B includes the first communication mode and the second communication mode. The first communication mode may include an uplink feedback manner b 1′ and/or a downlink feedback manner b1*, and the second communication mode may include an uplink feedback manner b2′ and/or a downlink feedback manner b2*. The uplink feedback manner b 1′, the downlink feedback manner b1*, the uplink feedback manner b2′, and the downlink feedback manner b2* may all be one or more of the configuration manners shown in FIG. 7.

According to the foregoing embodiment, different feedback manners for data transmission in a communication mode are designed for different terminal types, to better meet communication requirements of different terminal types, and adapt to data transmission of different terminal types. This reduces signaling overheads, reduces communication complexity, reduces chip costs, and improves communication efficiency.

For example, the type of the physical layer function parameter is data transmission, and the data transmission includes the retransmission mechanism shown in FIG. 8. A corresponding configuration manner may be determined, based on the terminal type of the terminal device, for a retransmission mechanism corresponding to each communication mode of the terminal device. This embodiment of this application may be an independent embodiment, or may be combined with another embodiment of the present invention. This is not specifically limited in this application.

The following embodiment is a method for designing a retransmission mechanism for data transmission. In the method, a retransmission mechanism for data transmission may be customized based on a terminal type, to implement matching between a function and a terminal type. This optimally meets requirements of various devices, reduces signaling overheads, reduces a delay in physical layer function switching, reduces communication complexity, and reduces chip costs. This embodiment of this application may be an independent embodiment, or may be combined with another embodiment of this application. This is not specifically limited in this application.

In a possible implementation, the terminal device and/or the network device may determine, based on the terminal type, the retransmission mechanism for data transmission corresponding to the communication mode.

Optionally, there is a correspondence between the terminal type and the retransmission mechanism of the communication mode. The correspondence may be predefined in a protocol, or may be notified by the network device or the core network to a terminal by using upper layer signaling (for example, RRC signaling or MAC signaling) or physical layer signaling.

For example, as shown in the following Table 4, for a terminal type 1, a communication mode 1 may correspond to a retransmission mechanism aR1, a communication mode 2 may correspond to a retransmission mechanism aR2, . . . , and a communication mode n may correspond to a retransmission mechanism aRn; for a terminal type 2, a communication mode 1 may correspond to a retransmission mechanism bR1, a communication mode 2 may correspond to a retransmission mechanism bR2, and a communication mode N may correspond to a retransmission mechanism bRn; . . . ; and for a terminal type X, a communication mode 1 may correspond to a retransmission mechanism xR1, a communication mode 2 may correspond to a retransmission mechanism xR2, . . . , and a communication mode n may correspond to a retransmission mechanism xRn.

TABLE 4
Terminal type and retransmission
mechanism of a communication mode

| Terminal | Communication | Communication | | Communication |
|---|---|---|---|---|
| type | mode 1 | mode 2 | . . . | mode N |
| Type 1 | Retransmission | Retransmission | . . . | Retransmission |
| | mechanism aR1 | mechanism aR2 | | mechanism aRn |
| Type 2 | Retransmission | Retransmission | . . . | Retransmission |
| | mechanism bR1 | mechanism bR2 | | mechanism bRn |
| . . . | . . . | . . . | . . . | |
| Type X | Retransmission | Retransmission | . . . | Retransmission |
| | mechanism xR1 | mechanism xR2 | | mechanism xRn |

The terminal type 1, the terminal type 2, . . . , and the terminal type X may be at least one of the foregoing terminal types, for example, the eMBB, the URLLC, the IoT, the CPE, the V2X, the AR/VR, or the like. This is not limited.

The retransmission mechanism aR1, the retransmission mechanism aR2, and the retransmission mechanism aRn, the retransmission mechanism bR1, the retransmission mechanism bR2, . . . , and the retransmission mechanism bRn, and the retransmission mechanism xR1, the retransmission mechanism xR2, . . . , and the retransmission mechanism xRn may be at least one of the retransmission mechanisms described above, for example, the blind retransmission, the codeword-level retransmission, and the CBG-level retransmission.

aRn, bRn, . . . , and xRn are positive integers, and values of aRn, bRn, . . . , and xRn may be the same or different.

For example, the communication mode of the terminal type includes the first communication mode and the second communication mode. The first communication mode may include a retransmission mechanism 1, and the second communication mode may include a retransmission mechanism 2. The retransmission mechanism 1 may be one or more of the configuration manners shown in FIG. 8, and the retransmission mechanism 2 may also be one or more of the configuration manners shown in FIG. 8. In addition, at least one configuration manner in the retransmission mechanism 1 and the retransmission mechanism 2 is different, and/or the at least one configuration manner has different configuration parameters. For example, when the terminal type is eMBB, the first communication mode of the eMBB may include a retransmission mechanism of codeword-level retransmission, and the second communication mode may include a retransmission mechanism of code block group-level retransmission.

For another example, when the terminal type is URLLC, the first communication mode of the URLLC may include a retransmission mechanism of blind retransmission, and the second communication mode may include a retransmission mechanism of codeword-level retransmission.

According to the foregoing design, because the URLLC mainly performs small-packet transmission and needs to meet a low-delay and high-reliability requirement, the ACK/NACK feedback may not be performed, and retransmission may be directly performed for a plurality of times. In other words, the retransmission mechanism of blind retransmission is used, to reduce feedback overheads, reduce a transmission delay, and meet a low-delay requirement. In addition, repeated transmission is performed for a plurality of times, to improve reliability, and reduce a delay in retransmission after feedback. In addition, the codeword-level retransmission may also be performed on a small packet, and the CBG-level retransmission is not required. This can reduce feedback overheads and improve communication efficiency.

For another example, when the terminal type is IoT, the communication mode of the IoT may include the retransmission mechanism of blind retransmission.

According to the foregoing design, because the IoT mainly transmits small-packet data of a regular service type, an ACK/a NACK may not be fed back. In other words, the retransmission mechanism of blind retransmission is used, to reduce feedback overheads, reduce a delay, reduce implementation complexity, and improve communication efficiency.

For example, when the terminal type is CPE, the first communication mode of the CPE may include the retransmission mechanism of codeword-level retransmission, and the second communication mode may include the retransmission mechanism of code block group-level retransmission.

According to the foregoing design, because the CPE mainly transmits large data in a stationary scenario, a retransmission mechanism of CBG-level retransmission may be used, to avoid repeated transmission of a redundant and correct CBG, and improve transmission efficiency. In addition, the retransmission mechanism of codeword-level retransmission in the first communication mode is applicable to a terminal type with a weak capability, to reduce chip costs.

Optionally, the feedback manner for data transmission may correspond to the retransmission mechanism for data transmission, and there may be a correspondence between the feedback manner for data transmission and the retransmission mechanism for data transmission. The correspondence may be predefined in a protocol, or may be notified by the network device or the core network to a terminal by using upper layer signaling (for example, RRC signaling or MAC signaling) or physical layer signaling.

Optionally, corresponding identifiers may be configured for different retransmission mechanisms.

For example, a communication mode of a terminal type A includes a first communication mode and a second communication mode, the first communication mode includes the retransmission mechanism 1, and the second communication mode includes the retransmission mechanism 2. An identifier of the retransmission mechanism 1 may be determined as aR1, and an identifier of the retransmission mechanism 2 may be determined as aR2. When the network device indicates a terminal device A to switch a retransmission mechanism, the network device may send an identifier of the retransmission mechanism to the terminal device A, to indicate the terminal device AR to switch the retransmission mechanism. For example, the network device may send aR1 to the terminal device A, to indicate the terminal device A to transmit data in the retransmission mechanism 1, or the network device may send aR2 to the terminal device A, to indicate the terminal device A to transmit data in the retransmission mechanism 2.

In another example, a communication mode of a terminal type B includes a first communication mode and a second communication mode, the first communication mode includes the retransmission mechanism 1, and the second communication mode includes the retransmission mechanism 2. An identifier of the retransmission mechanism 1 may be determined as bR1, and an identifier of the retransmission mechanism 2 may be determined as bR2. When the network device indicates a terminal device B to switch a retransmission mechanism, the network device may send an identifier of the retransmission mechanism to the terminal device B, to indicate the terminal device B to switch the retransmission mechanism. For example, the network device may send bR1 to the terminal device B, to indicate the terminal device B to transmit data in the retransmission mechanism 1, or the network device may send bR2 to the terminal device B, to indicate the terminal device B to transmit data in the retransmission mechanism 2.

Optionally, the retransmission mechanism of the terminal device may be a retransmission mechanism used when the terminal device performs uplink communication, or may be a retransmission mechanism used when the terminal device performs downlink communication. In other words, the communication mode of the terminal device may include an uplink retransmission mechanism and/or a downlink retransmission mechanism.

For example, the communication mode of the terminal type A includes the first communication mode and the second communication mode. The first communication mode may include an uplink retransmission mechanism aR1′ and/or a downlink retransmission mechanism aR1*, and the second communication mode may include an uplink retransmission mechanism aR2′ and/or a downlink retransmission mechanism aR2*. The uplink retransmission mechanism aR1′, the downlink retransmission mechanism aR1*, the uplink retransmission mechanism aR2′, and the downlink retransmission mechanism aR2* may all be one or more of the configuration manners shown in FIG. 8.

In another example, the communication mode of the terminal type B includes the first communication mode and the second communication mode. The first communication mode may include an uplink retransmission mechanism bR1′ and/or a downlink retransmission mechanism bR1*, and the second communication mode may include an uplink retransmission mechanism bR2′ and/or a downlink retransmission mechanism bR2*. The uplink retransmission mechanism bR1′, the downlink retransmission mechanism bR1*, the uplink retransmission mechanism bR2′, and the downlink retransmission mechanism bR2* may all be one or more of the configuration manners shown in FIG. 8.

According to the foregoing embodiment, different retransmission mechanisms for data transmission in a communication mode are designed for different terminal types, to better meet communication requirements of different terminal types, and adapt to data transmission of different terminal types. This reduces signaling overheads, reduces communication complexity, reduces chip costs, and improves communication efficiency.

Optionally, for a type of the physical layer function parameter, one or more configuration manners included in the type of the physical layer function parameter may be jointly designed. For example, one communication mode may correspond to the one or more configuration manners included in the type of the physical layer function parameter. An example in which the type of the physical layer function parameter is data transmission is used for the following description. A configuration manner for data transmission may include one or more of a scheduling manner, a feedback manner, a retransmission manner, and another data transmission parameter.

The following embodiment is a data transmission design method. In the method, the configuration manner for data transmission may be customized based on a terminal type, to implement matching between a data transmission function and a terminal type. This optimally meets requirements of various devices, reduces signaling overheads, reduces a delay in physical layer function switching, reduces communication complexity, and reduces chip costs. This embodiment of this application may be an independent embodiment, or may be combined with another embodiment of this application. This is not specifically limited in this application.

In a possible implementation, the terminal device and/or the network device may determine, based on the terminal type, the configuration manner for data transmission corresponding to the communication mode.

Optionally, there is a correspondence between the terminal type and the configuration manner for data transmission. The correspondence may be predefined in a protocol, or may be notified by the network device or the core network to a terminal by using upper layer signaling (for example, RRC signaling or MAC signaling) or physical layer signaling.

For example, refer to Table 5. A correspondence between the terminal type and the communication mode may be at least one row or at least one column in the following Table 5.

TABLE 5
Terminal type and configuration manner for
data transmission in a communication mode

| Terminal | Communication | Communication | | Communication |
|---|---|---|---|---|
| type | mode 1 | mode 2 | . . . | mode N |
| Type 1 | Scheduling | Scheduling | . . . | Scheduling |
| | manner A1 | manner A2 | | manner An |
| | Feedback | Feedback | | Feedback |
| | manner a1 | manner a2 | | manner an |
| | Retransmission | Retransmission | | Retransmission |
| | mechanism aR1 | mechanism aR2 | | mechanism aRn |
| Type 2 | Scheduling | Scheduling | . . . | Scheduling |
| | manner B1 | manner B2 | | manner Bn |
| | Feedback | Feedback | | Feedback |
| | manner b1 | manner b2 | | manner bn |
| | Retransmission | Retransmission | | Retransmission |
| | mechanism bR1 | mechanism bR2 | | mechanism bRn |
| . . . | . . . | . . . | . . . | |
| Type X | Scheduling | Scheduling | . . . | Scheduling |
| | manner X1 | manner X2 | | manner Xn |
| | Feedback | Feedback | | Feedback |
| | manner x1 | manner x2 | | manner xn |
| | Retransmission | Retransmission | | Retransmission |
| | mechanism xR1 | mechanism xR2 | | mechanism xRn |

The terminal type 1, the terminal type 2, . . . , and the terminal type X may be at least one of the foregoing terminal types, for example, the eMBB, the URLLC, the IoT, the CPE, the V2X, the AR/VR, or the like. This is not limited.

The scheduling manner A1 to the scheduling manner An, the scheduling manner B1 to the scheduling manner Bn, and the scheduling manner X1 to the scheduling manner Xn may be at least one of the scheduling manners described above, for example, the dynamic scheduling, the configured grant type scheduling, the SPS scheduling, the slot or sub-slot aggregation, the cross-slot scheduling, the including data in a random access process, or the like.

An, Bn, . . . , and Xn are positive integers, and values of An, Bn, . . . , and Xn may be the same or different.

The feedback manner a1 to the feedback manner an, the feedback manner b 1 to the feedback manner bn, and the feedback manner x1 to the feedback manner xn may all be at least one of the HARQ feedback manners described above, for example, no ACK/NACK feedback, the codeword-level ACK/NACK feedback, the CBG-level ACK/NACK feedback, the synchronous HARQ, the asynchronous HARQ, the adaptive HARQ, the non-adaptive HARQ, or the like.

an, bn, . . . , and xn are positive integers, and values of an, bn, . . . , and xn may be the same or different.

The retransmission mechanism aR1 to the retransmission mechanism aRn, the retransmission mechanism bR1 to the retransmission mechanism bRn, and the retransmission mechanism xR1 to the retransmission mechanism xRn may be at least one of the retransmission mechanisms described above, for example, the blind retransmission, the codeword-level retransmission, and the CBG-level retransmission.

aRn, bRn, . . . , and xRn are positive integers, and values of aRn, bRn, . . . , and xRn may be the same or different.

For example, the communication mode of the terminal type includes the first communication mode and the second communication mode. The first communication mode may include at least two of the scheduling manner 1, the feedback manner 1, and the retransmission mechanism 1. The second communication mode may include at least two of the scheduling manner 2, the feedback manner 2, and the retransmission mechanism 2. The scheduling manner 1 may be one or more of the configuration manners shown in FIG. 6, and the scheduling manner 2 may also be one or more of the configuration manners shown in FIG. 6. The feedback manner 1 may be one or more of the configuration manners shown in FIG. 7, and the feedback manner 2 may also be one or more of the configuration manners shown in FIG. 7. The retransmission mechanism 1 may be one or more of the configuration manners shown in FIG. 8, and the retransmission mechanism 2 may also be one or more of the configuration manners shown in FIG. 8. In addition, at least one configuration manner in the scheduling manner 1 and the scheduling manner 2 is different, and/or the at least one configuration manner has different configuration parameters. In addition/Alternatively, at least one configuration manner in the feedback manner 1 and the feedback manner 2 is different, and/or the at least one configuration manner has different configuration parameters. In addition/Alternatively, at least one configuration manner in the retransmission mechanism 1 and the retransmission mechanism 2 is different, and/or the at least one configuration manner has different configuration parameters. For example, when the terminal type is eMBB, the first communication mode of the eMBB may include the scheduling manner of dynamic scheduling, the feedback manner of a codeword-level ACK/NACK feedback, and the retransmission mechanism of codeword-level retransmission, and the second communication mode may include the slot or sub-slot aggregation scheduling manner, the feedback manner of a code block group-level ACK/NACK feedback, and the retransmission mechanism of code block group-level retransmission.

For another example, when the terminal type is URLLC, the first communication mode of the URLLC may include the configured grant type scheduling manner, the feedback manner in which an ACK/NACK feedback is not required, and the retransmission mechanism of blind retransmission, and the second communication mode may include the slot or sub-slot aggregation scheduling manner, the feedback manner of a codeword-level ACK/NACK feedback, and the retransmission mechanism of codeword-level retransmission.

According to the foregoing design, because URLLC data transmission is mainly transmission of a small-packet low-delay and high-reliability service, dynamic scheduling may not be performed, and transmission is directly performed in the configured grant type scheduling manner. An incoming packet can be transmitted at any time, to reduce a delay. Repeated transmission can be performed for a plurality of times by using slot aggregation, to improve reliability, and reduce a delay in feedback and retransmission. In addition, a low-delay and high-reliability requirement needs to be met. Therefore, the ACK/NACK feedback may not be performed, and retransmission may be directly performed for a plurality of times. In other words, the retransmission mechanism of blind retransmission is used, to reduce feedback overheads, reduce a transmission delay, and meet a low-delay requirement. In addition, repeated transmission is performed for a plurality of times, to improve reliability, and reduce a delay in retransmission after feedback. In addition, the codeword-level retransmission may also be performed on a small packet, and the CBG-level retransmission is not required. This can reduce feedback overheads and improve communication efficiency.

For another example, when the terminal type is IoT, the first communication mode of the IoT may include the dynamic scheduling or the configured grant type scheduling manner, the feedback manner in which an ACK/NACK feedback is not required, and the retransmission mechanism of blind retransmission, and the second communication mode may include the scheduling manner of including data in a message 1 or a message 3 in a random access process, the feedback manner in which an ACK/NACK feedback is not required, and the retransmission mechanism of blind retransmission.

According to the foregoing design, because the IoT mainly transmits small-packet data of a regular service type, the scheduling manner of dynamic scheduling may be performed. This can implement fast data transmission, reduce a transmission delay, and improve communication efficiency. In addition, an ACK/a NACK may not be fed back. In other words, the retransmission mechanism of blind retransmission is used, to reduce feedback overheads, reduce a delay, reduce implementation complexity, and improve communication efficiency.

For another example, when the terminal type is CPE, the first communication mode of the CPE may include the scheduling manner of dynamic scheduling and the slot or sub-slot aggregation scheduling manner, the feedback manner of a codeword-level ACK/NACK feedback, and the retransmission mechanism of codeword-level retransmission, and the second communication mode may include the scheduling manner of cross-slot scheduling, the feedback manner of a code block group-level ACK/NACK feedback, and the retransmission mechanism of code block group-level retransmission.

According to the foregoing design, because the CPE mainly transmits large data in a stationary scenario, a high power consumption mode may be used, data is transmitted at any time, and a large packet may be transmitted in a plurality of slots by using dynamic scheduling such as cross-slot scheduling and slot aggregation. This can improve communication efficiency. In addition, the retransmission mechanism of CBG-level retransmission manner may be used, to avoid repeated transmission of a redundant and correct CBG, and improve transmission efficiency. In addition, the retransmission mechanism of codeword-level retransmission in the first communication mode is applicable to a terminal type with a weak capability, to reduce chip costs.

Optionally, the feedback manner for data transmission may correspond to the retransmission mechanism for data transmission, and there may be a correspondence between the feedback manner for data transmission and the retransmission mechanism for data transmission. The correspondence may be predefined in a protocol, or may be notified by the network device or the core network to a terminal by using upper layer signaling (for example, RRC signaling or MAC signaling) or physical layer signaling.

Optionally, corresponding identifiers may be configured for different configuration manner for data transmissions. One data transmission identifier may correspond to one or more of configuration manner for data transmissions. For example, one configuration identifier may correspond to at least two of a data transmission scheduling manner, a feedback manner, and a retransmission mechanism. This can reduce configuration overheads during function switching of data transmission.

For example, a communication mode of the terminal type A includes a first communication mode and a second communication mode, the first communication mode includes a scheduling manner 1, a feedback manner 1, and a retransmission mechanism 1, and the second communication mode includes a scheduling manner 2, a feedback manner 2, and a retransmission mechanism 2. An identifier of the data transmission in the first communication mode may be determined as aDT1, and an identifier of the data transmission in the first communication mode may be determined as aDT2. When the network device indicates the terminal device A to switch a function of data transmission, the network device may send the identifier of the data transmission to the terminal device A, to indicate the terminal device A to switch the function of data transmission. For example, the network device may send aDT1 to the terminal device A, to indicate the terminal device A to transmit data in the scheduling manner 1, the feedback manner 1, and the retransmission mechanism 1, or the network device may send aDT2 to the terminal device A, to indicate the terminal device A to transmit data in the scheduling manner 2, the feedback manner 2, and the retransmission mechanism 2.

In another example, a communication mode of the terminal type B includes a first communication mode and a second communication mode, the first communication mode includes a scheduling manner 1′, a feedback manner 1′, and a retransmission mechanism 1′, and the second communication mode includes a scheduling manner 2′, a feedback manner 2′, and a retransmission mechanism 2′. An identifier of the data transmission in the first communication mode may be determined as bDT1, and an identifier of the data transmission in the second communication mode may be determined as bDT2. When the network device indicates the terminal device B to switch a function of data transmission, the network device may send the identifier of the data transmission to the terminal device B, to indicate the terminal device B to switch the function of data transmission. For example, the network device may send bDT1 to the terminal device B, to indicate the terminal device B to transmit data in the scheduling manner 1′, the feedback manner 1′, and the retransmission mechanism 1′, or the network device may send bDT2 to the terminal device B, to indicate the terminal device B to transmit data in the scheduling manner 2′, the feedback manner 2′, and the retransmission mechanism 2′.

Optionally, the configuration manner for data transmission of the terminal device may be a configuration manner for data transmission used when the terminal device performs uplink communication, or may be a configuration manner for data transmission used when the terminal device performs downlink communication. In other words, the communication mode of the terminal device may include uplink data transmission and/or downlink data transmission.

For example, a communication mode of the terminal type A includes a first communication mode and a second communication mode. The first communication mode may include one or more of an uplink scheduling manner A1′ and/or a downlink scheduling manner A1*, an uplink feedback manner a1′ and/or a downlink feedback manner a1*, and an uplink retransmission mechanism aR1′ and/or a downlink retransmission mechanism aR1*. The second communication mode may include an uplink scheduling manner A2′ and/or a downlink scheduling manner A2*, an uplink feedback manner a2′ and/or a downlink feedback manner a2*, an uplink retransmission mechanism aR2′ and/or a downlink retransmission mechanism aR2*. The uplink scheduling manner A1′, the downlink scheduling manner A1*, the uplink scheduling manner A2′, and the downlink scheduling manner A2* may all be one or more of the configuration manners shown in FIG. 6. The uplink feedback manner a1′, the downlink feedback manner a1*, the uplink feedback manner a2′, and the downlink feedback manner a2* may all be one or more of the configuration manners shown in FIG. 7. The uplink retransmission mechanism aR1′, the downlink retransmission mechanism aR1*, the uplink retransmission mechanism aR2′, and the downlink retransmission mechanism aR2* may all be one or more of the configuration manners shown in FIG. 8.

In another example, a communication mode of the terminal type B includes a first communication mode and a second communication mode. The first communication mode may include an uplink scheduling manner B 1′ and/or a downlink scheduling manner B1*, an uplink feedback manner b1′ and/or a downlink feedback manner b1*, and an uplink retransmission mechanism bR1′ and/or a downlink retransmission mechanism bR1*. The second communication mode may include an uplink scheduling manner B2′ and/or a downlink scheduling manner B2*, an uplink feedback manner b2′ and/or a downlink feedback manner b2*, and an uplink retransmission mechanism bR2′ and/or a downlink retransmission mechanism bR2*. The uplink scheduling manner B1′, the downlink scheduling manner B1*, the uplink scheduling manner B2′, and the downlink scheduling manner B2* may all be one or more of the configuration manners shown in FIG. 6. The uplink feedback manner b1′, the downlink feedback manner b1*, the uplink feedback manner b2′, and the downlink feedback manner b2* may all be one or more of the configuration manners shown in FIG. 7. The uplink retransmission mechanisms bR1′, the downlink retransmission mechanisms bR1*, the uplink retransmission mechanism bR2′, and the downlink retransmission mechanism bR2* may be one or more of the configuration manners shown in FIG. 8.

According to the foregoing embodiment, different configuration manners for data transmission in a communication mode are designed for different terminal types, and a plurality of configuration manners for data transmission are jointly used as one configuration identifier, to better meet communication requirements of different terminal types, and adapt to data transmission of different terminal types. This reduces signaling overheads, reduces communication complexity, reduces chip costs, and improves communication efficiency. For example, the type of the physical layer function parameter is the CSI measurement feedback shown in FIG. 9. A corresponding configuration manner may be determined, based on the terminal type of the terminal device, for a CSI measurement feedback corresponding to each communication mode of the terminal device.

This embodiment of this application may be an independent embodiment, or may be combined with another embodiment of this application. This is not specifically limited in this application.

The following embodiment is a CSI measurement feedback design method. In the method, a configuration manner of a CSI measurement feedback may be customized based on a terminal type, to implement matching between a CSI measurement feedback function and a terminal. This optimally meets requirements of various devices, reduces signaling overheads, reduces a delay in physical layer function switching, reduces communication complexity, and reduces chip costs. This embodiment of this application may be an independent embodiment, or may be combined with another embodiment of the present invention. This is not specifically limited in this application.

In a possible implementation, the terminal device and/or the network device may determine, based on the terminal type, the configuration manner of the CSI measurement feedback corresponding to the communication mode.

Optionally, there is a correspondence between the terminal type and the configuration manner of the CSI measurement feedback. The correspondence may be predefined in a protocol, or may be notified by the network device or the core network to a terminal by using upper layer signaling (for example, RRC signaling or MAC signaling) or physical layer signaling.

For example, refer to Table 6. A correspondence between the terminal type and the configuration manner of the CSI measurement feedback in a communication mode may be at least one row or at least one column in the following table.

TABLE 6
Terminal type and configuration manner of the CSI
measurement feedback in a communication mode

| | Data | Data | | Data |
|---|---|---|---|---|
| Terminal | transmission | transmission | | transmission |
| type | mode 1 | mode 2 | . . . | mode N |
| Type 1 | CSI measurement | CSI measurement | . . . | CSI measurement |
| | feedback | feedback | | feedback |
| | manner AC1 | manner AC2 | | manner ACn |
| Type 2 | CSI measurement | CSI measurement | . . . | CSI measurement |
| | feedback | feedback | | feedback |
| | manner BC1 | manner BC2 | | manner BCn |
| . . . | . . . | . . . | . . . | |
| Type X | CSI measurement | CSI measurement | . . . | CSI measurement |
| | feedback | feedback | | feedback |
| | manner XC1 | manner XC2 | | manner XCn |

The terminal type 1, the terminal type 2, . . . , and the terminal type X may be at least one of the foregoing terminal types, for example, the eMBB, the URLLC, the IoT, the CPE, the V2X, the AR/VR, or the like. This is not limited.

The CSI measurement feedback manner AC1 to the CSI measurement feedback manner ACn, the CSI measurement feedback manner BC1 to the CSI measurement feedback manner BCn, and the CSI measurement feedback manner XC1 to the CSI measurement feedback manner XCn may be at least one of the CSI measurement feedback manners described above, for example, a periodic feedback, an aperiodic feedback, a semi-persistent feedback, a subband feedback, or a wideband feedback.

ACn, BCn, . . . , and XCn are positive integers, and values of ACn, BCn, . . . , and XCn may be the same or different.

For example, the communication mode of the terminal type includes a first communication mode and a second communication mode. The first communication mode may include a CSI measurement feedback 1, and the second communication mode may include a CSI measurement feedback 2. The CSI measurement feedback 1 may be one or more of the configuration manners shown in FIG. 9, and the CSI measurement feedback 2 may also be one or more of the configuration manners shown in FIG. 9. In addition, at least one configuration manner in the CSI measurement feedback 1 and the CSI measurement feedback 2 is different, and/or the at least one configuration manner has different configuration parameters.

For example, when the terminal type is eMBB, the first communication mode of the eMBB may include the periodic CSI measurement feedback and/or have 16 or 32 antenna ports, the second communication mode may include the aperiodic CSI measurement feedback, and the third communication mode may include the semi-persistent CSI measurement feedback.

For another example, when the terminal type is URLLC, the communication mode of the URLLC may include the periodic CSI measurement feedback and/or have 4 or 8 antenna ports.

According to the foregoing design, the URLLC is mainly used in a factory scenario, and a moving route of the terminal device is known or predictable. Therefore, a channel environment is relatively stable. Therefore, the CSI measurement feedback may not be performed, to reduce power consumption. In addition, for some terminals, periodic measurement may also be performed once in a period of time, and a route is known or predictable. In this way, channel information is obtained with minimum power consumption, and communication efficiency is improved.

For another example, when the terminal type is IoT, the communication mode of the IoT may include the periodic CSI measurement feedback.

According to the foregoing design, because the IoT is mainly used in a stationary scenario such as a smart water meter, the CSI measurement feedback may not be performed. In a high-speed scenario, the aperiodic CSI measurement feedback may be performed to trigger a feedback, so that power consumption is reduced, and communication efficiency is improved.

For another example, when the terminal type is CPE, the communication mode of the CPE may include the periodic CSI measurement feedback.

According to the foregoing design, because the CPE mainly transmits large data in a stationary scenario and has no mobility, periodic measurement may be performed once in a period of time, to obtain channel information with minimum power consumption and improve communication efficiency.

Optionally, corresponding identifiers may be configured for different CSI measurement feedbacks.

For example, the communication mode of the terminal type A includes a first communication mode and a second communication mode, the first communication mode includes a CSI measurement feedback 1, and the second communication mode includes a CSI measurement feedback 2. An identifier of the CSI measurement feedback 1 may be determined as AC1, and an identifier of the CSI measurement feedback 2 may be determined as AC2. When the network device indicates the terminal device A to perform CSI measurement feedback switching, the network device may send an identifier of the CSI measurement feedback to the terminal device A, to indicate the terminal device AC to perform CSI measurement feedback switching. For example, the network device may send AC1 to the terminal device A, to indicate the terminal device A to transmit data by using the CSI measurement feedback 1, or the network device may send AC2 to the terminal device A, to indicate the terminal device A to transmit data by using the CSI measurement feedback 2.

In another example, the communication mode of the terminal type B includes a first communication mode and a second communication mode, the first communication mode includes a CSI measurement feedback 1, and the second communication mode includes a CSI measurement feedback 2. An identifier of the CSI measurement feedback 1 may be determined as BC1, and an identifier of the CSI measurement feedback 2 may be determined as BC2. When the network device indicates the terminal device B to perform CSI measurement feedback switching, the network device may send an identifier of the CSI measurement feedback to the terminal device B, to indicate the terminal device B to perform CSI measurement feedback switching. For example, the network device may send BC1 to the terminal device B, to indicate the terminal device B to transmit data by using the CSI measurement feedback 1, or the network device may send BC2 to the terminal device B, to indicate the terminal device B to transmit data by using the CSI measurement feedback 2.

Optionally, the CSI measurement feedback of the terminal device may be a CSI measurement feedback used when the terminal device performs uplink communication, or may be a CSI measurement feedback used when the terminal device performs downlink communication. In other words, the communication mode of the terminal device may include an uplink CSI measurement feedback and/or a downlink CSI measurement feedback.

For example, the communication mode of the terminal type A includes a first communication mode and a second communication mode. The first communication mode may include an uplink CSI measurement feedback AC1′ and/or a downlink CSI measurement feedback AC1*, and the second communication mode may include an uplink CSI measurement feedback AC2′ and/or a downlink CSI measurement feedback AC2*. The uplink CSI measurement feedback AC1′, the downlink CSI measurement feedback AC1*, the uplink CSI measurement feedback ACT, and the downlink CSI measurement feedback AC2* may all be one or more of the configuration manners shown in FIG. 9.

In another example, the communication mode of the terminal type B includes a first communication mode and a second communication mode. The first communication mode may include an uplink CSI measurement feedback BC1′ and/or a downlink CSI measurement feedback BC1*, and the second communication mode may include an uplink CSI measurement feedback BC2′ and/or a downlink CSI measurement feedback BC2*. The uplink CSI measurement feedback BC1′, the downlink CSI measurement feedback BC1*, the uplink CSI measurement feedback BC2′, and the downlink CSI measurement feedback BC2* may all be one or more of the configuration manners shown in FIG. 9.

According to the foregoing embodiment, configuration manners of a CSI measurement feedback in a communication mode are designed for different terminal types, to better meet communication requirements of different terminal types, and adapt to data transmission of different terminal types. This reduces signaling overheads, reduces communication complexity, reduces chip costs, and improves communication efficiency.

For example, the type of the physical layer function parameter is the power control shown in FIG. 10. A corresponding configuration manner may be determined, based on the terminal type of the terminal device, for power control corresponding to each communication mode of the terminal device.

This embodiment of this application may be an independent embodiment, or may be combined with another embodiment of the present invention. This is not specifically limited in this application.

The following embodiment is a power control design method. In the method, the configuration manner for power control may be customized based on a terminal type, to implement matching between a power control function and a terminal. This optimally meets requirements of various devices, reduces signaling overheads, reduces a delay in physical layer function switching, reduces communication complexity, and reduces chip costs. This embodiment of this application may be an independent embodiment, or may be combined with another embodiment of the present invention. This is not specifically limited in this application.

In a possible implementation, the terminal device and/or the network device may determine, based on the terminal type, the configuration manner for power control corresponding to the communication mode.

Optionally, there is a correspondence between the terminal type and the configuration manner for power control. The correspondence may be predefined in a protocol, or may be notified by the network device or the core network to a terminal by using upper layer signaling (for example, RRC signaling or MAC signaling) or physical layer signaling.

For example, refer to Table 7. A correspondence between the terminal type and the configuration manner for power control in a communication mode may be at least one row or at least one column in the following Table 7.

TABLE 7
Table 7 Terminal type and configuration manner
for power control in a communication mode

| Terminal | Communication | Communication | | Communication |
|---|---|---|---|---|
| type | mode 1 | mode 2 | . . . | mode N |
| Type 1 | Power control | Power control | . . . | Power control |
| | manner AP1 | manner AP2 | | manner APn |
| Type 2 | Power control | Power control | . . . | Power control |
| | manner BP1 | manner BP2 | | manner BPn |
| . . . | . . . | . . . | . . . | |
| Type X | Power control | Power control | . . . | Power control |
| | manner XP1 | manner XP2 | | manner XPn |

The terminal type 1, the terminal type 2, . . . , and the terminal type X may be at least one of the foregoing terminal types, for example, the eMBB, the URLLC, the IoT, the CPE, the V2X, the AR/VR, or the like. This is not limited.

The power control manner AP1 to the power control manner APn, the power control manner BP1 to the power control manner BPn, and the power control manner XP1 to the power control manner XPn may be at least one of the power control manners described above, for example, open-loop power control, closed-loop power control, closed-loop inner-loop power control, closed-loop outer-loop power control, and PHR reporting power control.

The power control manner AP1 may also be referred to as power control AP1 for short. AP1 is merely an example, and other values are similar. Details are not described herein again.

APn, BPn, . . . , and XPn are positive integers, and values of APn, BPn, . . . , and XPn may be the same or different. For example, the communication mode of the terminal type includes the first communication mode and the second communication mode. The first communication mode may include power control 1, and the second communication mode may include power control 2. The power control 1 may be one or more of the configuration manners shown in FIG. 10, and the power control 2 may also be one or more of the configuration manners shown in FIG. 10. In addition, at least one configuration manner in the power control 1 and the power control 2 is different, and/or the at least one configuration manner has different configuration parameters.

For example, when the terminal type is eMBB, the first communication mode of the eMBB may include the open-loop power control, the second communication mode may include the closed-loop power control, and the third communication mode may include the PHR reporting and the closed-loop power control.

For another example, when the terminal type is URLLC, the first communication mode of the URLLC may include the open-loop power control, and the second communication mode may include the closed-loop power control.

According to the foregoing design, the URLLC is mainly used in a factory scenario, and a moving route of the terminal device is known or predictable. Therefore, a channel environment is relatively stable. Therefore, the open-loop power control may be performed, to reduce power consumption and reduce complexity. In addition, for some terminals, the closed-loop power control may alternatively be performed, to reduce power consumption and improve communication efficiency.

For another example, when the terminal type is IoT, the communication mode of the IoT may include the open-loop power control.

According to the foregoing design, because the IoT is mainly used in a stationary scenario such as a smart water meter, the open-loop power control may be performed, to reduce complexity, reduce power consumption, and improve communication efficiency.

For another example, when the terminal type is CPE, the communication mode of the CPE may include the closed-loop power control.

According to the foregoing design, because the CPE mainly transmits large data in a stationary scenario and has no mobility, the closed-loop power control may be performed, to reduce power consumption and improve communication efficiency.

Optionally, corresponding identifiers may be configured for different power control.

For example, the communication mode of the terminal type A includes a first communication mode and a second communication mode, the first communication mode includes power control 1, and the second communication mode includes power control 2. An identifier of the power control 1 may be determined as AP1, and an identifier of the power control 2 may be determined as AP2. When the network device indicates the terminal device A to switch the power control, the network device may send an identifier of the power control to the terminal device A, to indicate the terminal device AP to switch the power control. For example, the network device may send AP1 to the terminal device A, to indicate the terminal device A to transmit data by using the power control 1, or the network device may send AP2 to the terminal device A, to indicate the terminal device A to transmit data by using the power control 2.

In another example, the communication mode of the terminal type B includes a first communication mode and a second communication mode, the first communication mode includes power control 1, and the second communication mode includes power control 2. An identifier of the power control 1 may be determined as BP1, and an identifier of the power control 2 may be determined as BP2. When the network device indicates the terminal device B to switch the power control, the network device may send an identifier of the power control to the terminal device B, to indicate the terminal device B to switch the power control. For example, the network device may send BP1 to the terminal device B, to indicate the terminal device B to transmit data by using the power control 1, or the network device may send BP2 to the terminal device B, to indicate the terminal device B to transmit data by using the power control 2.

According to the foregoing embodiment, configuration manners for power control in a communication mode are designed for different terminal types, to better meet communication requirements of different terminal types, and adapt to data transmission of different terminal types. This reduces signaling overheads, reduces communication complexity, reduces chip costs, and improves communication efficiency.

For example, the type of the physical layer function parameter is the beam management shown in FIG. 11c. A corresponding configuration manner may be determined, based on the terminal type of the terminal device, for beam management corresponding to each communication mode of the terminal device.

This embodiment of this application may be an independent embodiment, or may be combined with another embodiment of the present invention. This is not specifically limited in this application.

The following embodiment is a beam management design method. In the method, the configuration manner for beam management may be customized based on a terminal type, to implement matching between a beam management function and a terminal. This optimally meets requirements of various devices, reduces signaling overheads, reduces a delay in physical layer function switching, reduces communication complexity, and reduces chip costs. This embodiment of this application may be an independent embodiment, or may be combined with another embodiment of the present invention. This is not specifically limited in this application.

In a possible implementation, the terminal device and/or the network device may determine, based on the terminal type, the configuration manner for beam management corresponding to the communication mode.

Optionally, there is a correspondence between the terminal type and the configuration manner for beam management. The correspondence may be predefined in a protocol, or may be notified by the network device or the core network to a terminal by using upper layer signaling (for example, RRC signaling or MAC signaling) or physical layer signaling.

For example, refer to Table 8. A correspondence between the terminal type and the configuration manner for beam management in a communication mode may be at least one row or at least one column in the following Table 8.

TABLE 8
Terminal type and configuration manner for
beam management in a communication mode

| Terminal | Communication | Communication | | Communication |
|---|---|---|---|---|
| type | mode 1 | mode 2 | . . . | mode N |
| Type 1 | Beam | Beam | . . . | Beam |
| | management | management | | management |
| | manner AM1 | manner AM2 | | manner AMn |
| Type 2 | Beam | Beam | . . . | Beam |
| | management | management | | management |
| | manner BM1 | manner BM2 | | manner BMn |
| . . . | . . . | . . . | . . . | |
| Type X | Beam | Beam | . . . | Beam |
| | management | management | | management |
| | manner XM1 | manner XM2 | | manner XMn |

The terminal type 1, the terminal type 2, . . . , and the terminal type X may be at least one of the foregoing terminal types, for example, the eMBB, the URLLC, the IoT, the CPE, the V2X, the AR/VR, or the like. This is not limited.

The beam management manner AM1 to the beam management manner AMn, the beam management manner BM1 to the beam management manner BMn, and the beam management manner XM1 to the beam management manner XMn may be at least one of the beam management manners described above, for example, beam management of beam sweeping, beam management of wide beam sweeping, beam management of narrow beam sweeping, beam management of beam tracking, beam management of beam recovery, or beam management that does not need to be performed. The beam management manner AM1 may also be referred to as beam management AM1 for short. AM1 is merely an example, and other values are similar. Details are not described herein again.

AMn, BMn, . . . , and XMn are positive integers, and values of AMn, BMn, and XMn may be the same or different.

Optionally, the terminal device and/or the network device may determine the configuration manner for beam management based on a terminal type and a terminal capability.

Optionally, there is a correspondence between the terminal type, the terminal capability, and the configuration manner for beam management. The correspondence may be predefined in a protocol, or may be notified by the network device or the core network to a terminal by using upper layer signaling (for example, RRC signaling or MAC signaling) or physical layer signaling.

For terminals of different terminal types, considering different data transmission requirements of the terminals and different capabilities of the terminal devices, a more suitable beam management manner may be used.

The capability of the terminal device includes one or more of the following: a large quantity of antennas, whether to support beam sending, whether to support beam receiving, whether the terminal device is moving, whether the terminal device is static, whether a path is known, whether a path can be reported, whether a path is fixed, and the like.

For example, the communication mode of the terminal type includes the first communication mode and the second communication mode. The first communication mode may include beam management 1, and the second communication mode may include beam management 2. The beam management 1 may be one or more of the configuration manners shown in FIG. 11c, and the beam management 2 may also be one or more of the configuration manners shown in FIG. 11c. In addition, at least one configuration manner in the beam management 1 and the beam management 2 is different, and/or the at least one configuration manner has different configuration parameters.

For example, when the terminal type is eMBB, the first communication mode of the eMBB may include the beam sweeping, the second communication mode may include the beam tracking, and the third communication mode may include the beam recovery.

For another example, when the terminal type is URLLC, the communication mode of the URLLC may include the beam sweeping.

According to the foregoing design, in a URLLC scenario of a type such as a mechanical arm, the beam management may be performed to implement beam alignment and location prediction, a precise beam may be determined by using the beam sweeping, and data transmission in the beam may be prepared in advance. This can reduce a delay, meet a requirement for a precise operation of a service and a delay, and improve communication efficiency.

Optionally, corresponding identifiers may be configured for different beam management.

For example, the communication mode of the terminal type A includes a first communication mode and a second communication mode, the first communication mode includes beam management 1, and the second communication mode includes beam management 2. An identifier of beam management 1 may be determined as AM1, and an identifier of beam management 2 may be determined as AM2. When the network device indicates the terminal device A to switch the beam management, the network device may send an identifier of the beam management to the terminal device A, to indicate the terminal device AM to switch the beam management. For example, the network device may send AM1 to the terminal device A, to indicate the terminal device A to perform communication by using beam management 1, or the network device may send AM2 to the terminal device A, to indicate the terminal device A to perform communication by using beam management 2.

In another example, the communication mode of the terminal type B includes a first communication mode and a second communication mode, the first communication mode includes beam management 1′, and the second communication mode includes beam management 2′. An identifier of the beam management 1′ may be determined as BM1, and an identifier of the beam management 2′ may be determined as BM2. When the network device indicates the terminal device B to switch the beam management, the network device may send an identifier of the beam management to the terminal device B, to indicate the terminal device B to switch the beam management. For example, the network device may send BM1 to the terminal device B, to indicate the terminal device B to perform communication by using beam management 1′, or the network device may send BM2 to the terminal device B, to indicate the terminal device B to perform communication by using beam management 2′.

Optionally, the beam management of the terminal device may be beam management used when the terminal device performs uplink communication, or may be beam management used when the terminal device performs downlink communication. In other words, the communication mode of the terminal device may include uplink beam management and/or downlink beam management.

For example, the communication mode of the terminal type A includes a first communication mode and a second communication mode. The first communication mode may include uplink beam management AM1′ and/or downlink beam management AM1*, and the second communication mode may include uplink beam management AM2′ and/or downlink beam management AM2*. The uplink beam management AM1′, the downlink beam management AM1*, the uplink beam management AM2′, and the downlink beam management AM2* may all be one or more of the configuration manners shown in FIG. 11c.

In another example, the communication mode of the terminal type B includes a first communication mode and a second communication mode. The first communication mode may include uplink beam management BM1′ and/or downlink beam management BM1*, and the second communication mode may include uplink beam management BM2′ and/or downlink beam management BM2*. The uplink beam management BM1′, the downlink beam management BM1*, the uplink beam management BM2′, and the downlink beam management BM2* may all be one or more of the configuration manners shown in FIG. 11c.

According to the foregoing embodiment, configuration manners for beam management in a communication mode are designed for different terminal types, to better meet communication requirements of different terminal types, and adapt to data transmission of different terminal types. This reduces signaling overheads, reduces communication complexity, reduces chip costs, and improves communication efficiency.

Based on the foregoing related descriptions of the communication mode and the physical layer function parameter, at least one communication mode may be determined for the terminal device based on the terminal type, and the first correspondence between a communication mode and a physical layer function parameter is configured for the terminal device based on the method shown in step 301, so that the network device sends the identifier of the communication mode to the terminal device, to indicate the terminal device to switch the communication mode. This reduces RRC signaling overheads, reduces a switching delay of the physical layer function parameter, and reduces power consumption of the terminal device.

Types of the physical layer function parameters in different communication modes may be the same or different. When the types of the physical layer function parameters are the same, configuration manners corresponding to the physical layer function parameters may be the same or different. When configuration manners of the physical layer function parameters are the same, configuration parameters corresponding to the configuration manners may be the same or different. When the configuration parameters are the same, values of the configuration parameters are different.

Further, the communication mode of the terminal device may be a communication mode used when the terminal device performs uplink communication, or may be a communication mode used when the terminal device performs downlink communication. In other words, the communication mode in the first correspondence of the terminal device may be an uplink communication mode or a downlink communication mode.

Optionally, for types of a plurality of physical layer function parameters, one communication mode may correspond to configuration manners of the types of the plurality of physical layer function parameters. In other words, the types of the plurality of physical layer function parameters are jointly designed. For example, one communication mode may correspond to the configuration manners of the types of the plurality of physical layer function parameters. For example, the following uses an example in which the type of the physical layer function parameter is one or more of the data transmission, the CSI measurement feedback, the power control, the beam management, and the mobility for description.

The following embodiment is a communication design method. In the method, the configuration manner for communication may be customized based on a terminal type, to implement matching between a function and a terminal. This optimally meets requirements of various devices, reduces signaling overheads, reduces a delay in physical layer function switching, reduces communication complexity, and reduces chip costs. This embodiment of this application may be an independent embodiment, or may be combined with another embodiment of the present invention. This is not specifically limited in this application.

In a possible implementation, the terminal device and/or the network device may determine, based on the terminal type, the physical layer function parameter corresponding to the communication mode.

Optionally, there is a correspondence between the terminal type and the physical layer function parameter. The correspondence may be predefined in a protocol, or may be notified by the network device or the core network to a terminal by using upper layer signaling (for example, RRC signaling or MAC signaling) or physical layer signaling.

For example, refer to Table 9. A correspondence between the terminal type and the physical layer function parameter of the communication mode may be at least one row or at least one column in the following Table 9.

TABLE 9
Terminal type and physical layer function parameter

| Terminal | Communication | Communication | | Communication |
|---|---|---|---|---|
| type | mode 1 | mode 2 | . . . | mode N |
| Type 1 | Data transmission ADT1 | Data transmission ADT2 | . . . | Data transmission ADTn |
| | CSI measurement | CSI measurement | | CSI measurement |
| | feedback manner AC1 | feedback manner AC2 | | feedback manner ACn |
| | Power control manner AP1 | Power control manner AP2 | | Power control manner APn |
| | Beam management manner AM1 | Beam management manner AM2 | | Beam management manner AMn |
| Type 2 | Data transmission BDT1 | Data transmission BDT2 | . . . | Data transmission BDTn |
| | CSI measurement | CSI measurement | | CSI measurement |
| | feedback manner BC1 | feedback manner BC2 | | feedback manner BCn |
| | Power control manner BP1 | Power control manner BP2 | | Power control manner BPn |
| | Beam management manner BM1 | Beam management manner BM2 | | Beam management manner BMn |
| . . . | . . . | . . . | . . . | |
| Type X | Data transmission XDT1 | Data transmission XDT2 | . . . | Data transmission XDTn |
| | CSI measurement | CSI measurement | | CSI measurement |
| | feedback manner XC1 | feedback manner XC2 | | feedback manner XCn |
| | Power control manner XP1 | Power control manner XP2 | | Power control manner XPn |
| | Beam management manner XM1 | Beam management manner XM2 | | Beam management manner XMn |

The terminal type 1, the terminal type 2, . . . , and the terminal type X may be at least one of the foregoing terminal types, for example, the eMBB, the URLLC, the IoT, the CPE, the V2X, the AR/VR, or the like. This is not limited.

The data transmission ADT1 to the data transmission XDT1, the data transmission ADT2 to the data transmission XDT2, and the data transmission ADTn to the data transmission XDTn may be at least one of the data transmission described above, for example, dynamic scheduling, configured grant type scheduling, SPS scheduling, slot or sub-slot aggregation, cross-slot scheduling, including data in a random access process, no ACK/NACK feedback, a codeword-level ACK/NACK feedback, a CBG-level ACK/NACK feedback, a synchronous HARQ, an asynchronous HARQ, an adaptive HARQ, a non-adaptive HARQ, blind retransmission, codeword-level retransmission, or CBG-level retransmission.

ACn, BCn, . . . , and XCn are positive integers, and values of ACn, BCn, . . . , and XCn may be the same or different.

The CSI measurement feedback manner AC1 to the CSI measurement feedback manner ACn, the CSI measurement feedback manner BC1 to the CSI measurement feedback manner BCn, and the CSI measurement feedback manner XC1 to the CSI measurement feedback manner XCn may be at least one of the CSI measurement feedback manners described above, for example, a periodic feedback, an aperiodic feedback, a semi-persistent feedback, a subband feedback, or a wideband feedback.

ACn, BCn, . . . , and XCn are positive integers, and values of ACn, BCn, . . . , and XCn may be the same or different.

The power control manner AP1 to the power control manner APn, the power control manner BP1 to the power control manner BPn, and the power control manner XP1 to the power control manner XPn may be at least one of the power control manners described above, for example, open-loop power control, closed-loop power control, closed-loop inner-loop power control, closed-loop outer-loop power control, and PHR reporting power control.

The power control manner AP1 may also be referred to as power control AP1 for short. AP1 is merely an example, and other values are similar. Details are not described herein again.

APn, BPn, . . . , and XPn are positive integers, and values of APn, BPn, . . . , and XPn may be the same or different.

The beam management manner AM1 to the beam management manner AMn, the beam management manner BM1 to the beam management manner BMn, and the beam management manner XM1 to the beam management manner XMn may be at least one of the beam management manners described above, for example, beam management of beam sweeping, beam management of wide beam sweeping, beam management of narrow beam sweeping, beam management of beam tracking, beam management of beam recovery, or beam management that does not need to be performed. The beam management manner AM1 may also be referred to as beam management AM1 for short. AM1 is merely an example, and other values are similar. Details are not described herein again.

AMn, BMn, . . . , and XMn are positive integers, and values of AMn, BMn, and XMn may be the same or different.

For example, the communication mode of the terminal type includes a first communication mode and a second communication mode. The first communication mode may include one or more of data transmission 1, a CSI measurement feedback 1, power control 1, and beam management 1. The second communication mode may include data transmission 2, a CSI measurement feedback 2, power control 2, and beam management 2. The data transmission 1 may be one or more of the configuration manners shown in FIG. 6 to FIG. 8. The data transmission 2 may be one or more of the configuration manners shown in FIG. 6 to FIG. 8. The CSI measurement feedback 1 may be one or more of the configuration manners shown in FIG. 9. The CSI measurement feedback 2 may be one or more of the configuration manners shown in FIG. 9. The power control 1 may be one or more of the configuration manners shown in FIG. 10. The power control 2 may be one or more of the configuration manners shown in FIG. 10. The beam management 1 may be one or more of the configuration manners shown in FIG. 11c. The beam management 2 may also be one or more of the configuration manners shown in FIG. 11c. In addition, at least one configuration manner in the data transmission 1 and the data transmission 2 is different, and/or the at least one configuration manner has different configuration parameters. In addition/Alternatively, at least one configuration manner in the CSI measurement feedback 1 and the CSI measurement feedback 2 is different, and/or the at least one configuration manner has different configuration parameters. In addition/Alternatively, at least one configuration manner in the power control 1 and the power control 2 is different, and/or the at least one configuration manner has different configuration parameters. In addition/Alternatively, at least one configuration manner in the beam management 1 and the beam management 2 is different, and/or the at least one configuration manner has different configuration parameters.

For example, when the terminal type is the ultra reliable low latency communication URLLC device, a communication mode of the URLLC includes the first communication mode and a second communication mode. A type of a physical layer function parameter of the first communication mode includes the data transmission, and a configuration manner of the data transmission is a configured grant type scheduling manner, a feedback manner in which an acknowledgement/negative acknowledgement ACK/NACK feedback is not required, and a retransmission mechanism of blind retransmission. A type of a physical layer function parameter of the second communication mode includes the data transmission, and the configuration manner of the data transmission is a slot or sub-slot aggregation scheduling manner, a feedback manner of a codeword-level ACK/NACK feedback, and a retransmission mechanism of codeword-level retransmission.

In addition/Alternatively, when the terminal type is the internet of things IoT device, a communication mode of the IoT includes the first communication mode. A type of a physical layer function parameter of the first communication mode includes the data transmission, and a configuration manner of the data transmission is a scheduling manner of dynamic scheduling, a feedback manner in which an acknowledgement/negative acknowledgement ACK/NACK feedback is not required, and a retransmission mechanism of blind retransmission.

In addition/Alternatively, when the terminal type is the customer premise equipment CPE, a communication mode of the CPE includes the first communication mode and a second communication mode. A type of a physical layer function parameter of the first communication mode includes the data transmission and the CSI measurement feedback, a configuration manner of the data transmission is a scheduling manner of dynamic scheduling and a slot or sub-slot aggregation scheduling manner, a feedback manner of a codeword-level ACK/NACK feedback, and a retransmission mechanism of codeword-level retransmission, and a configuration manner of the CSI measurement feedback is a periodic CSI measurement feedback. A type of a physical layer function parameter of the second communication mode includes the data transmission and the CSI measurement feedback, the configuration manner of the data transmission is a scheduling manner of cross-slot scheduling, a feedback manner of a code block group-level ACK/NACK feedback, and a retransmission mechanism of code block group-level retransmission, and the configuration manner of the CSI measurement feedback is the periodic CSI measurement feedback.

Optionally, corresponding identifiers may be configured for different communication modes. An identifier of the communication mode may correspond to one or more of configuration manners of a type of another physical layer function parameter, such as a configuration manner for data transmission, a configuration manner of a CSI measurement feedback, a configuration manner for power control, and a configuration manner for beam management. For example, one configuration identifier may correspond to at least two of a scheduling manner for data transmission, a feedback manner, a retransmission mechanism, a CSI measurement feedback manner, a configuration manner for power control, a configuration manner for beam management, and the like. This can reduce configuration overheads during switching of physical layer functions corresponding to the communication mode.

For example, the communication mode of the terminal type A includes a first communication mode and a second communication mode, the first communication mode includes one or more of the data transmission 1, the CSI measurement feedback 1, the power control 1, and the beam management 1, and the second communication mode includes one or more of the data transmission 2, the CSI measurement feedback 2, the power control 2, and the beam management 2. An identifier of the first communication mode may be determined as ATM1, and an identifier of the second communication mode may be determined as ATM2. When the network device indicates the terminal device A to switch the communication mode, the network device may send an identifier of the communication mode to the terminal device A, to indicate the terminal device A to switch the communication mode. For example, the network device may send ATM1 to the terminal device A, to indicate the terminal device A to perform communication in the first communication mode, or the network device may send ATM2 to the terminal device A, to indicate the terminal device A to perform communication in the second communication mode.

In another example, the communication mode of the terminal type B includes a first communication mode and a second communication mode, the first communication mode includes one or more of the data transmission 1′, the CSI measurement feedback 1′, the power control 1′, and the beam management 1′, and the second communication mode includes one or more of the data transmission 2′, the CSI measurement feedback 2′, the power control 2′, and the beam management 2′. An identifier of the first communication mode may be determined as BTM1, and an identifier of the second communication mode may be determined as BTM2. When the network device indicates the terminal device B to switch the communication mode, the network device may send an identifier of the communication mode to the terminal device B, to indicate the terminal device B to switch the communication mode. For example, the network device may send BTM1 to the terminal device B, to indicate the terminal device B to perform communication in the first communication mode, or the network device may send BTM2 to the terminal device B, to indicate the terminal device B to perform communication in the second communication mode.

Optionally, the communication mode of the terminal device may be a communication mode used when the terminal device performs uplink communication, or may be a communication mode used when the terminal device performs downlink communication. In other words, the communication mode of the terminal device may include an uplink communication mode and/or a downlink communication mode.

For example, the communication mode of the terminal type A includes a first communication mode and a second communication mode. The first communication mode may include one or more of an uplink scheduling manner A1′ and/or a downlink scheduling manner A1*, an uplink feedback manner a1′ and/or a downlink feedback manner a1*, an uplink retransmission mechanism aR1′ and/or a downlink retransmission mechanism aR1*, an uplink CSI measurement feedback AC1′ and/or a downlink CSI measurement feedback AC1*, and uplink beam management AM1′ and/or downlink beam management AM1*. The second communication mode may include one or more of an uplink scheduling manner A2′ and/or a downlink scheduling manner A2*, an uplink feedback manner a2′, and/or a downlink feedback manner a2*, an uplink retransmission mechanism aR2′ and/or a downlink retransmission mechanism aR2*, an uplink CSI measurement feedback AC2′ and/or a downlink CSI measurement feedback AC2*, and uplink beam management AM2′ and/or downlink beam management AM2*. The uplink scheduling manner A1′, the downlink scheduling manner A1*, the uplink scheduling manner A2′, and the downlink scheduling manner A2* may all be one or more of the configuration manners shown in FIG. 6. The uplink feedback manner a1′, the downlink feedback manner a1*, the uplink feedback manner a2′, and the downlink feedback manner a2* may all be one or more of the configuration manners shown in FIG. 7. The uplink retransmission mechanism aR1′, the downlink retransmission mechanism aR1*, the uplink retransmission mechanism aR2′, and the downlink retransmission mechanism aR2* may all be one or more of the configuration manners shown in FIG. 8. The uplink CSI measurement feedback AC1′, the downlink CSI measurement feedback AC1*, the uplink CSI measurement feedback AC2′, and the downlink CSI measurement feedback AC2* may all be one or more of the configuration manners shown in FIG. 9. The uplink beam management AM1′, the downlink beam management AM1*, the uplink beam management AM2′, and the downlink beam management AM2* may all be one or more of the configuration manners shown in FIG. 11c.

In another example, the communication mode of the terminal type B includes a first communication mode and a second communication mode. The first communication mode may include one or more of an uplink scheduling manner BP and/or a downlink scheduling manner B 1*, an uplink feedback manner b 1′ and/or a downlink feedback manner b1*, an uplink retransmission mechanism bR1′ and/or a downlink retransmission mechanism bR1*, an uplink CSI measurement feedback BC1′ and/or a downlink CSI measurement feedback BC1*, and uplink beam management BM1′ and/or downlink beam management BM1*. The second communication mode may include one or more of an uplink scheduling manner B2′ and/or a downlink scheduling manner B2*, an uplink feedback manner b2′ and/or a downlink feedback manner b2*, an uplink retransmission mechanism bR2′ and/or a downlink retransmission mechanism bR2*, an uplink CSI measurement feedback BC2′ and/or a downlink CSI measurement feedback BC2*, and uplink beam management BM2′ and/or downlink beam management BM2*. The uplink scheduling manner B1′, the downlink scheduling manner B1*, the uplink scheduling manner B2′, and the downlink scheduling manner B2* may all be one or more of the configuration manners shown in FIG. 6. The uplink feedback manner b 1′, the downlink feedback manner b1*, the uplink feedback manner b2′, and the downlink feedback manner b2* may all be one or more of the configuration manners shown in FIG. 7. The uplink retransmission mechanisms bR1′, downlink retransmission mechanisms bR1*, the uplink retransmission mechanism bR2′, and the downlink retransmission mechanism bR2* may be one or more of the configuration manners shown in FIG. 8. The uplink CSI measurement feedback BC1′, the downlink CSI measurement feedback BC1*, the uplink CSI measurement feedback BC2′, and the downlink CSI measurement feedback BC2* may all be one or more of the configuration manners shown in FIG. 9. The uplink beam management BM1′, the downlink beam management BM1*, the uplink beam management BM2′, and the downlink beam management BM2* may all be one or more of the configuration manners shown in FIG. 11c.

According to the foregoing embodiment, configuration manners in a communication mode are designed for different terminal types, to better meet communication requirements of different terminal types, and adapt to data transmission of different terminal types. This reduces signaling overheads, reduces communication complexity, reduces chip costs, and improves communication efficiency.

The following embodiment provides a mode switching method. In this method, the terminal device may switch a communication mode based on predetermined duration, to reduce signaling overheads, implement fast switching, reduce a switching delay, save energy of the terminal device, and improve communication efficiency. This embodiment of this application may be an independent embodiment, or may be combined with another embodiment of this application. This is not specifically limited.

For example, based on the method shown in FIG. 3a, in addition to the method in which the network device sends the first identifier to the terminal device, the network device may further send a timer to the terminal device, to indicate the terminal device to switch the communication mode when the timer expires. Therefore, signaling overheads generated when the terminal device switches the communication mode are reduced, a switching delay is reduced, and power consumption of the terminal device is reduced.

In other words, in this embodiment of this application, step 301 may be omitted.

Duration of the timer may be pre-specified in a communication protocol, or may be determined by the network device. The network device may send the timer to the terminal device by using the upper layer signaling. The upper layer signaling may be RRC signaling or MAC signaling. This is not limited.

In a possible design, the network device may send the timer to the terminal device, to indicate the terminal device to switch the communication mode to a default communication mode when the timer expires. The default communication mode may be predefined in a protocol. For example, the first communication mode may also be notified by the network device to the terminal device by using the upper layer signaling or the physical layer signaling. This is not specifically limited in this application.

In another possible design, the network device may send the first identifier and the timer to the terminal device, to indicate the terminal device to switch the communication mode to the first communication mode indicated by the first identifier when the timer expires.

In another possible design, the network device may send identifiers of a plurality of communication modes and timers to the terminal device, to indicate the terminal device to sequentially switch to each communication mode based on the timers.

For example, the network device sends the first identifier, a second identifier, a third identifier, and the timer to the terminal device. The terminal device may switch to the first communication mode corresponding to the first identifier when the timer expires for the first time, switch to the second communication mode corresponding to the second identifier when the timer expires for the second time, and switch to the third communication mode corresponding to the third identifier when the timer expires for the third time.

Optionally, when the terminal device switches the communication mode, a sequence corresponding to the communication mode may be determined by the network device, or may be determined by the terminal device. This is not limited.

Based on the foregoing three possible designs, the terminal device may start the timer after receiving the DCI. If no more DCI is received within duration of the timer, the terminal device may switch the communication mode based on the foregoing two possible designs.

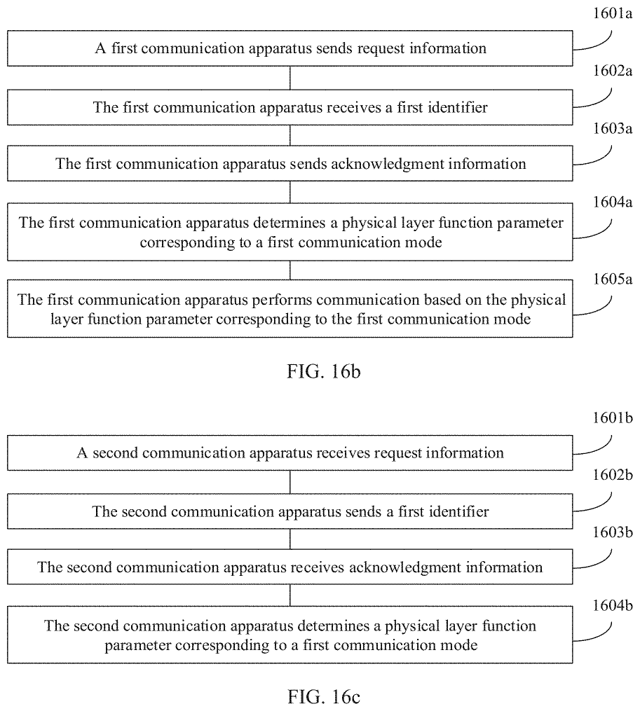

Based on the method shown in FIG. 3a to FIG. 15, as shown in FIG. 16a, before performing step 301, the network device and the terminal device may further perform the following step 301′; and/or after receiving the first identifier, the terminal device may further perform the following step 301*. It should be noted that step 301* may be performed before step 302, or may be performed after step 302, or may be performed simultaneously with step 302. This is not limited.

Step 301′: the terminal device sends request information to the network device. Correspondingly, the network device receives the request information.

The request information is used to request to switch the communication mode.

Specifically, after receiving the request information, the network device may determine, based on the terminal type, the communication mode corresponding to the terminal device, determine the first communication mode for the terminal device from the communication mode corresponding to the terminal device, and send the first identifier corresponding to the first communication mode to the terminal device.

Optionally, the request information may include characteristic information, and the characteristic information indicates the communication mode in the first correspondence.

In a possible design, the characteristic information may be an identifier of the communication mode determined by the terminal device.

Specifically, the terminal device may determine, based on a communication requirement of the terminal device, a communication mode suitable for communication of the terminal device, and send an identifier of the communication mode to the network device. After receiving the identifier of the communication mode sent by the terminal device, the network device determines whether the terminal device can use the communication mode. If the terminal device can use the communication mode, the network device sends the identifier of the communication mode as the first identifier to the terminal device. If the terminal device cannot use the communication mode, the network device may determine, from the communication mode corresponding to the terminal device, the communication mode that the terminal device needs to use, and send the identifier of the communication mode as the first identifier to the terminal device.

In another possible design, the characteristic information indicates a terminal type of the terminal device.

The characteristic information may be the terminal type of the terminal device, or may be related information of a communication requirement of the terminal device, such as a service type, mobility, a transmission delay requirement, a reliability requirement, a coverage requirement, or a communication scenario. The terminal device and/or the network device may determine the terminal type of the terminal device based on the characteristic information.

Specifically, the network device may determine, for the terminal device from communication modes corresponding to the terminal device based on the characteristic information sent by the terminal device, a communication mode that meets a communication requirement of the terminal device, and send the identifier of the communication mode to the terminal device as the first identifier.

In the foregoing design, the terminal device may request information from the network device, and the terminal device may recommend, to the network device based on a communication requirement of the terminal device, a communication mode or a physical layer function parameter corresponding to the communication mode, to better adapt to the communication requirement of the terminal device and improve communication efficiency.

This embodiment of this application may be an independent embodiment, or may be combined with another embodiment of this application. This is not specifically limited in this application.

Optionally, after receiving the first identifier, the terminal device may perform the following step 301*.

301*: the terminal device sends acknowledgment information to the network device. Correspondingly, the network device receives the acknowledgment information.

The acknowledgment information may indicate that the terminal device receives the first identifier.

Optionally, the terminal device receives resource indication information from the network device. The resource indication information indicates a transmission resource used when the terminal device sends the acknowledgment information. The terminal device sends the acknowledgment information to the network device based on the transmission resource.

Optionally, the resource indication information may indicate one or more of a time domain resource, a frequency domain resource, a code resource, or a sequence of the transmission resource. The transmission resource may be a common uplink transmission resource or a terminal device-dedicated uplink transmission resource. The common uplink transmission resource is an uplink transmission resource jointly used by a plurality of terminal devices, and the terminal device-dedicated uplink transmission resource is an uplink transmission resource that can be used only by the terminal device.

The code resource or the sequence may correspond to a device identifier of the terminal device. The device identifier of the terminal device may be referred to as a terminal identifier. The terminal identifier is used to identify the terminal, for example, a radio network temporary identifier (RNTI) or a subscriber identity module (SIM) card identifier. A value range of the terminal identifier may be 0 to 65535. The terminal identifier may be a terminal identifier at an access network layer, or may be a terminal identifier at a core network layer. This is not specifically limited herein.

Optionally, when the terminal device sends the acknowledgment information in the common uplink transmission resource, the terminal device may send the device identifier of the terminal device when sending the acknowledgment information.

Optionally, the network device may include the resource indication information in the DCI, so that after receiving the DCI, the terminal device transmits the acknowledgment information on a time-domain, and/or frequency-domain, and/or codeword transmission resource indicated in the DCI.

In a possible design, the acknowledgment information is uplink control information (UCI).

The UCI may be scheduling request (SR) information, or may be ACK/NACK information.

For example, when the UCI is SR information, it may indicate that the terminal device correctly receives the first identifier. Alternatively, when a value of a data bearer included in the SR information falls within a first interval, it may indicate that the terminal device correctly receives the first identifier. Alternatively, when a value of a data bearer included in the SR information falls outside a first interval, it may indicate that the terminal device does not correctly receive the first identifier.

Specifically, after receiving the first identifier sent by the network device, the terminal device may send the scheduling request to the network device. After receiving the scheduling request, the network device may confirm that the terminal device correctly receives the first identifier.

In another example, after receiving the first identifier sent by the network device, the terminal device may send an ACK to the network device, to indicate that the terminal device correctly receives the first identifier, or send a NACK to the network device, to indicate that the terminal device does not correctly receive the first identifier.

In another example, the terminal device may alternatively send only a NACK. To be specific, the terminal device may feed back a NACK only when the first identifier fails to be received, and does not feed back a NACK when the first identifier is successfully received.

Optionally, the acknowledgment information may be sent together with a data feedback.

For example, a data channel is scheduled by using the DCI. The terminal device may receive data (for example, a PDSCH) carried on the data channel. When the PDSCH is successfully received, the terminal device may feed back an ACK, to indicate that the data is successfully received, and indicate that the first identifier is successfully received. When the PDSCH fails to be received, the terminal device feeds back a NACK, to indicate that the data fails to be received, and indicate that the first identifier fails to be received.

Optionally, the acknowledgment information and the data feedback may alternatively be sent separately.

For example, a data channel is scheduled by using the DCI. The terminal device may receive data (for example, a PDSCH) carried on the data channel. When the PDSCH is successfully received, the terminal device feeds back an ACK, to indicate that the data is successfully received. For the first identifier, the terminal device may send an ACK, to indicate that the first identifier is successfully received. When the PDSCH fails to be received, the terminal device feeds back a NACK, to indicate that the data fails to be received. For the first identifier, the terminal device may send an ACK, to indicate that the first identifier is successfully received. Alternatively, the terminal device may send two pieces of ACK/NACK information, where one piece of ACK/NACK information indicates acknowledgment of the first identifier, and the other piece of ACK/NACK information indicates acknowledgment of the data. A sending sequence of the two pieces of ACK/NACK information is not limited, and may be pre-specified in a communication protocol, or may be preconfigured by the network device.

In another possible design, the acknowledgment information is upper layer signaling.

Specifically, after receiving the DCI carrying the first identifier or the upper layer signaling, the terminal device may send the upper layer signaling, for example, RRC signaling or MAC signaling, to notify the network device that the first identifier is successfully received.

It should be noted that the foregoing two possible designs may be acknowledgment manners used when the terminal device completes uplink synchronization or the terminal device determines a TA.

In another possible design, the acknowledgment information is an uplink sequence or an uplink signal.

Specifically, after receiving the DCI carrying the first identifier or the upper layer signaling, the terminal device may send the uplink sequence, for example, a random access preamble sequence, a sounding reference signal (SRS), or another uplink signal.

It should be noted that the possible design may be an acknowledgment manner used when the terminal device does not perform uplink synchronization, or the terminal device does not determine a TA.

The terminal device may roughly estimate a TA value of the terminal device based on positioning or a time-based path through empirical learning or machine learning, and send an uplink sequence or an uplink signal based on the TA value, to avoid sending a PRACH for a long time. In this case, the uplink sequence or the uplink signal sent by the terminal device may have a long cyclic prefix (CP) length, and the network device may determine the TA by receiving the uplink sequence or the uplink signal, and notify the terminal device of the TA.

Alternatively, based on the method shown in FIG. 3a to FIG. 16a, as shown in FIG. 16b, the communication method provided in this embodiment of this application may be described from a perspective of the first communication apparatus.

FIG. 16b is a flowchart of a communication method according to an embodiment of this application. As shown in FIG. 16b, the method may include the following steps.

Step 1601a: the first communication apparatus sends the request information.

Specifically, for specific descriptions in which the first communication apparatus sends the request information, refer to the specific descriptions in which the terminal device sends the request information in step 301′. This is not limited.

It should be noted that this step may be omitted.

Step 1602a: the first communication apparatus receives the first identifier.

Specifically, for specific descriptions in which the first communication apparatus receives the first identifier, refer to the related descriptions in which the terminal device receives the first identifier in step 301. Details are not described again.

Step 1603a: the first communication apparatus sends the acknowledgment information.

For a specific operation, refer to 301*. Details are not described herein again. This step can be omitted.

Specifically, for specific descriptions in which the first communication apparatus sends the acknowledgment information, refer to the related descriptions in which the terminal device sends the acknowledgment information in step 301*. Details are not described again.

It should be noted that this step may be omitted.

Step 1604a: the first communication apparatus determines the physical layer function parameter corresponding to the first communication mode.

Specifically, for specific descriptions in which the first communication apparatus determines the physical layer function parameter corresponding to the first communication mode, refer to the related descriptions in which the terminal device determines the physical layer function parameter corresponding to the first communication mode in step 302. Details are not described again.

Step 1605a: the first communication apparatus performs communication based on the physical layer function parameter corresponding to the first communication mode.

Specifically, for specific descriptions in which the first communication apparatus performs communication based on the physical layer function parameter corresponding to the first communication mode, refer to the related descriptions in which the terminal device performs communication based on the physical layer function parameter corresponding to the first communication mode in step 303. Details are not described again.

Alternatively, based on the method shown in FIG. 3a to FIG. 16b, as shown in FIG. 16c, the communication method provided in this embodiment of this application may be described from a perspective of the second communication apparatus.

FIG. 16c is a flowchart of a communication method according to an embodiment of this application. As shown in FIG. 16c, the method may include the following steps.

Step 1601b: the second communication apparatus receives the request information.

Specifically, for specific descriptions in which the second communication apparatus receives the request information, refer to the related descriptions in which the network device receives the request information in step 301′. Details are not described again.

It should be noted that this step may be omitted.

Step 1602b: the second communication apparatus sends the first identifier.

Specifically, for specific descriptions in which the second communication apparatus sends the first identifier, refer to the related descriptions in which the network device receives the first identifier in step 301. Details are not described again.

Step 1603b: the second communication apparatus receives the acknowledgment information.

Specifically, for specific descriptions in which the second communication apparatus receives the acknowledgment information, refer to the related descriptions in which the network device receives the acknowledgment information in step 301*. Details are not described again.

It should be noted that this step may be omitted.

Step 1604b: the second communication apparatus determines the physical layer function parameter corresponding to the first communication mode.

Specifically, for specific descriptions in which the second communication apparatus determines the physical layer function parameter corresponding to the first communication mode, refer to the related descriptions in which the network device determines the physical layer function parameter corresponding to the first communication mode in step 302. Details are not described again.

It should be noted that an execution sequence of step 1602b and step 1604b is not limited. Step 1602b may be performed before step 1604b, or step 1604b may be performed before step 1602b, or step 1602b and step 1604b may be performed simultaneously.

This embodiment of this application may be an independent embodiment, or may be combined with another embodiment of this application. This is not specifically limited in this application.

According to the foregoing design, the network device sends the identifier of the communication mode to the terminal device, and the terminal device can quickly update the mode configuration parameter after receiving the information. Further, the terminal device may send the acknowledgment information, that is, notify the network device that the terminal device correctly receives the information, so that the network device and the terminal device have a consistent understanding of the communication mode, to enhance reliability, and improve communication robustness.

Based on the methods described in FIG. 3a to FIG. 16a, the network device sends the identifier of the communication mode to the terminal device, so that the terminal device can determine, based on the first correspondence, the communication mode corresponding to the identifier sent by the network device, and perform communication based on the physical layer function parameter corresponding to the communication mode. Therefore, the network device is prevented from sending RRC signaling including the physical layer function parameter to the terminal device. This reduces RRC signaling overheads, reduces a physical layer function switching delay corresponding to the terminal device, reduces power consumption of the terminal device, and reduces communication complexity. In addition, the corresponding communication mode is determined for the terminal device based on the terminal type, so that communication requirements of different terminal devices can be met, RRC signaling overheads can be reduced, chip complexity can be reduced, production costs can be reduced, and communication complexity can be reduced.

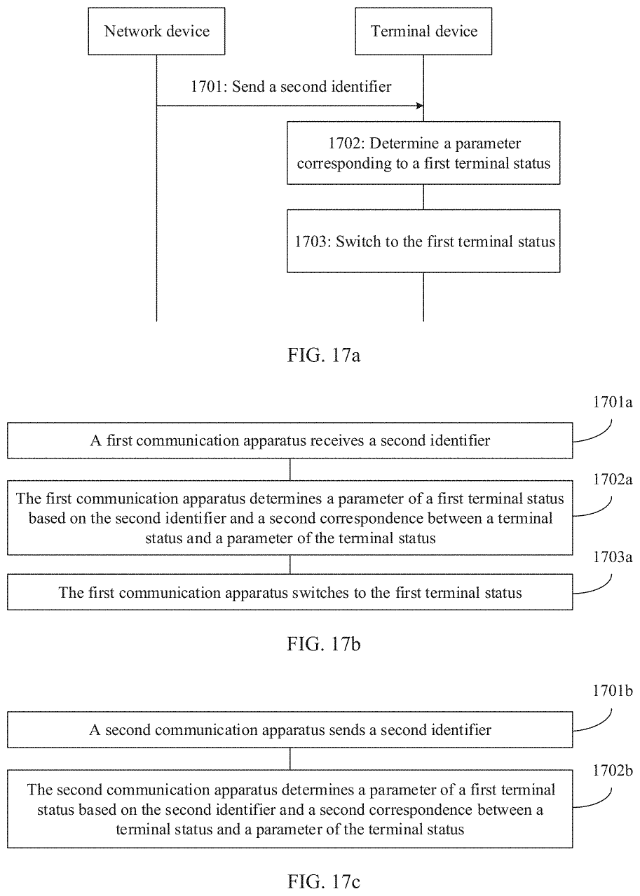

Optionally, when the terminal device switches between the idle mode, the inactive mode, and the connected mode based on the RRC signaling, RRC signaling overheads are high, and a switching delay is high; consequently, when the terminal device performs state switching, the terminal device needs to maintain a high power consumption state, resulting in high power consumption of the terminal device. To resolve the foregoing technical problems, an embodiment of this application further provides a communication method. This application may be an independent embodiment, or may be combined with another embodiment. This is not specifically limited in this application. As shown in FIG. 17a, the communication method may include the following steps.

Step 1701: a network device sends a second identifier to a terminal device. Correspondingly, the terminal device receives the second identifier.

The second identifier indicates a first terminal status of the terminal device.

Optionally, the network device may send physical layer signaling including the second identifier to the terminal device, or may send upper layer signaling including the second identifier to the terminal device. The physical layer signaling may be DCI, a data channel, or the like. The upper layer signaling may be RRC signaling, MAC signaling, or the like. This is not limited.

Optionally, the first terminal status is a data transmission state or a non-data transmission state, or the first terminal status is an enhanced state or a non-enhanced state. The non-enhanced state may also be referred to as a default state.

Specifically, when the terminal device does not transmit data, the network device may indicate that the terminal device is in the non-data transmission state. When the terminal device transmits data, the network device may indicate that the terminal device is in the data transmission state.

For example, the enhanced state may be a large-packet transmission state, and the non-enhanced state may be a small-packet transmission state. Alternatively, the enhanced state may be a high-rate transmission state, and the non-enhanced state may be a low-rate transmission state. Alternatively, the enhanced state may be a high power consumption state, and the non-enhanced state may be a low power consumption state. Alternatively, the enhanced state may be a high transmission delay state, and the non-enhanced state may be a low transmission delay state.

Optionally, the terminal device and/or the network device may determine a terminal status based on a terminal type.

Optionally, there is a correspondence between the terminal type and the terminal status. The correspondence may be predefined in a protocol, or may be notified by the network device or the core network to a terminal by using upper layer signaling (for example, RRC signaling or MAC signaling) or physical layer signaling.

For example, when the terminal type is IoT, a terminal status corresponding to the IoT may be the data transmission state or the non-data transmission state. When the terminal type is eMBB, a terminal status corresponding to the eMBB may be the enhanced state or the non-enhanced state. When the terminal type is URLLC, a terminal status corresponding to the URLLC may be the enhanced state or the non-enhanced state.

Optionally, the network device may determine at least one terminal status for the terminal device based on the terminal type of the terminal device. The terminal status corresponding to the terminal device may include the first terminal status.

Each terminal status may have a respective function or an operation that needs to be performed. The function or operation may be at least one of a function in an idle mode, a function in an inactive mode, and a function in a connected mode that are included in the conventional technology.

Optionally, the terminal status may also be referred to as a terminal mode. This is not specifically limited in this application.

For example, for an IoT terminal, a terminal status 1 may be an idle mode, and a terminal status 2 may be an INACTIVE mode or a CONNECTED mode.

For example, for an eMBB terminal, a terminal status 1 may be an INACTIVE mode, and a terminal status 2 may be a CONNECTED mode.

For example, for a URLLC terminal, a terminal status 1 may be a CONNECTED mode, and a terminal status 2 may be a CONNECTED mode.

Further, the network device may further send a second correspondence between each terminal status and a parameter of the terminal status to the terminal device, so that the terminal device determines, based on the terminal status, the parameter corresponding to the terminal status.

The network device may send the second correspondence to the terminal device by using the upper layer signaling or the physical layer signaling. The upper layer signaling may be RRC signaling, MAC signaling, or the like. This is not limited.

Alternatively, the terminal status corresponding to the terminal type of the terminal device and the second correspondence between a terminal status and a terminal status parameter may be pre-specified in a communication protocol. The terminal status corresponding to the terminal type of the terminal device may include the first terminal status.

Terminal devices belonging to a same terminal type may correspond to a same terminal status. The terminal status corresponding to the terminal type of the terminal device may also be described as a terminal status corresponding to the terminal device, or may be described as a terminal status corresponding to the terminal type.

Specifically, the network device may determine the first terminal status for the terminal device from the terminal statuses corresponding to the terminal device, and send the second identifier corresponding to the first terminal status to the terminal device, so that the terminal device determines the first terminal status based on the second identifier, and adjusts the terminal status of the terminal device to the first terminal status. Therefore, the network device is prevented from controlling, by using RRC signaling, the terminal device to perform status switching. This reduces RRC signaling overheads, reduces a switching delay of the terminal status corresponding to the terminal device, and further reduces power consumption of the terminal device.

Step 1702: the terminal device determines a parameter of the first terminal status based on the second identifier and the second correspondence between a terminal status and a parameter of the terminal status.

The terminal status in the second correspondence includes the first terminal status.

Optionally, the terminal device may receive the second correspondence from the network device, and determine, based on the second correspondence and the second identifier, the parameter corresponding to the first terminal status.

The parameter of the terminal status may be a physical layer function parameter, or may be an upper layer function parameter, or the like. This is not specifically limited in this application.

Optionally, different terminal statuses may correspond to different physical layer function parameters, and/or different terminal statuses may correspond to different communication modes.

Optionally, a method for designing a physical layer function parameter in this application may be applied to the first terminal status, or may be applied to a second terminal status.

For example, the first terminal status corresponds to a first communication mode and a second communication mode, and/or the second terminal status corresponds to a third communication mode and a fourth communication mode.

Optionally, the network device and/or the terminal device may determine the communication mode based on the terminal type and the terminal status. There may be correspondences between the terminal type and the communication mode and between the terminal status and the communication mode. The correspondence may be predefined in a protocol, or may be notified by the network device to the terminal device by using upper layer signaling or physical layer signaling. This is not specifically limited in this application.

Optionally, the network device may indicate the communication mode in at least one of the following two manners.

Manner 1: indicate identifiers of the communication modes in a plurality of terminal statuses.

For example, the first terminal status corresponds to two communication modes, and the second terminal status corresponds to two communication modes. In this case, the identifier of the communication mode may be 0, 1, 2, or 3, and may be indicated by using two bits.

In this manner, the terminal status and the communication mode can be switched simultaneously to reduce a switching delay.

Manner 2: indicate an identifier of the communication mode corresponding to the terminal status of the terminal device.

For example, the first terminal status corresponds to two communication modes, and the second terminal status corresponds to two communication modes. In this case, when the terminal device is in the first terminal status, the identifier of the communication mode may be 0 or 1, that is, may be indicated by using one bit. When the terminal device is in the second terminal status, the identifier of the communication mode may also be 0 or 1, that is, may be indicated by using one bit.

In this manner, the terminal status and the communication mode can be switched simultaneously, to reduce indication overheads. Alternatively, when the communication protocol pre-specifies the terminal status corresponding to the terminal type and the second correspondence between a terminal status and a parameter of the terminal status, the terminal device may determine the parameter corresponding to the first terminal status based on the second correspondence specified in the communication protocol and the second identifier sent by the network device.

Step 1703: the terminal device switches to the first terminal status.

Based on the method described in FIG. 17a, the network device sends the second identifier to the terminal device, so that the terminal device can complete terminal status switching based on the second identifier. This avoids switching by using RRC signaling, reduces RRC signaling overheads, reduces a terminal status switching delay corresponding to the terminal device, reduces power consumption of the terminal device, and reduces communication complexity. In addition, the corresponding terminal status is determined for the terminal device based on the terminal type, so that communication requirements of different terminal devices can be met, RRC signaling overheads can be reduced, chip complexity can be reduced, production costs can be reduced, and communication complexity can be reduced.

Alternatively, based on the method shown in FIG. 17a, as shown in FIG. 17b, the communication method provided in this embodiment of this application may be described from a perspective of the first communication apparatus.

FIG. 17b is a flowchart of a communication method according to an embodiment of this application. As shown in FIG. 17b, the method may include the following steps.

Step 1701a: the first communication apparatus receives the second identifier.

Specifically, for specific descriptions in which the first communication apparatus receives the second identifier, refer to the specific descriptions in which the terminal device receives the second identifier in step 1701. Details are not described again.

Step 1702a: the first communication apparatus determines the parameter of the first terminal status based on the second identifier and the second correspondence between a terminal status and a parameter of the terminal status.

Specifically, for specific descriptions in which the first communication apparatus determines the parameter of the first terminal status, refer to the specific descriptions in which the terminal device determines the parameter of the first terminal status in step 1702. Details are not described again.

It should be noted that this step may be omitted.

Step 1703a: the first communication apparatus switches to the first terminal status.

Specifically, for specific descriptions in which the first communication apparatus switches to the first terminal status, refer to the specific descriptions in which the terminal device switches to the first terminal status in step 1703. Details are not described again.

Alternatively, based on the method shown in FIG. 17a and FIG. 17b, as shown in FIG. 17c, the communication method provided in this embodiment of this application may be described from a perspective of a second communication apparatus.

FIG. 17c is a flowchart of a communication method according to an embodiment of this application. As shown in FIG. 17c, the method may include the following steps.

1701b: the second communication apparatus sends the second identifier.

Specifically, for specific descriptions in which the second communication apparatus sends the second identifier, refer to the related descriptions in which the network device receives the second identifier in step 1701. Details are not described again.

1702b: the second communication apparatus determines the parameter of the first terminal status based on the second identifier and the second correspondence between a terminal status and a parameter of the terminal status.

Specifically, for specific descriptions in which the second communication apparatus determines the parameter of the first terminal status, refer to the related descriptions in which the network device determines the parameter of the first terminal status in step 1702. Details are not described again.

It should be noted that an execution sequence of step 1701b and step 1702b is not limited. Step 1702b may be performed before step 1701b, or step 1701b may be performed before step 1702b, or step 1701b and step 1702b may be performed simultaneously.

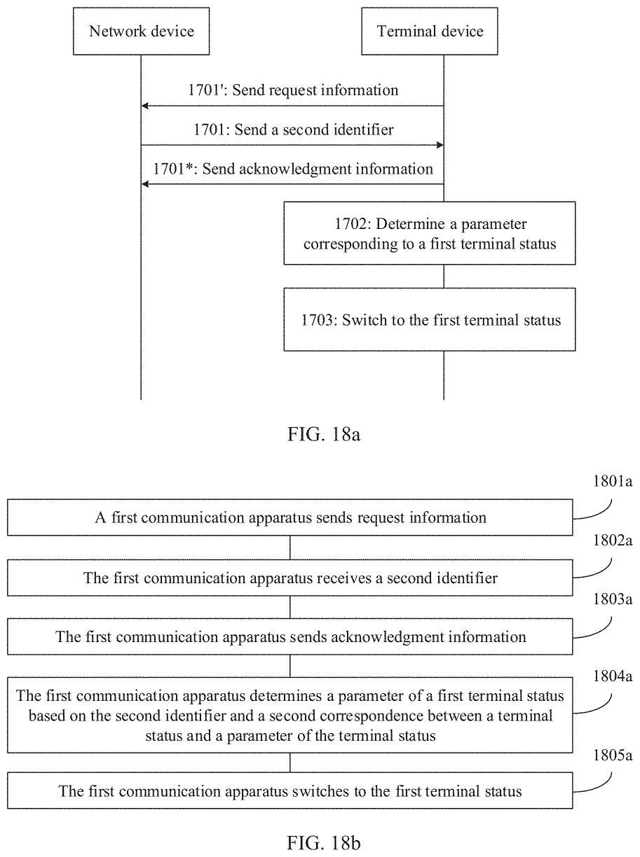

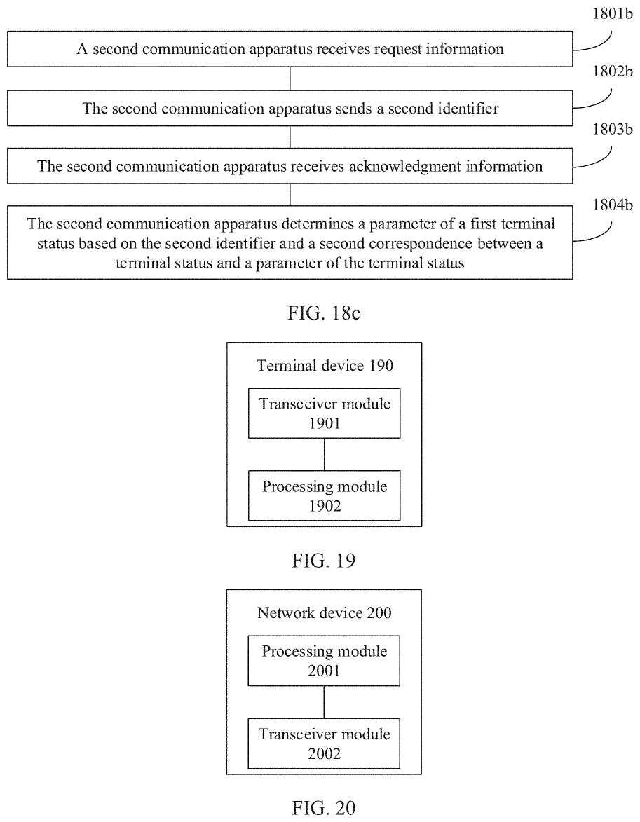

This embodiment of this application may be an independent embodiment, or may be combined with another embodiment of this application. This is not specifically limited in this application. Based on the method shown in FIG. 17a, as shown in FIG. 18a, before performing step 1701, the network device and the terminal device may further perform the following step 1701′; and/or after receiving the second identifier, the terminal device may further perform the following step 1701*. It should be noted that step 1701* may be performed before step 1702, or may be performed after step 1702, or may be performed simultaneously with step 1702. This is not limited.

Step 1701′: the terminal device sends request information to the network device. Correspondingly, the network device receives the request information.

The request information is used to request to switch the terminal status.

Similarly, for specific descriptions in which the terminal device sends the request information used to request to switch the terminal status to the network device, refer to the related descriptions in which the terminal device sends the request information used to request to switch the communication mode to the network device in step 301′. Details are not described again.

Optionally, after receiving the second identifier, the terminal device may perform the following step 1701*.

1701*: the terminal device sends acknowledgment information to the network device. Correspondingly, the network device sends the acknowledgment information.

The acknowledgment information may indicate that the terminal device receives the second identifier.

Similarly, for specific descriptions in which the terminal device sends, to the network device, the acknowledgment information indicating that the terminal device receives the second identifier, refer to the related descriptions in which the terminal device sends, to the network device, the acknowledgment information indicating that the terminal device receives the first identifier in step 301*. Details are not described again.

Based on the method shown in FIG. 18a, the terminal device sends the request information and the acknowledgment information to the network device, so that the terminal device and the network device can achieve an agreement on the terminal status of the terminal device, to improve reliability of a communication system.

Alternatively, based on the method shown in FIG. 17a to FIG. 18a, as shown in FIG. 18b, the communication method provided in this embodiment of this application may be described from a perspective of the first communication apparatus.

FIG. 18b is a flowchart of a communication method according to an embodiment of this application. As shown in FIG. 18b, the method may include the following steps.

Step 1801a: The first communication apparatus sends the request information.

Specifically, for specific descriptions in which the first communication apparatus sends the request information, refer to the specific descriptions in which the terminal device sends the request information in step 1701′. Details are not described again.

It should be noted that this step may be omitted.

Step 1802a: The first communication apparatus receives the second identifier.

Specifically, for specific descriptions in which the first communication apparatus receives the second identifier, refer to the specific descriptions in which the terminal device receives the second identifier in step 1701. Details are not described again.

Step 1803a: The first communication apparatus sends the acknowledgment information.

Specifically, for specific descriptions in which the first communication apparatus sends the acknowledgment information, refer to the specific descriptions in which the terminal device sends the acknowledgment information in step 1701*. Details are not described again.

It should be noted that this step may be omitted.

Step 1804a: The first communication apparatus determines the parameter of the first terminal status based on the second identifier and the second correspondence between a terminal status and a parameter of the terminal status.

Specifically, for specific descriptions in which the first communication apparatus determines the parameter of the first terminal status, refer to the specific descriptions in which the terminal device determines the parameter of the first terminal status in step 1702. Details are not described again.

It should be noted that this step may be omitted.

Step 1805a: The first communication apparatus switches to the first terminal status.

Specifically, for specific descriptions in which the first communication apparatus switches to the first terminal status, refer to the specific descriptions in which the terminal device switches to the first terminal status in step 1703. Details are not described again.

Alternatively, based on the method shown in FIG. 18a and FIG. 18b, as shown in FIG. 18c, the communication method provided in this embodiment of this application may be described from a perspective of the second communication apparatus.

FIG. 18c is a flowchart of a communication method according to an embodiment of this application. As shown in FIG. 18c, the method may include the following steps.

Step 1801b: The second communication apparatus receives the request information.

Specifically, for specific descriptions in which the second communication apparatus receives the request information, refer to the related descriptions in which the network device receives the request information in step 1701′. Details are not described again.

It should be noted that this step may be omitted.

Step 1802b: The second communication apparatus sends the second identifier.

Specifically, for specific descriptions in which the second communication apparatus sends the second identifier, refer to the related descriptions in which the network device sends the second identifier in step 1701. Details are not described again.

Step 1803b: The second communication apparatus receives the acknowledgment information.

Specifically, for specific descriptions in which the second communication apparatus receives the acknowledgment information, refer to the related descriptions in which the network device receives the acknowledgment information in step 1701*. Details are not described again.

It should be noted that this step may be omitted.

Step 1804b: The second communication apparatus determines the parameter of the first terminal status based on the second identifier and the second correspondence between a terminal status and a parameter of the terminal status.

Specifically, for specific descriptions in which the second communication apparatus determines the parameter of the first terminal status, refer to the related descriptions in which the network device determines the parameter of the first terminal status in step 1802. Details are not described again.

It should be noted that an execution sequence of step 1802b and step 1804b is not limited. Step 1802b may be performed before step 1804b, or step 1804b may be performed before step 1802b, or step 1802b and step 1804b may be performed simultaneously.

This embodiment of this application may be an independent embodiment, or may be combined with another embodiment of this application. This is not specifically limited in this application.

Optionally, the uplink and the downlink in this application are merely examples of communication links, and are also applicable to other communication link types such as a sidelink, a backhaul link, an access link, a relay link, and a full-duplex link. This is not specifically limited in this embodiment of this application.

The foregoing mainly describes the solutions provided in embodiments of this application from a perspective of interaction between the devices. It may be understood that to implement the foregoing functions, the devices include hardware structures and/or software modules corresponding to the functions. A person of ordinary skill in the art should easily be aware that, in combination with algorithms and steps in the examples described in embodiments disclosed in this specification, this application can be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In embodiments of this application, functional modules of each device may be obtained through division according to the foregoing method example. For example, the functional modules may be obtained through division corresponding to various functions, or two or more functions may be integrated into one processing module. The integrated module may be implemented in a form of hardware, or may be implemented in a form of a software function module. It should be noted that, in embodiments of this application, module division is an example, and is merely logical function division. In an actual implementation, another division manner may be used.

When each function module is obtained through division based on each corresponding function, FIG. 19 shows a terminal device. A terminal device 190 may include a transceiver module 1901 and a processing module 1902. For example, the terminal device 190 may be a terminal device, or may be a chip used in a terminal device or another combined component or part that has a function of the terminal device. When the terminal device 190 is the terminal device, the transceiver module 1901 may be a transceiver, where the transceiver may include an antenna, a radio frequency circuit, and the like. The processing module 1902 may be a processor (or a processing circuit), for example, a baseband processor, where the baseband processor may include one or more CPUs. When the terminal device 190 is the component that has the function of the terminal device, the transceiver module 1901 may be a radio frequency unit, and the processing module 1902 may be a processor (or a processing circuit), for example, a baseband processor. When the terminal device 190 is a chip system, the transceiver module 1901 may be an input/output interface of a chip (for example, a baseband chip), and the processing module 1902 may be a processor (or a processing circuit) of the chip system, and may include one or more central processing units. It should be understood that the transceiver module 1901 in this embodiment of this application may be implemented by a transceiver or a transceiver-related circuit component, and the processing module 1902 may be implemented by a processor or a processor-related circuit component (or referred to as a processing circuit).

For example, the transceiver module 1901 may be configured to perform all sending and receiving operations performed by the terminal device in the embodiments shown in FIG. 3a to FIG. 18c, and/or configured to support another process of the technology described in this specification. The processing module 1902 may be configured to perform all operations except the receiving and sending operations performed by the terminal device in the embodiments shown in FIG. 3a to FIG. 18c, and/or configured to support another process of the technology described in this specification.

The transceiver module 1901 is configured to receive a first identifier indicating a first communication mode of the terminal device from a network device. The first communication mode corresponds to a physical layer function parameter used by the terminal device for communication. The processing module 1902 is configured to determine, based on the first identifier and a first correspondence between a communication mode and a physical layer function parameter, the physical layer function parameter corresponding to the first communication mode. The communication mode in the first correspondence includes the first communication mode. The processing module 1902 is further configured to perform communication based on the physical layer function parameter corresponding to the first communication mode.

In a possible design, the communication mode corresponds to one or more of the following types of physical layer function parameters: data transmission, a channel state information CSI measurement feedback, initial access, mobility, power control, and beam management.

In a possible design, when a terminal type is an ultra reliable low latency communication URLLC device, the type of the physical layer function parameter corresponding to the communication mode includes the data transmission, the mobility, and the beam management. In addition/Alternatively, when a terminal type is an internet of things device IoT, the type of the physical layer function parameter corresponding to the communication mode includes the data transmission. In addition/Alternatively, when a terminal type is customer premise equipment CPE, the type of the physical layer function parameter corresponding to the communication mode includes the data transmission and the CSI measurement feedback.

In a possible design, the transceiver module 1901 is further configured to receive the first correspondence between a communication mode and a physical layer function parameter from the network device. The communication mode in the first correspondence is determined based on a terminal type of the terminal device.

In a possible design, before receiving the first identifier from the network device, the transceiver module 1901 is further configured to send request information to the network device. The request information is used to request to switch the communication mode.

In a possible design, the request information includes characteristic information. The characteristic information indicates the communication mode in the first correspondence.

In a possible design, the physical layer function parameter includes a first parameter field. The first parameter field indicates a configuration manner of the physical layer function parameter. The configuration manner includes a second parameter field. The second parameter field includes a configuration parameter of the configuration manner.

In a possible design, when the terminal type is the ultra reliable low latency communication URLLC device, a communication mode of the URLLC includes the first communication mode and a second communication mode. A type of a physical layer function parameter of the first communication mode includes the data transmission, and a configuration manner of the data transmission is a configured grant type scheduling manner, a feedback manner in which an acknowledgement/negative acknowledgement ACK/NACK feedback is not required, and a retransmission mechanism of blind retransmission. A type of a physical layer function parameter of the second communication mode includes the data transmission, and the configuration manner of the data transmission is a slot or sub-slot aggregation scheduling manner, a feedback manner of a codeword-level ACK/NACK feedback, and a retransmission mechanism of codeword-level retransmission. In addition/Alternatively, when the terminal type is the internet of things IoT device, a communication mode of the IoT includes the first communication mode. A type of a physical layer function parameter of the first communication mode includes the data transmission, and a configuration manner of the data transmission is a scheduling manner of dynamic scheduling, a feedback manner in which an acknowledgement/negative acknowledgement ACK/NACK feedback is not required, and a retransmission mechanism of blind retransmission. In addition/Alternatively, when the terminal type is the customer premise equipment CPE, a communication mode of the CPE includes the first communication mode and a second communication mode. A type of a physical layer function parameter of the first communication mode includes the data transmission and the CSI measurement feedback, a configuration manner of the data transmission is a scheduling manner of dynamic scheduling and a slot or sub-slot aggregation scheduling manner, a feedback manner of a codeword-level ACK/NACK feedback, and a retransmission mechanism of codeword-level retransmission, and a configuration manner of the CSI measurement feedback is a periodic CSI measurement feedback. A type of a physical layer function parameter of the second communication mode includes the data transmission and the CSI measurement feedback, the configuration manner of the data transmission is a scheduling manner of cross-slot scheduling, a feedback manner of a code block group-level ACK/NACK feedback, and a retransmission mechanism of code block group-level retransmission, and the configuration manner of the CSI measurement feedback is the periodic CSI measurement feedback.

In a possible design, the communication mode in the first correspondence is an uplink communication mode or a downlink communication mode.

In a possible design, the transceiver module 1901 is further configured to receive a timer from the network device. The timer is used by the terminal device to switch the communication mode when the timer expires.

In a possible design, the transceiver module 1901 is further configured to send acknowledgment information to the network device. The acknowledgment information indicates that the terminal device receives the first identifier.

In a possible design, the transceiver module 1901 is further configured to receive resource indication information from the network device. The resource indication information indicates a transmission resource used when the terminal device sends the acknowledgment information. The transceiver module 1901 is further configured to send the acknowledgment information to the network device based on the transmission resource.

In another possible implementation, the transceiver module 1901 and the processing module 1902 in the terminal device 190 shown in FIG. 19 may be further configured to:

The transceiver module 1901 is configured to receive a second identifier from a network device. The second identifier indicates a first terminal status of the terminal device. The first terminal status is a data transmission state or a non-data transmission state, or the first terminal status is an enhanced state or a non-enhanced state. The processing module 1902 is configured to determine a parameter of the first terminal status based on the second identifier and a second correspondence between a terminal status and a parameter of the terminal status. The terminal status in the second correspondence includes the first terminal status. The processing module is further configured to switch to the first terminal status.

In a possible design, the transceiver module 1901 is further configured to receive the second correspondence between a terminal status and a parameter of the terminal status from the network device. The terminal status in the second correspondence is determined based on a terminal type of the terminal device.

In a possible design, the enhanced state is a large-packet transmission state, and the non-enhanced state is a small-packet transmission state. Alternatively, the enhanced state is a high-rate transmission state, and the non-enhanced state is a low-rate transmission state. Alternatively, the enhanced state is a high power consumption state, and the non-enhanced state is a low power consumption state. Alternatively, the enhanced state is a high transmission delay state, and the non-enhanced state is a low transmission delay state.

In still another possible implementation, the transceiver module 1901 in FIG. 19 may be replaced with a transceiver, functions of the transceiver module 1901 may be integrated into the transceiver, the processing module 1902 may be replaced with a processor, and functions of the processing module 1902 may be integrated into the processor. Further, the terminal device 190 shown in FIG. 19 may further include a memory. When the transceiver module 1901 is replaced with a transceiver and the processing module 1902 is replaced with a processor, the terminal device 190 in this embodiment of this application may be the communication apparatus shown in FIG. 2.

When each function module is obtained through division based on each corresponding function, FIG. 20 shows a network device. A network device 200 may include a processing module 2001 and a transceiver module 2002. For example, the network device 200 may be a network device, or may be a chip used in a network device or another combined component or part that has a function of the network device. When the network device 200 is the network device, the transceiver module 2002 may be a transceiver, where the transceiver may include an antenna, a radio frequency circuit, and the like. The processing module 2001 may be a processor (or a processing circuit), for example, a baseband processor, where the baseband processor may include one or more CPUs. When the network device 200 is the component that has the function of the network device, the transceiver module 2002 may be a radio frequency unit, and the processing module 2001 may be a processor (or a processing circuit), for example, a baseband processor. When the network device 200 is a chip system, the transceiver module 2002 may be an input/output interface of a chip (for example, a baseband chip), and the processing module 2001 may be a processor (or a processing circuit) of the chip system, and may include one or more central processing units. It should be understood that the transceiver module 2002 in this embodiment of this application may be implemented by a transceiver or a transceiver-related circuit component, and the processing module 2001 may be implemented by a processor or a processor-related circuit component (or referred to as a processing circuit).

For example, the processing module 2001 may be configured to perform all operations except the receiving and sending operations performed by the network device in the embodiments shown in FIG. 3a to FIG. 18c, and/or configured to support another process of the technology described in this specification. The transceiver module 2002 may be configured to perform all sending and receiving operations performed by the network device in the embodiments shown in FIG. 3a to FIG. 18c, and/or configured to support another process of the technology described in this specification.

The processing module 2001 is configured to determine a first identifier. The first identifier indicates a first communication mode of a terminal device. The first communication mode corresponds to a physical layer function parameter used by the terminal device for communication. The transceiver module 2002 is configured to send the first identifier to the terminal device.

In a possible design, the communication mode corresponds to one or more of the following types of physical layer function parameters: data transmission, a channel state information CSI measurement feedback, initial access, mobility, power control, and beam management.

In a possible design, the processing module 2001 is further configured to determine, based on a terminal type of the terminal device, a first correspondence that is between a communication mode and a physical layer function parameter and that corresponds to the terminal device. The transceiver module 2002 is further configured to send, to the terminal device, the first correspondence that is between a communication mode and a physical layer function parameter and that corresponds to the terminal device.

In a possible design, the processing module 2001 is further configured to determine the terminal type of the terminal device based on one or more of the following: a service type, mobility, a transmission delay requirement, a channel environment, a reliability requirement, a coverage requirement, and a communication scenario that correspond to the terminal device.

In a possible design, before sending the first identifier to the terminal device, the transceiver module 2002 is further configured to receive request information from the terminal device. The request information is used to request to switch the communication mode.

In a possible design, the request information further includes characteristic information. The characteristic information indicates the communication mode in the first correspondence.

In a possible design, the physical layer function parameter includes a first parameter field. The first parameter field indicates a configuration manner of the physical layer function parameter. The configuration manner includes a second parameter field. The second parameter field includes a configuration parameter of the configuration manner.

In a possible design, the transceiver module 2002 is further configured to send a timer to the terminal device. The timer is used by the terminal device to switch the communication mode when the timer expires.

In a possible design, the transceiver module 2002 is further configured to receive acknowledgment information from the terminal device. The acknowledgment information indicates that the terminal device receives the first identifier.

In a possible design, the transceiver module 2002 is further configured to send resource indication information to the terminal device. The resource indication information indicates a transmission resource used when the terminal device sends the acknowledgment information.

In another possible implementation, the processing module 2001 and the transceiver module 2002 in the network device 200 shown in FIG. 20 may be further configured to:

The processing module 2001 is configured to determine a second identifier. The second identifier indicates a first terminal status of a terminal device. The first terminal status is a data transmission state or a non-data transmission state, or the first terminal status is an enhanced state or a non-enhanced state. The transceiver module 2002 is configured to send the second identifier to the terminal device.

In a possible design, the processing module 2001 is further configured to determine, based on a terminal type of the terminal device, a second correspondence that is between a terminal status and a parameter of the terminal status and that corresponds to the terminal device. The transceiver module 2002 is further configured to send, to the terminal device, the second correspondence that is between a terminal status and a parameter of the terminal status and that corresponds to the terminal device.

In a possible design, the enhanced state is a large-packet transmission state, and the non-enhanced state is a small-packet transmission state. Alternatively, the enhanced state is a high-rate transmission state, and the non-enhanced state is a low-rate transmission state. Alternatively, the enhanced state is a high power consumption state, and the non-enhanced state is a low power consumption state. Alternatively, the enhanced state is a high transmission delay state, and the non-enhanced state is a low transmission delay state.

In still another possible implementation, the transceiver module 2002 in FIG. 20 may be replaced with a transceiver, functions of the transceiver module 2002 may be integrated into the transceiver, the processing module 2001 may be replaced with a processor, and functions of the processing module 2001 may be integrated into the processor. Further, the network device 200 shown in FIG. 20 may further include a memory. When the transceiver module 2002 is replaced with a transceiver and the processing module 2001 is replaced with a processor, the network device 200 in this embodiment of this application may be the communication apparatus shown in FIG. 2.

Embodiments of this application further provide a computer-readable storage medium. All or some of the processes in the foregoing method embodiments may be implemented by a computer program instructing related hardware. The program may be stored in the computer-readable storage medium. When the program is executed, the processes of the foregoing method embodiments may be included. The computer-readable storage medium may be an internal storage unit of the terminal (including a data transmit end and/or a data receive end) in any one of the foregoing embodiments, for example, a hard disk drive or a memory of the terminal. Alternatively, the computer-readable storage medium may be an external storage device of the terminal, for example, a plug-in hard disk, a smart media card (SMC), a secure digital (SD) card, a flash card, or the like that are configured on the terminal. Further, the computer-readable storage medium may alternatively include both of the internal storage unit of the terminal and the external storage device. The computer-readable storage medium is configured to store the computer program and other programs and data that are required by the terminal. The computer-readable storage medium may be further configured to temporarily store data that has been output or is to be output.

It should be noted that, in the specification, claims, and accompanying drawings of this application, the terms “first”, “second”, and the like are intended to distinguish between different objects but do not indicate a particular order. In addition, the terms “including” and “having” and any other variants thereof are intended to cover a non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device.

It should be understood that, in this application, “at least one (item)” means one or more, “a plurality of” means two or more, “at least two (items)” means two, three, or more, and “and/or” is used to describe an association relationship between associated objects, and indicates that there may be three relationships. For example, “A and/or B” may indicate that only A exists, only B exists, and both A and B exist, where A and B may be singular or plural. The character “/” generally indicates an “or” relationship between the associated objects. “At least one of the following items (pieces)” or a similar expression thereof refers to any combination of these items, including any combination of singular items (pieces) or plural items (pieces). For example, at least one of a, b, or c may indicate a, b, c, a and b, a and c, b and c, or a, b, and c, where a, b, and c may be singular or plural.

The foregoing descriptions about implementations allow a person skilled in the art to understand that, for the purpose of convenient and brief description, division of the foregoing functional modules is taken as an example for illustration. In actual application, the foregoing functions can be allocated to different modules and implemented according to a requirement, that is, an inner structure of an apparatus is divided into different functional modules to implement all or some of the functions described above.

In the several embodiments provided in this application, it should be understood that the disclosed apparatus and method may be implemented in other manners. For example, the described apparatus embodiment is merely an example. For example, the module or division into the units is merely logical function division and may be other division in actual implementation. For example, a plurality of units or components may be combined or integrated into another apparatus, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may be one or more physical units, may be located in one place, or may be distributed on different places. Some or all of the units may be selected based on actual requirements to achieve the objectives of the solutions in embodiments.

In addition, function units in embodiments of this application may be integrated into one processing unit, or each of the units may exist alone physically, or two or more units are integrated into one unit. The integrated unit may be implemented in a form of hardware, or may be implemented in a form of a software function unit.

When the integrated unit is implemented in the form of a software functional unit and sold or used as an independent product, the integrated unit may be stored in a readable storage medium. Based on such an understanding, the technical solutions of this application essentially, or the part contributing to the conventional technology, or all or some of the technical solutions may be implemented in the form of a software product. The software product is stored in a storage medium and includes several instructions for instructing a device (which may be a single-chip microcomputer, a chip or the like) or a processor to perform all or some of the steps of the methods described in embodiments of this application. The foregoing storage medium includes any medium that can store program code, such as a USB flash drive, a removable hard disk, a ROM, a RAM, a magnetic disk, or an optical disc.

What is claimed is:

1. A communication method, comprising:
receiving, by a terminal device, a first identifier from a network device, wherein the first identifier indicates a first communication mode of the terminal device, and the first communication mode corresponds to a first physical layer function parameter used by the terminal device for communication;
determining, by the terminal device based on the first identifier and a first correspondence between a communication mode and a physical layer function parameter, the first physical layer function parameter corresponding to the first communication mode, wherein the communication mode in the first correspondence comprises the first communication mode; and
performing, by the terminal device, communication based on the first physical layer function parameter corresponding to the first communication mode.

2. The communication method according to claim 1, wherein:
a type of the physical layer function parameter corresponding to the communication mode comprises one or more of the following: data transmission, a channel state information (CSI) measurement feedback, initial access, mobility, power control, and beam management.

3. The communication method according to claim 2, wherein:
a terminal type of the terminal device is an ultra reliable low latency communication (URLLC) device, and the type of the physical layer function parameter corresponding to the communication mode comprises the data transmission, the mobility, and the beam management; or
a terminal type of the terminal device is an internet of things (IoT) device, and the type of the physical layer function parameter corresponding to the communication mode comprises the data transmission; or
a terminal type of the terminal device is customer premise equipment (CPE), and the type of the physical layer function parameter corresponding to the communication mode comprises the data transmission and the CSI measurement feedback.

4. The communication method according to claim 1, wherein the communication method further comprises:
receiving, by the terminal device, the first correspondence between a communication mode and a physical layer function parameter from the network device, wherein the communication mode in the first correspondence is determined based on a terminal type of the terminal device.

5. The communication method according to claim 1, wherein before the receiving, by a terminal device, a first identifier from a network device, the communication method further comprises:
sending, by the terminal device, request information to the network device, wherein the request information is used to request to switch the communication mode.

6. The communication method according to claim 5, wherein:
the request information comprises characteristic information, and the characteristic information indicates the communication mode in the first correspondence.

7. The communication method according to claim 1, wherein:
the physical layer function parameter comprises a first parameter field, and the first parameter field indicates a configuration manner of the physical layer function parameter; and
the configuration manner comprises a second parameter field, and the second parameter field comprises a configuration parameter of the configuration manner.

8. The communication method according to claim 2, wherein:
a terminal type of the terminal device is an ultra reliable low latency communication (URLLC) device, and a communication mode of the URLLC comprises the first communication mode and a second communication mode, wherein:
a type of a physical layer function parameter of the first communication mode comprises the data transmission, and a configuration manner of the data transmission comprises a configured grant type scheduling manner, a feedback manner in which an acknowledgement/negative acknowledgement (ACK/NACK) feedback is not required, and a retransmission mechanism of blind retransmission; and
a type of a physical layer function parameter of the second communication mode comprises the data transmission, and the configuration manner of the data transmission comprises a slot or sub-slot aggregation scheduling manner, a feedback manner of a codeword-level ACK/NACK feedback, and a retransmission mechanism of codeword-level retransmission; or
a terminal type of the terminal device is an internet of things (IoT) device, and a communication mode of the IoT device comprises the first communication mode, wherein:
a type of a physical layer function parameter of the first communication mode comprises the data transmission, and a configuration manner of the data transmission comprises a scheduling manner of dynamic scheduling, a feedback manner in which an acknowledgement/negative acknowledgement (ACK/NACK) feedback is not required, and a retransmission mechanism of blind retransmission; or
a terminal type of the terminal device is customer premise equipment (CPE), and a communication mode of the CPE comprises the first communication mode and a second communication mode, wherein:
a type of a physical layer function parameter of the first communication mode comprises the data transmission and the CSI measurement feedback, a configuration manner of the data transmission comprises a scheduling manner of dynamic scheduling and a slot or sub-slot aggregation scheduling manner, a feedback manner of a codeword-level ACK/NACK feedback, and a retransmission mechanism of codeword-level retransmission, and a configuration manner of the CSI measurement feedback is a periodic CSI measurement feedback; and
a type of a physical layer function parameter of the second communication mode comprises the data transmission and the CSI measurement feedback, the configuration manner of the data transmission comprises a scheduling manner of cross-slot scheduling, a feedback manner of a code block group-level ACK/NACK feedback, and a retransmission mechanism of code block group-level retransmission, and the configuration manner of the CSI measurement feedback is the periodic CSI measurement feedback.

9. The communication method according to claim 1, wherein:
the communication mode in the first correspondence is an uplink communication mode or a downlink communication mode.

10. The communication method according to claim 1, wherein the communication method further comprises:
receiving, by the terminal device, a timer from the network device, wherein the timer is used by the terminal device to switch the communication mode when the timer expires.

11. The communication method according to claim 1, wherein the communication method further comprises:
sending, by the terminal device, acknowledgment information to the network device, wherein the acknowledgment information indicates that the terminal device receives the first identifier.

12. The communication method according to claim 11, wherein the communication method further comprises:
receiving, by the terminal device, resource indication information from the network device, wherein the resource indication information indicates a transmission resource used when the terminal device sends the acknowledgment information; and
sending, by the terminal device, the acknowledgment information to the network device based on the transmission resource.

13. A communication method, comprising:
receiving, by a terminal device, a second identifier from a network device, wherein the second identifier indicates a first terminal status of the terminal device, and (1) the first terminal status is a data transmission state or a non-data transmission state, or (2) the first terminal status is an enhanced state or a non-enhanced state;
determining, by the terminal device, a parameter of the first terminal status based on the second identifier and a second correspondence between a terminal status and a parameter of the terminal status, wherein the terminal status in the second correspondence comprises the first terminal status; and
switching, by the terminal device, to the first terminal status.

14. The communication method according to claim 13, wherein the communication method further comprises:
receiving, by the terminal device, the second correspondence between a terminal status and a parameter of the terminal status from the network device, wherein the terminal status in the second correspondence is determined based on a terminal type of the terminal device.

15. The communication method according to claim 13, wherein:
the enhanced state is a large-packet transmission state, and the non-enhanced state is a small-packet transmission state;
the enhanced state is a high-rate transmission state, and the non-enhanced state is a low-rate transmission state;
the enhanced state is a high power consumption state, and the non-enhanced state is a low power consumption state; or
the enhanced state is a high transmission delay state, and the non-enhanced state is a low transmission delay state.

16. A terminal device, comprising:
one or more processors; and
one or more memories coupled to the one or more processors and storing programming instructions for execution by the one or more processors to cause the terminal device to perform operations comprising:
receiving a first identifier from a network device, wherein the first identifier indicates a first communication mode of the terminal device, and the first communication mode corresponds to a first physical layer function parameter used by the terminal device for communication;
determining, based on the first identifier and a first correspondence between a communication mode and a physical layer function parameter, the first physical layer function parameter corresponding to the first communication mode, wherein the communication mode in the first correspondence comprises the first communication mode; and
performing communication based on the first physical layer function parameter corresponding to the first communication mode.

17. The terminal device according to claim 16, wherein:
a type of the physical layer function parameter corresponding to the communication mode comprises one or more of the following: data transmission, a channel state information CSI measurement feedback, initial access, mobility, power control, and beam management.

18. The terminal device according to claim 17, wherein:
a terminal type of the terminal device is an ultra reliable low latency communication (URLLC) device, and the type of the physical layer function parameter corresponding to the communication mode comprises the data transmission, the mobility, and the beam management; or
a terminal type of the terminal device is an internet of things (IoT) device, and the type of the physical layer function parameter corresponding to the communication mode comprises the data transmission; or
a terminal type of the terminal device is customer premise equipment (CPE), and the type of the physical layer function parameter corresponding to the communication mode comprises the data transmission and the CSI measurement feedback.

19. The terminal device according to claim 16, wherein the operations further comprise:
receiving the first correspondence between a communication mode and a physical layer function parameter from the network device, wherein the communication mode in the first correspondence is determined based on a terminal type of the terminal device.

20. The terminal device according to claim 16, wherein:
before receiving the first identifier from the network device, the operations further comprise sending request information to the network device, wherein the request information is used to request to switch the communication mode.
